(19) United States
(12) Patent Application Publication
(10) Pub. No.: US 2026/0176402 A1
(43) Pub. Date: Jun. 25, 2026

(54) RECYCLABLE POLY(UREA-URETHANE) POLYMER AND COMPOSITE WITH DYNAMIC HINDERED UREA BONDS (HUBS)

(71) Applicant: BASE SE, Ludwigshafen am Rhein (DE)

(72) Inventors: Larissa Maria HAMMER, Ludwigshafen am Rhein (DE); Florian Ludwig GEYER, Ludwigshafen am Rhein (DE); Sandra Gloria KOENIG, Ludwigshafen am Rhein (DE)

(21) Appl. No.: 19/129,700

(22) PCT Filed: Nov. 14, 2023
(86) PCT No.: PCT/EP2023/081747

§ 371 Date: May 14, 2025

(30) Foreign Application Priority Data
Nov. 15, 2022 (EP) 22207570.7
Nov. 15, 2022 (EP) 22207575.6

(51) Int. Cl. C08G 18/10; C08G 18/08; C08G 18/32; C08G 18/40; C08G 18/42; C08G 18/48; C08G 18/66; C08G 18/76

(52) U.S. Cl. CPC C08G 18/10; C08G 18/0823; C08G 18/3206; C08G 18/4018; C08G 18/4277; C08G 18/4854; C08G 18/6659; C08G 18/7664

(57) ABSTRACT

The present invention relates to a poly(urea-urethane) polymer, a poly(urea-urethane) polymer composite, a method for preparing the polymer and the composite. Further, the present invention relates to a method of shaping the polymer and use of the polymer and its composite as repairable and recyclable material.

The present invention relates to a poly(urea-urethane) polymer, a poly(urea-urethane) polymer composite, a method for preparing the polymer and the composite. Further, the present invention relates to a method of shaping the polymer and use of the polymer and its composite as repairable and recyclable material.

There is a need in the material and polymer sciences to develop polymeric materials with desired in-use performance characteristics that are also malleable, repairable, and shape reprogrammable. There is also a need to develop such polymers that can be degraded or reversibly depolymerized. Even though shape memory and self-healing polymers are known, many of these polymers do not have both the desired performance and dynamic characteristics. With respect to degradable or reversibly depolymerizable polymers, these polymers often lack the required in-use performance characteristics and are either too easily degraded or on the other hand not degraded as readily or rapidly as desired.

Further, composite materials based on polymers comprising glass fibers reinforced plastics (GFRP) are widely used in applications such as airplanes, boats or windmill blades. Over 10 million of tones of GRPD are produced every year and no feasible recycling concept exits once embedded into the polymers.

Thus, there is a need to provide a new polymer. Thus, it is an object of the present invention to provide a new polymer, in particular poly(urea-urethane) polymer, obtained from isocyanates, amines, and polyols which can be used for composites and is easily repairable and recyclable.

Surprisingly, it was found that the polymer according to the present invention permits to create composite which can be used in many applications while being easily repairable and recyclable. Indeed, the poly(urea-urethane) polymer according to the present invention has dynamic hindered urea bonds (HUBs) which acts as dynamic covalent bonds in a covalent adaptable system/network (CAS/CAN). It is thus believed that the introduction of bulky substituent to a nitrogen atom weaken the bond such that there is a dissociation equilibrium of open and closed bonds which shifts to the open side by increasing temperature. The HUBs split up to the original constituting groups (de-polymerization). The claimed material are easily processable by thermo-mechanical processing methods as demonstrated in the following and facilitate the chemical and mechanical recycling of the poly(urea-urethane) polymers.

Therefore, the present invention relates to a poly(urea-urethane) polymer obtainable or obtained by a process comprising:
reacting the following components
   (i) at least one isocyanate;
   (ii) at least one polyol; and
   (iii) at least one secondary amine having the following formula (I)

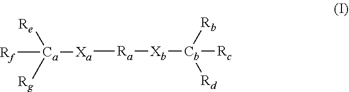

wherein —Rₐ— is selected from the group consisting of —Z₁—, —Z₂—, —Z₃—, —Z₄—, —Z₅—, —Z₆—, —Z₇—, —Z₇—, —Z₈—, —Z₉—, —Z₁₀—, —Z₁₁—, —Z₁₃—, —Z₁—Z₅—, —Z₅—Z₁—Z₅—, —Z₁—Z₆—, —Z₁—Z₇—, —Z₁—Z₈—, —Z₁—, —Z₁—Z₉—Z₁—, —Z₉—Z₁ (—Z₁₁—Z₁)ₙ—Z₉—, with n=1, 2, 3, 4, 5, or 6, and —Z₁—Z₁₂—Z₁—; wherein
—Z₁— is a substituted or unsubstituted, linear or branched C₁-C₃₀ alkylene;
—Z₂— is a substituted or unsubstituted, linear or branched 2- to 300,000-membered heteroalkylene;
—Z₃— is a substituted or unsubstituted, linear or branched C₂-C₃₀ alkenylene;
—Z₄— is a substituted or unsubstituted, linear or branched 3- to 30-membered heteroalkenylene;
—Z₅— is a substituted or unsubstituted C₅-C₃₀ cycloalkylene;
—Z₆— is a substituted or unsubstituted 5- to 30-membered heterocycloalkylene;
—Z₇— is a substituted or unsubstituted C₅-C₃₀ cycloalkenylene;
—Z₈— is a substituted or unsubstituted 5- to 30-membered heterocycloalkenylen;
—Z₉— is a substituted or unsubstituted C₆-C₃₀ arylene;
—Z₁₀— is a substituted or unsubstituted 5- to 30-membered heteroarylene;
—Z₁₁— is a C₆-C₃₀ arylene substituted with —NHR or —OR, wherein R is selected from the group consisting of H and substituted or unsubstituted, linear or branched C₁-C₁₀ alkyl;
—Z₁₂— is —N(R_{f})—;
—Z₁₃— is a substituted or unsubstituted 5- to 30-membered heterocycloalkylene, wherein at least one of the one or more heteroatoms of Z₁₃ is from Xₐ;
wherein Cₐ is a C atom or a H atom and C_{b} is a C atom or a H atom, wherein at least one of Cₐ and C_{b} is a C atom;
wherein Xₐ is a O atom or NH and X_{b} is a O atom or NH, wherein at least one of Xₐ and X_{b} is NH, with the condition that for Xₐ and/or X_{b} being NH, the respective Cₐ and/or C_{b} is/are C atom(s);
wherein
(A) R_{c}, R_{d}, R_{f} and R_{g} independently of each other are selected from the group consisting of hydrogen, linear or branched, substituted or unsubstituted C₁-C₃₀ alkyl, linear or branched, substituted or unsubstituted C₂-C₃₀ alkenyl, substituted or unsubstituted, linear or branched 2- to 30-membered heteroalkyl, substituted or unsubstituted, linear or branched 3- to 30-membered heteroalkenyl, substituted or unsubstituted C₅-C₃₀ cycloalkyl, substituted or unsubstituted C₅-C₃₀ cycloalkenyl, substituted or unsubstituted 5- to 30-membered heterocycloalkyl, substituted or unsubstituted 5- to 30-membered heterocycloalkenyl, substituted or unsubstituted C₆-C₃₀ aryl, substituted or unsubstituted 5- to 30-membered heteroaryl, substituted or unsubstituted C₁-C₁₀ alkylene C₅-C₃₀ cycloalkyl, substituted or unsubstituted C₁-C₁₀ alkylene C₅-C₃₀ cycloalkenyl, substituted or unsubstituted C₁-C₁₀ alkylene 5- to 30-membered heterocycloalkyl, substituted or unsubstituted C₁-C₁₀ alkylene 5- to 30-membered heterocycloalkenyl, substituted or unsubstituted C₁-C₁₀ alkylene C₆-C₃₀ aryl and substituted or unsubstituted C₁-C₁₀ alkylene 5- to 30-membered heteroaryl,
   R_{b} and Rₑ independently of each other are defined as R_{c}, R_{d}, R_{f} and R_{g}; or
   R_{b} and Rₑ are none, and Cₐ and C_{b} are connected to each other via a single bond forming a heterocycle consisting of Cₐ, C_{b}, Xₐ, X_{b} and Rₐ; or
(B) Cₐ and Rₑ form a substituted or unsubstituted C₆-C₃₀ arylene, and both R_{f} and R_{g} are none; and
   C_{b} and R_{b} form a substituted or unsubstituted C₆-C₃₀ arylene, and both R_{c} and R_{d} are none; or
(C) —Cₐ and Rₑ form a substituted or unsubstituted C₆-C₃₀ arylene, and both R_{f} and R_{g} are none; or
   —C_{b} and R_{b} form a substituted or unsubstituted C₆-C₃₀ arylene, and both R_{c} and R_{d} are none;
   wherein, when Cₐ and Rₑ form a substituted or unsubstituted C₆-C₃₀ arylene, R_{b}, R_{c} and R_{d} independently of each other are defined as any one of R_{c}, R_{d}, R_{f} and R_{g} under (A);
   wherein, when C_{b} and R_{b} form a substituted or unsubstituted C₆-C₃₀ arylene, Rₑ, R_{f} and R_{g} independently of each other are defined as any one of R_{c}, Rₐ, R_{f} and R_{g} under (A).

Preferably, the at least one secondary amine (iii) has the following formula (I)

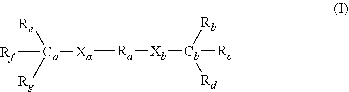

wherein —Rₐ— is selected from the group consisting of —Z₁—, —Z₂—, —Z₃—, —Z₄—, —Z₅—, —Z₆—, —Z₇—, —Z₇—, —Z₈—, —Z₉—, —Z₁₀—, —Z₁₁—, —Z₁₃—, —Z₁—Z₅—, —Z₅—Z₁—Z₅—, —Z₁—Z₆—, —Z₁—Z₇—, —Z₁—Z₈—, —Z₁—Z₉—, —Z₉—Z₁—Z₉—, —Z₁—Z₁₀—, —Z₃—Z₅—, —Z₃—Z₆—, —Z₃—Z₇—, Z₃—Z₈—, —Z₃—Z₉—, —Z₃—Z₁₀—, —Z₁—Z₅—Z₁—, Z₁—Z₉—Z₁—, —Z₉—Z₁ (—Z₁₁—Z₁)ₙ—Z₉—, with n=1, 2, 3, 4, 5, or 6, and —Z₁—Z₁₂—Z₁—; wherein
—Z₁— is a substituted or unsubstituted, linear or branched C₁-C₃₀ alkylene;
—Z₂— is a substituted or unsubstituted, linear or branched 2- to 300,000-membered heteroalkylene;
—Z₃— is a substituted or unsubstituted, linear or branched C₂-C₃₀ alkenylene;
—Z₄— is a substituted or unsubstituted, linear or branched 3- to 30-membered heteroalkenylene;
—Z₅— is a substituted or unsubstituted C₅-C₃₀ cycloalkylene;
—Z₆— is a substituted or unsubstituted 5- to 30-membered heterocycloalkylene;
—Z₇— is a substituted or unsubstituted C₅-C₃₀ cycloalkenylene;
—Z₈— is a substituted or unsubstituted 5- to 30-membered heterocycloalkenylen;
—Z₉— is a substituted or unsubstituted C₆-C₃₀ arylene;
—Z₁₀— is a substituted or unsubstituted 5- to 30-membered heteroarylene;
—Z₁₁— is a C₆-C₃₀ arylene substituted with —NHR or —OR, wherein R is selected from the group consisting of H and substituted or unsubstituted, linear or branched C₁-C₁₀ alkyl;
—Z₁₂— is —N(R_{f})—;
—Z₁₃— is a substituted or unsubstituted 5- to 30-membered heterocycloalkylene, wherein at least one of the one or more heteroatoms of Z₁₃ is from Xₐ;
wherein Cₐ is a C atom or a H atom and C_{b} is a C atom or a H atom, wherein at least one of Cₐ and C_{b} is a C atom;
wherein Xₐ is a O atom or NH and X_{b} is a O atom or NH, wherein at least one of Xₐ and X_{b} is NH, with the condition that for Xₐ and/or X_{b} being NH, the respective Cₐ and/or C_{b} is/are C atom(s);
wherein
(A) R_{c}, R_{d}, R_{f} and R_{g} independently of each other are selected from the group consisting of hydrogen, linear or branched, substituted or unsubstituted C₁-C₃₀ alkyl, linear or branched, substituted or unsubstituted C₂-C₃₀ alkenyl, substituted or unsubstituted, linear or branched 2- to 30-membered heteroalkyl, substituted or unsubstituted, linear or branched 3- to 30-membered heteroalkenyl, substituted or unsubstituted C₅-C₃₀ cycloalkyl, substituted or unsubstituted C₅-C₃₀ cycloalkenyl, substituted or unsubstituted 5- to 30-membered heterocycloalkyl, substituted or unsubstituted 5- to 30-membered heterocycloalkenyl, substituted or unsubstituted C₆-C₃₀ aryl, substituted or unsubstituted 5- to 30-membered heteroaryl, substituted or unsubstituted C₁-C₁₀ alkylene C₅-C₃₀ cycloalkyl, substituted or unsubstituted C₁-C₁₀ alkylene C₅-C₃₀ cycloalkenyl, substituted or unsubstituted C₁-C₁₀ alkylene 5- to 30-membered heterocycloalkyl, substituted or unsubstituted C₁-C₁₀ alkylene 5- to 30-membered heterocycloalkenyl, substituted or unsubstituted C₁-C₁₀ alkylene C₆-C₃₀ aryl and substituted or unsubstituted C₁-C₁₀ alkylene 5- to 30-membered heteroaryl,
   R_{b} and Rₑ independently of each other are defined as R_{c}, R_{d}, R_{f} and R_{g}; or R_{b} and Rₑ are none, and Cₐ and C_{b} are connected to each other via a single bond forming a heterocycle consisting of Cₐ, C_{b}, Xₐ, Xₚ and Rₐ; or
(B) Cₐ and Rₑ form a substituted or unsubstituted C₆-C₃₀ arylene, more preferably a phenyl, and both R_{f} and R_{g} are none; and
   C_{b} and R_{b} form a substituted or unsubstituted C₆-C₃₀ arylene, more preferably a phenyl, and both R_{c} and Rₐ are none.

Preferably, each of Cₐ and C_{b} is a C atom.

Preferably, Xₐ is NH, X_{b} is NH, the secondary amine (iii) having the following formula (II)

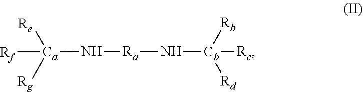

wherein Cₐ, C_{b}, R_{b}, R_{c}, R_{d}, Rₑ, R_{f}, R_{g}, and —Rₐ— are as defined in formula (I).

Preferably, —Rₐ— is selected from the group consisting of —Z₁—, —Z₂—, —Z₅—, —Z₉—, —Z₁₀—, —Z₁—Z₅—, —Z₅—Z₁—Z₅—, —Z₉—Z₁—Z₉—, —Z₁—Z₅—Z₁—, —Z₁—Z₉—Z₁—, and —Z₉—Z₁ (—Z₁₁—Z₁)ₙ—Z₉—, wherein n=1, 2, 3, 4, 5, or 6, preferably selected from the group consisting of —Z₂—, —Z₉—Z₁—Z₉—, and —Z₉—Z₁ (—Z₁₁—Z₁)ₙ—Z₉—, wherein n=1, 2, 3, 4, 5, or 6, more preferably selected from the group consisting of —Z₂— and —Z₉—Z₁ (—Z₁₁—Z₁)ₙ—Z₉—, wherein n=1, 2, 3, 4, 5, or 6.

Preferably, —Z₁— is selected from the group consisting of —CH₂—, —CH₂—CH₂—, —CH₂—CH(CH₃)—, —CH(CH₃)—CH₂—, —CH(CH₃)—CH₂—CH₂—, —CH₂—CH₂—CH(CH₂CH₃)—, —C(CH₃)₂, —CH₂—C(CH₃)₂—CH₂—, —CH₂—CH(CH₃)—CH₂—C(CH₃)₂—CH₂—CH₂—, —CH₂—C(CH₃)₂—CH₂—CH(CH₃)—CH₂—CH₂—, —(CH₂)₃—, —(CH₂)₄—, —(CH₂)₅—, —(CH₂)₆—, —(CH₂)₈—, and —(CH₂)₁₀—.

Preferably, when Rₐ is selected from the group consisting of —Z₁—Z₅—, —Z₅—Z₁—Z₅—, —Z₁—Z₆—, with n=1, 2, 3, 4, 5, or 6, and —Z₁—Z₁₂—Z₁—, —Z₁— is —CH₂—.

Preferably, —Z₉— is selected from the group consisting of phenylene, naphthylene, biphenylene, fluorenylene, and indenyl, wherein —Z₉-more preferably is phenylene. Preferably, phenylene is selected from the group consisting of ortho-phenylene, meta-phenylene, and para-phenylene, more preferably ortho- and para-phenylene.

Preferably, —Rₐ— is —Z₉—Z₁—Z₉—, with —Z₉— is phenylene, more preferably para-phenylene, and —Z₁— is —CH₂—.

Preferably, —Rₐ— is —Z₉—Z₁ (—Z₁₁—Z₁)ₙ—Z₉—, wherein n=1, 2, 3, 4, 5, or 6, with —Z₉— is phenylene and —Z₁— is —CH₂— and wherein —Z₁₁— is a C₆-arylene substituted with —NHR.

Preferably, in —Z₁₁—, R is —C(Rₕ)(Rᵢ)(Rⱼ), wherein Rₕ, Rᵢ and Rⱼ independently of each other are selected from the group consisting of hydrogen, linear or branched, substituted or unsubstituted C₁-C₃₀ alkyl, linear or branched, substituted or unsubstituted C₂-C₃₀ alkenyl, substituted or unsubstituted, linear or branched 2- to 30-membered heteroalkyl, substituted or unsubstituted, linear or branched 3- to 30-membered heteroalkenyl, substituted or unsubstituted C₅-C₃₀ cycloalkyl, substituted or unsubstituted C₅-C₃₀ cycloalkenyl, substituted or unsubstituted 5- to 30-membered heterocycloalkyl, substituted or unsubstituted 5- to 30-membered heterocycloalkenyl, substituted or unsubstituted C₆-C₃₀ aryl, substituted or unsubstituted 5- to 30-membered heteroaryl, substituted or unsubstituted C₁-C₁₀ alkylene C₅-C₃₀ cycloalkyl, substituted or unsubstituted C₁-C₁₀ alkylene C₅-C₃₀ cycloalkenyl, substituted or unsubstituted C₁-C₁₀ alkylene 5- to 30-membered heterocycloalkyl, substituted or unsubstituted C₁-C₁₀ alkylene 5- to 30-membered heterocycloalkenyl, substituted or unsubstituted C₁-C₁₀ alkylene C₆-C₃₀ aryl and substituted or unsubstituted C₁-C₁₀ alkylene 5- to 30-membered heteroaryl. More preferably, Rₕ, Rᵢ and Rⱼ independently of each other are selected from the group consisting of hydrogen, linear or branched, substituted or unsubstituted C₁-C₃₀ alkyl. More preferably, Rₕ, Rᵢ and Rⱼ independently of each other are selected from the group consisting of hydrogen, methyl, ethyl, propyl, iso-propyl, butyl, pentyl, hexyl, octyl, dodecyl, sec-butyl, tert-butyl, sec-isopentyl, 2-pentyl, 2-methyl-4-pentyl, 3-pentyl, 2-methyl-pentyl, 2,6-dimethyl-4-heptyl, 3-pinanyl-methyl, cyclopentyl, cyclohexyl, dicyclohexylmethyl, cyclohexylmethyl, cyclododecyl, phenyl, benzyl, and cyclohexyl(phenyl)methyl, preferably selected from the group consisting of hydrogen, methyl, and ethyl, more preferably selected from the group consisting of hydrogen, methyl and ethyl. More preferably, any one of Rₕ, Rᵢ and Rⱼ is H, and one of Rₕ, Rᵢ and Rⱼ other than the one being H is CH₃. More preferably, one of Rₕ, Rᵢ, and Rⱼ, other than the one being CH₃ or H, is an ethyl group.

Alternatively, preferably, in —Z₁₁—, R is —C(Rₕ)(Rᵢ)(Rⱼ), wherein C and Rₕ form a substituted or unsubstituted C₆-C₃₀ arylene, and both Rᵢ and Rⱼ are none. For example, —Z₁₁— can be —NH-Ph.

In the context of the present invention, preferably, —Z₂— is a substituted or unsubstituted, linear or branched 2- to 500-membered heteroalkylene, more preferably a substituted or unsubstituted, linear or branched 2- to 35-membered heteroalkylene, more preferably a substituted or unsubstituted, linear or branched 2- to 30-membered heteroalkylene.

More preferably, —Z₂— is selected from the group consisting of —CH₂—CH₂—NH—CH₂—CH₂—, —CH₂—CH₂—NH—CH₂—CH₂—CH₂—, —CH(CH₃)—CH₂—NH—CH₂—CH(CH₃)—, —CH₂—CH₂—CH₂—N(CH₃)CH₂—CH₂—CH₂—, —CH₂—CH₂—CH₂—NH—CH₂—CH₂—CH₂—, —CH₂—CH₂—CH₂—NH—CH₂—CH₂—NH—CH₂—CH₂—CH₂—, —CH₂—CH₂—NH—CH₂—CH₂—NH—CH₂—CH₂—, —CH₂—CH₂—NH—CH₂—CH₂—NH—CH₂—CH₂—NH—CH₂—CH₂, —CH₂—CH₂—O—CH₂—CH₂—, —CH₂—CH₂—CH₂—O—CH₂—CH₂—O—CH₂—CH₂—O—CH₂—CH₂—CH₂—, —CH₂—CH₂—CH₂—O—CH₂—CH₂—CH₂—CH₂—O—CH₂—CH₂—CH₂—, —CH₂—CH₂—O—CH₂—CH₂—O—CH₂—CH₂—, —(CH(CH₃)—CH₂—O)₁₋₁₀₀—CH(CH₃)—CH₂—,
—[CH(CH₃)—CH₂—O]ₘ₁—CH₂—C(Rₓ₁)(R_{y1})—[O—CH₂—CH(CH₃)]ₒ₁—, wherein Rₓ₁ is —CH₂—CH₃, wherein R_{y1} is [—O—CH₂—CH(CH₃)]ₘ₁—NH—C(Rₗ)(Rₘ)(Rₙ), wherein m1+n1+o1 is in the range of from 5 to 6,
—[CH(CH₃)—CH₂—O]ₘ₂—CH₂—CH(R_{y2})—[O—CH₂—CH(CH₃)]ₒ₂—, wherein R_{y2} is [—O—CH₂—CH(CH₃)]ₙ₂—NH—C(Rₗ)(Rₘ)(Rₙ), and wherein m2+n2+o2 is in the range of 45 to 85,
[CH(CH₃)—CH₂—O]ₘ₃—[CH₂—CH₂—O]ₙ₃—[CH₂—CH(CH₃)—O]ₒ₃—CH₂—CH(CH)₃—,
wherein n3 is in the range of from 8 to 10 and m3+o3 is in the range of from 3 to 4, or
wherein n3 is in the range of from 12 to 13 and m3+o3 is in the range of from 5 to 7, or
wherein n3 is in the range of from 38 to 40 and m3+o3 is in the range of from 5 to 7,
[CH—CH₂—O]ₘ₄—CH₂—CH₂—, wherein m4 is in the range of from 8 to 250, and
[CH₂—CH₂—NH]ₘ₅—, wherein m5 is in the range of from 10 to 100,000.

More preferably, —Z₂— is —[CH(CH₃)—CH₂—O]ₘ₁—CH₂—C(Rₓ₁)(R_{y1})—CH₂—[O—CH₂—CH(CH₃)]ₒ₁—, wherein Rₓ₁ is —CH₂—CH₃, wherein R_{y1} is —CH₂—[O—CH₂—CH(CH₃)]ₙ₁—NH—C(Rₗ)(Rₘ)(Rₙ), wherein m1+n1+o1 is in the range of 5 to 6.

Preferably, in one or more of R_{y1} and R_{y2}, Rₗ, Rₘ and Rₙ independently of each other are selected from the group consisting of hydrogen, linear or branched, substituted or unsubstituted C₁-C₃₀ alkyl, linear or branched, substituted or unsubstituted C₂-C₃₀ alkenyl, substituted or unsubstituted, linear or branched 2- to 30-membered heteroalkyl, substituted or unsubstituted, linear or branched 3- to 30-membered heteroalkenyl, substituted or unsubstituted C₅-C₃₀ cycloalkyl, substituted or unsubstituted C₅-C₃₀ cycloalkenyl, substituted or unsubstituted 5- to 30-membered heterocycloalkyl, substituted or unsubstituted 5- to 30-membered heterocycloalkenyl, substituted or unsubstituted C₆-C₃₀ aryl, substituted or unsubstituted 5- to 30-membered heteroaryl, substituted or unsubstituted C₁-C₁₀ alkylene C₅-C₃₀ cycloalkyl, substituted or unsubstituted C₁-C₁₀ alkylene C₅-C₃₀ cycloalkenyl, substituted or unsubstituted C₁-C₁₀ alkylene 5- to 30-membered heterocycloalkyl, substituted or unsubstituted C₁-C₁₀ alkylene 5- to 30-membered heterocycloalkenyl, substituted or unsubstituted C₁-C₁₀ alkylene C₆-C₃₀ aryl and substituted or unsubstituted C₁-C₁₀ alkylene 5- to 30-membered heteroaryl. More preferably, Rₗ, Rₘ and Rₙ independently of each other are selected from the group consisting of hydrogen, linear or branched, substituted or unsubstituted C₁-C₃₀ alkyl. More preferably, Rₗ, Rₘ and Rₙ independently of each other are selected from the group consisting of hydrogen, methyl, ethyl, propyl, iso-propyl, butyl, pentyl, hexyl, octyl, dodecyl, sec-butyl, tert-butyl, sec-isopentyl, 2-pentyl, 2-methyl-4-pentyl, 3-pentyl, 2-methyl-pentyl, 2,6-dimethyl-4-heptyl, 3-pinanyl-methyl, cyclopentyl, cyclohexyl, dicyclohexylmethyl, cyclohexylmethyl, cyclododecyl, phenyl, benzyl, and cyclohexyl(phenyl)methyl, more preferably selected from the group consisting of hydrogen, methyl, and ethyl, more preferably selected from the group consisting of hydrogen, methyl and ethyl. More preferably, any one of Rₗ, Rₘ and Rₙ is H, and one of Rₗ, Rₘ and Rₙ other than the one being H is CH₃. More preferably, one of Rₗ, Rₘ and Rₙ, other than the one being CH₃ or H, is an ethyl group. Alternatively, preferably, in one or more of R_{y1} and R_{y2}, C and Rₗ form a substituted or unsubstituted C₆-C₃₀ arylene, and both Rₘ and Rₙ are none. For example, R_{y1} can be —CH₂—[O—CH₂—CH(CH₃)]ₙ₁—NH-Ph and R_{y2} can be [—O—CH₂—CH(CH₃)]ₙ₂—NH-Ph.

Preferably, —Z₃— is selected from the group consisting of —CH═CH— and —CH₂—CH═CH—.

Preferably, —Z₄— is selected from the group consisting of —CH═CH—NH—, —CH═CH—O—, —CH═CH—CH₂—O—.

Preferably, —Z₅— is selected from the group consisting of cyclohexa-1,4-ylene, cyclohexa-1,3-ylene,

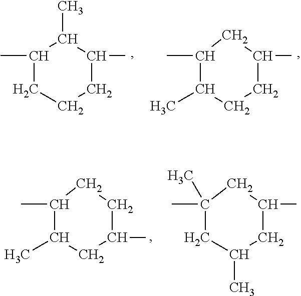

and 2,6-diyl-norbornane.

Preferably, —Z₆— is selected from the group consisting of 1,5-dioxaoctylene and 4,8-dioxabicyclo[3.3.0]octylene.

Preferably, —Z₇— is selected from the group consisting of cyclopent-1,2-en-3,5-ylene, 3-cyclohexene-1,2-ylene, 2,5-cyclohexadiene-1,4-ylene, cyclohex-1,2-en-3,5-ylene, 2,5-cyclohexadiene-1,4-ylene and cyclohept-1,2-en-3,5-ylene.

Preferably, —Z₁₀— is triazinylene, more preferably one or more of vic-triazinylene, asym-triazinylene, and sym-triazinylene.

Preferably, R_{c}, R_{d}, R_{f} and R_{g} independently of each other are selected from the group consisting of hydrogen, methyl, ethyl, propyl, iso-propyl, butyl, pentyl, hexyl, octyl, dodecyl, sec-butyl, tert-butyl, sec-isopentyl, 2-pentyl, 2-methyl-4-pentyl, 3-pentyl, 2-methyl-pentyl, 2,6-dimethyl-4-heptyl, 3-pinanyl-methyl, cyclopentyl, cyclohexyl, dicyclohexylmethyl, cyclohexylmethyl, cyclododecyl, phenyl, benzyl, cyclohexyl(phenyl)methyl, and —C(OH)H—Rₖ, more preferably selected from the group consisting of hydrogen, methyl, and ethyl, more preferably selected from the group consisting of hydrogen, methyl and ethyl,
wherein Rₖ is selected from the group consisting of hydrogen, linear or branched, substituted or unsubstituted C₁-C₃₀ alkyl, linear or branched, substituted or unsubstituted C₂-C₃₀ alkenyl, substituted or unsubstituted, linear or branched 2- to 30-membered heteroalkyl, substituted or unsubstituted, linear or branched 3- to 30-membered heteroalkenyl, substituted or unsubstituted C₅-C₃₀ cycloalkyl, substituted or unsubstituted C₅-C₃₀ cycloalkenyl, substituted or unsubstituted 5- to 30-membered heterocycloalkyl, substituted or unsubstituted 5- to 30-membered heterocycloalkenyl, substituted or unsubstituted C₆-C₃₀ aryl, substituted or unsubstituted 5- to 30-membered heteroaryl, substituted or unsubstituted C₁-C₁₀ alkylene C₅-C₃₀ cycloalkyl, substituted or unsubstituted C₁-C₁₀ alkylene C₅-C₃₀ cycloalkenyl, substituted or unsubstituted C₁-C₁₀ alkylene 5- to 30-membered heterocycloalkyl, substituted or unsubstituted C₁-C₁₀ alkylene 5- to 30-membered heterocycloalkenyl, substituted or unsubstituted C₁-C₁₀ alkylene C₆-C₃₀ aryl and substituted or unsubstituted C₁-C₁₀ alkylene 5- to 30-membered heteroaryl.

Preferably, R_{b} and Rₑ independently of each other are selected from the group consisting of hydrogen, methyl, ethyl, propyl, iso-propyl, butyl, pentyl, hexyl, octyl, dodecyl, sec-butyl, tert-butyl, sec-isopentyl, 2-pentyl, 2-methyl-4-pentyl, 3-pentyl, 2-methyl-pentyl, 2,6-dimethyl-4-heptyl, 3-pinanyl-methyl, cyclopentyl, cyclohexyl, dicyclohexylmethyl, cyclohexylmethyl, cyclododecyl, phenyl, benzyl, and cyclohexyl(phenyl)methyl, more preferably selected from the group consisting of hydrogen, methyl, and ethyl.

Preferably, any one of R_{b}, R_{c}, and R_{d} is H, and any one of Rₑ, R_{f}, and R_{g} is H; one of R_{b}, R_{c}, and Rₐ other than the one being H is CH₃, and one of Rₑ, R_{f}, and R_{g} other than the one being H is CH₃.

Preferably, any one of R_{b}, R_{c}, and R_{d} is an ethyl group, and any one of Rₑ, R_{f}, and R_{g} is an ethyl group; more preferably
one of R_{b}, R_{c}, and Rₐ other than the one being an ethyl group is H,
one of Rₑ, R_{f}, and R_{g} other than the one being an ethyl group is H,
one of R_{b}, R_{c}, and Rₐ other than the one being an ethyl group or H is CH₃, and
one of Rₑ, R_{f}, and R_{g} other than the one being an ethyl group or H is CH₃.

Preferably, the at least one secondary amine (iii) is

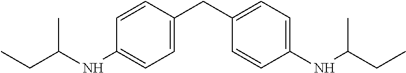 [SMILES: CCC(C)Nc1ccc(Cc2ccc(NC(C)CC)cc2)cc1]

4,4′-Methylenebis(N-sec-butylaniline) (DIB-MDA).

Alternatively, preferably, the at least one secondary amine (iii) is a sec-butyl-modified polyether amine, CH₃—CH₂—CH(CH₃)—NH—[CH(CH₃)—CH₂—O]ₘ₁—CH₂—C(Rₓ₁)(R_{y1})—CH₂—[O—CH₂—CH(CH₃)]ₒ₁—NH—CH(CH₃)—CH₂—CH₃, wherein Rₓ₁ is —CH₂—CH₃, wherein R_{y1} is —CH₂—[O—CH₂—CH(CH₃)]ₙ₁—NH—CH(CH₃)—CH₂—CH₃, wherein m1+n1+o1 is in the range of 5 to 6.

Preferably, the at least one secondary amine (iii) is

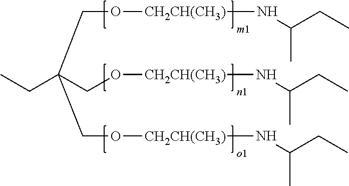

DIB-polyetheramine T403, with m1+n1+o1=5 to 6.

Alternatively, it is preferred that the at least one secondary amine (iii) is DIB-butanediamine (N,N′-di-sec-butyl-1,4-butanediamine.

Alternatively, it is preferred that the at least one secondary amine (iii) is 2-(ethylamino) ethanol.

In the context of the present invention, suitable isocyanates are known per se to a person skilled in the art.

Preferably, the at least one isocyanate (i) has a NCO functionality of 2 or more, more preferably of 2 or 3.

Preferably the at least one isocyanate (i) is a mixture of an isocyanate having a NCO functionality of 2 and an isocyanate having a NCO functionality of 3 or more, more preferably the at least one isocyanate (i) is a mixture of an isocyanate having a NCO functionality of 2 and an isocyanate having a NCO functionality of 3.

Preferably, the at least one isocyanate (i) is selected from the group consisting of monomeric methylene diphenylene diisocyanate (mMDI), polymethylene polyphenylene polyisocyanate (pMDI), a mixture of monomeric methylene diphenylene diisocyanate and polymethylene polyphenylene polyisocyanate (MDI), tolylene diisocyanate (TDI), isomers of xylylene diisocyanate (XDI), isomers of diisocyanatobenzene, xylene 2,6-diisocyanate, naphthylene 1,5-diisocyanate (1,5-NDI), butane 1,4-diisocyanate, pentane 1,5-diisocyanate (PDI), hexane 1,6-diisocyanate (HDI), octane 1,8-diisocyanate, nonane 1,9-diisocyanate, decane 1,10-diisocyanate, 2,2-dimethylpentane 1,5-diisocyanate, 2-methylpentane 1,5-diisocyanate (MPDI), 2,4,4 (or 2,2,4)-trimethylhexane 1,6-diisocyanate (TMDI), cyclohexane 1,3- and 1,4-diisocyanate, 1-isocyanato-3,3,5-trimethyl-5-isocyanatomethylcyclohexane (IPDI), methylene-bis(cyclohexyl isocyanate) (H12MDI), 2,4- or 2,6-diisocyanato-1-methylcyclohexane (H6TDI), 1-isocyanato-1-methyl-4 (3)-isocyanatomethylcyclohexane (AMCI), 1,3-bis(isocyanatomethyl)cyclohexane, 1,4-bis(isocyanatomethyl)cyclohexane, bis(isocyanatomethyl) norbornane (NBDI), triphenylmethane-4,4′,4″-triisocyanate, toluene-2,4,6-triyl triisocyanate, ethyl ester 1-lysine triisocyanate, triisocyanatocyclohexane, tris(isocyanatomethyl)cyclohexane, triisocyanatomethylcyclohexane, 1,8-diisocyanato-4-(isocyanatomethyl) octane, undecane 1,6,11-triisocyanate, 1,7-diisocyanato-4-(3-isocyanatopropyl) heptane, 1,6-diisocyanato-3-(isocyanatomethyl) hexane, 2,2-bis[[4-(isocyanatomethyl)phenyl]methyl]butyl n-[[4-(isocyanatomethyl)phenyl]methyl]carbamate, (2,4,6-trioxotriazine-1,3,5 (2h,4h,6h)-triyl)tris(hexamethylene) isocyanate, 1,3,5-triisocyanatobenzene, tris(isocyanatohexyl) biuret, 3,3′,3″-[(1h,3h,5h)-2,4,6-trioxo-1,3,5-triazine-1,3,5-triyltris(methylene)]tris[3,5,5-trimethylcyclohexyl]triisocyanate, 1,3,5-triazine-2,4,6-triisocyanate, 2,4,4′-triisocyanato-dicyclohexylmethane, triisocyanate triphenylthiophosphate, 2,4,4′-diphenylethertriisocyanate, 1,3-Bis(3-isocyanato-4-methylphenyl)-1,3-diazetidine-2,4-dione, and a mixture of two or more thereof,
more preferably selected from the group consisting of monomeric methylene diphenylene diisocyanate (mMDI), polymethylene polyphenylene polyisocyanate (pMDI), a mixture of monomer methylene diphenylene diisocyanate and polymethylene polyphenylene polyisocyanate (MDI), tolylene diisocyanate (TDI), naphthylene 1,5-diisocyanate (1,5-NDI), 1,4-diisocyanate, pentane 1,5-diisocyanate (PDI), hexane 1,6-diisocyanate (HDI), methylene-bis(cyclohexyl isocyanate) (H12MDI), such as dicyclohexylmethane 4,4′- or 2,4′- or 2,2′-diisocyanate, and a mixture of two or more thereof.

Preferably, the at least one isocyanate (i) is selected from the group consisting of monomeric methylene diphenylene diisocyanate (mMDI), polymethylene polyphenylene polyisocyanate (pMDI), a mixture of monomer methylene diphenylene diisocyanate and polymethylene polyphenylene polyisocyanate (MDI) and tolylene diisocyanate (TDI).

Preferably, the at least one isocyanate (i) is selected from the group consisting of methylene diphenylene diisocyanate (mMDI), polymethylene polyphenylene polyisocyanate (pMDI) and a mixture of monomeric methylene diphenylene diisocyanate and polymethylene polyphenylene polyisocyanate (MDI), more preferably selected from the group consisting of monomeric methylene diphenylene diisocyanate (mMDI) and a mixture of monomeric methylene diphenylene diisocyanate and polymethylene polyphenylene polyisocyanate (MDI).

More preferably, tolylene diisocyanate (TDI) comprises, more preferably consists of, one or more of 2,4-TDI and 2,6-TDI.

More preferably the monomeric methylene diphenylene diisocyanate (mMDI) comprises, more preferably consists of, one or more 4,4′-methylene (diphenyl diisocyanate) (4,4′-MDI), 2,2′-meth-ylene (diphenyl diisocyanate) (2,2′-MDI) and 2,4′-methylene (diphenyl diisocyanate) (2,4′-MDI), more preferably 4,4′-methylene (diphenyl diisocyanate) (4,4′-MDI). More preferably, the at least one isocyanate (i) is a monomeric methylene diphenylene diisocyanate (mMDI) which comprises, more preferably consists of, one or more 4,4′-methylene (diphenyl diisocyanate) (4,4′-MDI), 2,2′-methylene (diphenyl diisocyanate) (2,2′-MDI) and 2,4′-methylene (diphenyl diisocyanate) (2,4′-MDI), more preferably 4,4′-methylene (diphenyl diisocyanate) (4,4′-MDI).

Other possible isocyanates are mentioned by way of example in “Kunststoffhandbuch [Plastics handbook], volume 7, Polyurethane [Polyurethanes]”, Carl Hanser Verlag, 3rd edition 1993, chapter 3.2 and 3.3.2.

Suitable polyols are known per se to a person skilled in the art.

Principally, any polyol conventionally used for the preparation of polyurethanes can be used as polyol. The type of polyol may depend on the desired purpose of the application. Suitable polyols are polyester polyols, including in particular aliphatic polyester polyols and aliphatic aromatic polyester polyols, polyestercarbonate polyols, polyetherester polyols, aliphatic polycarbonate polyols, polyacrylate polyols, polyolefine polyols, aliphatic polyetherols and mixtures thereof. Preferably, the at least one polyol is selected from polyester polyols, in particular aliphatic polyester polyols and aliphatic aromatic polyester polyols, aliphatic polycarbonate polyols, aliphatic polyetherols and mixtures thereof. In particular, the at least one polyol comprises a polyester polyol and/or an aliphatic polyether polyol as described herein. Especially, the at least one polyol is selected from polyester polyols, aliphatic polyether polyols and combinations thereof.

Preferably, the at least one polyol (i) is selected from the group consisting of polyester polyol, polyetherester polyol, polycarbonate polyol, polyacrylate polyol, polyolefine polyol, polyether polyol, and mixtures thereof.

More preferably, the at least one polyol (i) is selected from the group consisting of polyester polyol and polyether polyol.

Polyester polyols suitable as polyol are in particular aliphatic polyesterols and aliphatic/aromatic polyesterols, i.e. polyesterols which are based on a dicarboxylic acid component selected from aliphatic dicarboxylic acids, cycloaliphatic dicarboxylic acids, aromatic dicarboxylic acids and combinations and a diol component, selected from aliphatic diols and cycloaliphatic diols and polyetherpolyols.

Suitable aliphatic diols for preparing the polyester polyols generally have usually 2 to 20 C atoms, in particular 3 to 10 C atoms. Examples of aliphatic diols are ethylene glycol, propane-1,2-diol, propane-1,3-diol, butane-1,2-diol, butane-1,3-diol, butane-1,4-diol, butane-2,3-diol, pentane-1,2-diol, pentane-1,3-diol, pentane-1,4-diol, pentane-1,5-diol, pentane-2,3-diol, pentane-2,4-diol, hexane-1,2-diol, hexane-1,3-diol, hexane-1,4-diol, hexane-1,5-diol, hexane-1,6-diol, hexane-2,5-diol, heptane-1,2-diol 1,7-heptanediol, 1,8-octanediol, 1,2-octanediol, 1,9-nonanediol, 1,2-decanediol, 1,10-decanediol, 1,2-dodecanediol, 1,12-dodecanediol, 1,5-hexadiene-3,4-diol, neopentyl glycol (2,2-dimethylpropane-1,3-diol), 2,2-diethylpropane-1,3-diol, 2-methyl-2-ethylpropane-1,3-diol, 2-methyl-2,4-pentanediol, 2,4-dimethyl-2,4-pentanediol, 2-ethyl-1,3-hexanediol, 2,5-dimethyl-2,5-hexanediol, 2,2,4-trimethyl-1,3-pentanediol, pinacol, diethylene glycol, triethylene glycol, dipropylene glycol, and tripropylene glycol

Suitable cycloaliphatic diols for preparing the polyester polyols generally have usually 4 to 20 C atoms, in particular 5 to 10 C atoms. Examples of cycloaliphatic diols are cyclopentanediol, cyclohexane-1,4-diol, cyclohexane-1,2-dimethanol, cyclohexane-1,3-dimethanol, cyclohexane-1,4-dimethanol and 2,2,4,4-tetramethylcyclobutane-1,3-diol. Also suitable diols for preparing the polyester polyols are polyether diols, in particular polyethylene glycols HO(CH₂CH₂O)ₙ—H, higher polypropylene glycols HO(CH [CH₃]CH₂O)ₙ—H, where n is an integer and n≥4, e.g., 4 to 20, and polyethylene-polypropylene glycols, more particularly those having 4 to 20 repeating units, it being possible for the sequence of the ethylene oxide and propylene oxide units to be blockwise or random, and polytetramethylene glycols, more particularly those having 4 to 20 repeating units, and poly-1,3-propanediols, more particularly those having 4 to 20 repeating units.

Preferred dicarboxylic acids for preparing the polyester polyols are aromatic dicarboxylic acids, such as phthalic acid, isophthalic acid and, terephthalic acid, cycloaliphatic dicarboxylic acids having preferably from 8 to 12 carbon atoms, such as tetrahydrophthalic acid, hexahydrophthalic acid, cyclohexanedicarboxylic acid, and aliphatic dicarboxylic acids having preferably from 3 to 40 carbon atoms, such as malonic acid, succinic acid, 2-methylsuccinic acid, glutaric acid, 2-methylglutaric acid, 3-methylglutaric acid, α-ketoglutaric acid, adipic acid, pimelic acid, azelaic acid, sebacic acid, brassylic acid, fumaric acid, 2,2-dimethylglutaric acid, suberic acid, diglycolic acid, oxaloacetic acid, glutamic acid, aspartic acid, itaconic acid and maleic acid and dimer fatty acids, such as the dimer fatty acid of octadecadienoic acids or dimeric fatty acids obtained by dimerization of other polyunsaturated fatty acids or fatty acid mixtures [CAS 61788-89-4].

The dicarboxylic acid used in preparing the polyester polyols may be the free acids or ester-forming derivatives thereof. Derivatives are understood preferably to be the corresponding anhydrides, monoalkyl and dialkyl esters, preferably mono- and di-C₁-C₄ alkyl esters, more preferably monomethyl and dimethyl esters, and also the corresponding monoethyl and diethyl esters, and additionally monovinyl and divinyl esters, and also mixed esters, examples being mixed esters with different C₁-C₄ alkyl components.

Amongst polyester polyols preference is given to polyester polyols based on a diol component selected from the group consisting of butanediol, neopentyl glycol, hexanediol, ethylene glycol, diethylene glycol and mixtures thereof, and a dicarboxylic acid component selected from the group consisting of adipic acid, phthalic acid, isophthalic acid and combinations thereof. Particular preference is given to polyester polyols based on butanediol and/or neopentyl glycol and/or hexanediol with adipic acid and/or phthalic acid and/or isophthalic acid.

Polyester polyols suitable as polyol also include polylactones, in particular poly-C4-C12-lactones, especially polycaprolactones (PCL). Polylactones refer to aliphatic polyesters obtainable by ring-opening polymerization of lactones, in particular C4-C12-lactones, especially epsilon-caprolactones (ε-caprolactone). Polycaprolactones have repeating monomer units of the general formula [—O—CHR—(CH₂)ₘ—CO—], in which m is 4 to 10, in case of caprolactone m=4, and R is hydrogen. In the context of the invention, the term polycaprolactone is understood to mean both homopolymers of epsilon-caprolactone and copolymers of epsilon-caprolactone. Suitable copolymers are, for example, copolymers of epsilon-caprolactone with monomers selected from the group consisting of lactic acid, lactide, hydroxyacetic acid and glycolide. The polyester polyols are customary components which are known e.g. from Ullmanns Encyklopädie der technischen Chemie [Ullmann's Encyclopedia of Industrial Chemistry], 4th edition, volume 19, pp. 62 to 65.

Aliphatic polyether polyols suitable as polyol are, for example, the polyaddition products of C2-C4-alkylene oxides, such as ethylene oxide, propylene oxide, 1,2-butylene oxide, 2,3-butylene oxide or 2-methylpropylene oxide. Further suitable polymeric polyols are aliphatic polyether polyols obtainable by condensation of polyhydric aliphatic alcohols, aliphatic polyether polyols obtained by alkoxylation of aliphatic polyhydric alcohols, amines and amino alcohols. Suitable polyhydric alcohols include ethylene glycol, 1,2-propylene glycol, 1,3-propylene glycol, 1,4-butanediol, neopentyl glycol, 1,6-hexanediol, trimethylolpropane, glycerol, pentaerythritol, triethanolamine (=tris(2-hydroxyethyl)amine), sorbitol or mixtures of these. Suitable polyetherols have generally OH functionalities in the range of 1.5 to 3.0, in particular in the range of 1.8 to 2.5. Suitable polyetherols have preferably OH numbers in the range of 20 to 300 mg KOH/g and in particular in the range of 30 to 250 mg KOH/g. In the context of the present invention, the OH number is measured according to EN ISO 4629-1:2016 unless otherwise noted.

Generally, they have number average molecular weights Mn in the range of 400 to 10.000 g/mol, preferably of 500 to 5.000 g/mol, determined by gel permeation chromatography as described above. Preferred polyether components are polyethylene oxide polyols, polypropylene oxide polyols and polytetramethylene oxide polyols (poly-THF) having a molecular weight Mn of 400 to 10.000 g/mol, preferably of 500 to 5.000 g/mol. In this case, the polyether polyols of particularly low molecular weight may be water-soluble in the case of correspondingly high OH contents.

Preferably, the at least one polyol (ii) is polyether polyol, the polyether polyol more preferably being selected from the group consisting of polytetrahydrofuran, trifunctional polyether polyol containing secondary hydroxyl groups, polypropylene glycol, polyether polyol based on sucrose, tetrafunctional polyether polyol based on ethylenediamine and propylene oxide, and a mixture of two or more thereof, more preferably selected from the group consisting of polytetrahydrofuran and trifunctional polyether polyol containing secondary hydroxyl groups.

Preferably, the at least one polyol (ii) is a polyether polyol, the polyether polyol more preferably being selected from the group consisting of polytetrahydrofuran (f=2 Mn=2000 g/mol, OH=56 mg KOH/g), trifunctional polyether polyol containing secondary hydroxyl groups (f=3, Mn=3500 g/mol, OH=48, Viscosity (25° C.)=600 mPa·s; or f=3, Mn=3000 g/mol, OH=53 mg KOH/g Viscosity (25° C.)=553 mPa·s), polypropylene glycol (f=2, Mn=500 g/mol, OH=248 mg KOH/g Viscosity (25° C.)=72 mPa·s), polyether polyol based on sucrose (f=5, Mn=500 g/mol, OH=490 mg KOH/g Viscosity (25° C.)=8450 mPa·s), tetrafunctional polyether polyol based on ethylenediamine and propylene oxide (f=4, Mn=300 g/mol, OH=753 mg KOH/g Viscosity (25° C.)=42000 mPa·s), and a mixture of two or more thereof, more preferably selected from the group consisting of polytetrahydrofuran (f=2 Mn=2000 g/mol, OH-56 mg KOH/g) and trifunctional polyether polyol containing secondary hydroxyl groups (f=3, Mn=3500 g/mol, OH=48, Viscosity (25° C.)=600 mPa·s; or f=3, Mn=3000 g/mol, OH=53 mg KOH/g Viscosity (25° C.)=553 mPa·s). For viscosity at 25° C.: DIN 53 240 and for OH value DIN EN 12092.

Alternatively, aliphatic polycarbonate polyols suitable as polyol are obtainable by reaction of carbonic acid derivatives, for example diphenyl carbonate, dimethyl carbonate or phosgene, with diols. Useful diols of this kind include, for example, ethylene glycol, propan-1,2- and -1,3-diol, butane-1,3- and 1,4-diol, hexane-1,6-diol, octane-1,8-diol, neopentyl glycol, 1,4-bishydroxymethyl-cyclohexane, 2-methylpropane-1,3-diol, 2,2,4-trimethylpentane-1,3-diol, dipropylene glycol, polypropylene glycols, dibutylene glycol, polybutylene glycols, but also lactone-modified diols. The diol component preferably contains 40% to 100% by weight of hexane-1,6-diol and/or hexanediol derivatives, preferably those having ether or ester groups as well as terminal OH groups, for example products which are obtained by reaction of 1 mol of hexanediol with at least 1 mol, preferably 1 to 2 mol, of ε-caprolactone or by etherification of hexanediol with itself to give di- or trihexylene glycol. It is also possible to use polyether polycarbonate polyols. Amongst aliphatic polycarbonate polyols preference is given to polycarbonate polyols based on dimethyl carbonate and hexanediol and/or butanediol and/or &-caprolactone. Very particular preference is given to polycarbonate polyols based on dimethyl carbonate and hexanediol and/or &-caprolactone. Preferred polycarbonate polyols have a molecular weight Mn of 400 to 10.000 g/mol, preferably of 500 to 5.000 g/mol, determined by gel permeation chromatography as described above.

Other possible polyols are mentioned by way of example in “Kunststoffhandbuch [Plastics handbook], volume 7, Polyurethane [Polyurethanes]”, Carl Hanser Verlag, 3rd edition 1993, chapter 3.1, 3.2 and 3.3.2.

Preferably, the at least one isocyanate (i), the at least one polyol (ii) and the at least one secondary amine (iii) are reacted in the absence of a solvent.

Preferably, the poly(urea urethane) polymer is obtainable or obtained by a process comprising
reacting (i), (ii) and/or (iii), more preferably (i) and (ii), with at least one additive, wherein the at least one additive selected from the group consisting of benzoyl chloride and diethylene glycol bis-chloroformate.

Any other additive than those listed above known by the skilled person might be used for the reaction of (i), (ii) and/or (iii).

Preferably, the poly(urea urethane) polymer is obtainable or obtained in the absence of a catalyst.

Preferably, the poly(urea urethane) polymer is obtained or obtainable by a process comprising
reacting the at least one isocyanate (i) with the at least one polyol (ii), obtaining a prepolymer, and
reacting the obtained pre-polymer with the at least one secondary amine (iii);
   or
reacting the at least one isocyanate (i) with the at least one secondary amine (iii), obtaining a pre-polymer, and
reacting the obtained pre-polymer with the at least one polyol (ii).

Preferably, the molar ratio of—NCO of the at least one isocyanate (i) relative to—OH of the at least one polyol (ii) is in the range of from 1:0.50 to 1:0.10, more preferably in the range of from 1:0.40 to 1:0.15, more preferably in the range of from 1:0.30 to 1:0.20.

Preferably, the molar ratio of —NCO of the at least one isocyanate (i) relative to —NH— of the at least one secondary amine (iii) is in the range of from 1:1.50 to 1:0.5, more preferably in the range of from 1:1.20 to 1:0.60, more preferably in the range of from 1:0.8 to 1:0.7.

Preferably, the reaction of the components (i), (ii) and/or (iii) is performed at a temperature in the range of from more than 0 to 200° C., more preferably in the range of from 1 to 200° C., more preferably in the range of from 10 to 150° C., more preferably in the range of from 20 to 90° C.

Preferably, the poly(urea-urethane) polymer is obtained or obtainable by a process further comprising curing the mixture of (i), (ii) and (iii), more preferably at a temperature in the range of from 90 to 200° C., more preferably in the range of from 100 to 150° C. Preferably, the poly(urea-urethane) polymer is thermoplastic or thermoset.

Preferably the poly(urea-urethane) polymer of the present invention is a covalent adaptable polymer, preferably a covalent adaptable network (CAN) thermoset or covalent adaptable system (CAS)/thermoplastic.

Preferably the poly(urea-urethane) polymer of the present invention is recyclable.

Preferably the poly(urea-urethane) polymer has a solubility in toluene in the range of 0.05:1 to 1:1 g/mL (grams of dissolved polymer:mL of solvent) measured at a temperature of 110° C. and after a duration of at least 12 hours of heating at ambient pressure, more preferably the poly(urea-urethane) polymer has a solubility in toluene in the range of 0.075:1 to 0.5:1 g/mL (grams of dissolved polymer:mL of solvent) measured at a temperature of 110° C. and after a duration of at least 12 hours of heating at ambient pressure.

Preferably the poly(urea-urethane) polymer has a solubility in 1,3-dimethyl-2-imidazolidinone in the range of 0.05:1 to 1:1 g/mL (grams of dissolved polymer:mL of solvent) measured at a temperature of 130° C. and after a duration of at least 20 hours of heating at ambient pressure, more preferably the poly(urea-urethane) polymer has a solubility in an organic solvent in the range of 0.075:1 to 0.5:1 g/mL (grams of dissolved polymer:mL of solvent) measured at a temperature of 130° C. and after a duration of at least 20 hours of heating at ambient pressure.

Preferably the poly(urea-urethane) polymer has a melting point in the range of from 10° C. to 200° C. at 880 kPa pressure determined by hot press (preferably measured with 20 kN of applied force using a circle shaped press having a 17 cm diameter), more preferably in the range of from 50° C. to 190° C. at 880 kPa pressure determined by hot press (preferably measured with 20 kN of applied force using a circle shaped press having a 17 cm diameter), more preferably in the range of from 60° C. to 180° C. at 880 kPa pressure determined by hot press (preferably measured with 20 kN of applied force using a circle shaped press having a 17 cm diameter).

The present invention further relates to a poly(urea-urethane) polymer-based composite obtainable or obtained by
reacting the following components
   (i) at least one isocyanate;
   (ii) at least one polyol; and
   (iii) at least one secondary amine having the following formula (I)

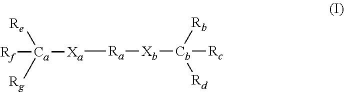

wherein —Rₐ— is selected from the group consisting of —Z₁—, —Z₂—, —Z₃—, —Z₄—, —Z₅—, —Z₆—, —Z₇—, —Z₇—, —Z₈—, —Z₉—, —Z₁₀—, —Z₁₁—, —Z₁₃—, Z₁—Z₅—, —Z₅—Z₁—Z₅, —Z₁—Z₆—, —Z₁—Z₇, —Z₁—Z₈—, —Z₁—Z₉—, —Z₉—Z₁—Z₉—, —Z₁—Z₁₀—, —Z₃—Z₅—, —Z₃—Z₆—, —Z₃—Z₇—, Z₃—Z₈—, —Z₃—Z₉—, —Z₃—Z₁₀—, —Z₁—Z₅—Z₁—, Z₁—Z₉—Z₁—, —Z₉—Z₁ (—Z₁₁—Z₁)ₙ—Z₉—, with n=1, 2, 3, 4, 5, or 6, and —Z₁—Z₁₂—Z₁—; wherein
—Z₁— is a substituted or unsubstituted, linear or branched C₁-C₃₀ alkylene;
—Z₂— is a substituted or unsubstituted, linear or branched 2- to 300,000-membered heteroalkylene;
—Z₃— is a substituted or unsubstituted, linear or branched C₂-C₃₀ alkenylene;
—Z₄— is a substituted or unsubstituted, linear or branched 3- to 30-membered heteroalkenylene;
—Z₅— is a substituted or unsubstituted C₅-C₃₀ cycloalkylene;
—Z₆— is a substituted or unsubstituted 5- to 30-membered heterocycloalkylene;
—Z₇— is a substituted or unsubstituted C₅-C₃₀ cycloalkenylene;
—Z₈— is a substituted or unsubstituted 5- to 30-membered heterocycloalkenylen;
—Z₉— is a substituted or unsubstituted C₆-C₃₀ arylene;
—Z₁₀— is a substituted or unsubstituted 5- to 30-membered heteroarylene;
—Z₁₁— is a C₆-C₃₀ arylene substituted with —NHR or —OR, wherein R is selected from the group consisting of H and substituted or unsubstituted, linear or branched C₁-C₁₀ alkyl;
—Z₁₂— is —N(R_{f})—;
—Z₁₃— is a substituted or unsubstituted 5- to 30-membered heterocycloalkylene, wherein at least one of the one or more heteroatoms of Z₁₃ is from Xₐ;
wherein Cₐ is a C atom or a H atom and C_{b} is a C atom or a H atom, wherein at least one of Cₐ and C_{b} is a C atom;
wherein Xₐ is a O atom or NH and X_{b} is a O atom or NH, wherein at least one of Xₐ and X_{b} is NH, with the condition that for Xₐ and/or X_{b} being NH, the respective Cₐ and/or C_{b} is/are C atom(s);
wherein
(A) R_{c}, R_{d}, R_{f} and R_{g} independently of each other are selected from the group consisting of hydrogen, linear or branched, substituted or unsubstituted C₁-C₃₀ alkyl, linear or branched, substituted or unsubstituted C₂-C₃₀ alkenyl, substituted or unsubstituted, linear or branched 2- to 30-membered heteroalkyl, substituted or unsubstituted, linear or branched 3- to 30-membered heteroalkenyl, substituted or unsubstituted C₅-C₃₀ cycloalkyl, substituted or unsubstituted C₅-C₃₀ cycloalkenyl, substituted or unsubstituted 5- to 30-membered heterocycloalkyl, substituted or unsubstituted 5- to 30-membered heterocycloalkenyl, substituted or unsubstituted C₆-C₃₀ aryl, substituted or unsubstituted 5- to 30-membered heteroaryl, substituted or unsubstituted C₁-C₁₀ alkylene C₅-C₃₀ cycloalkyl, substituted or unsubstituted C₁-C₁₀ alkylene C₅-C₃₀ cycloalkenyl, substituted or unsubstituted C₁-C₁₀ alkylene 5- to 30-membered heterocycloalkyl, substituted or unsubstituted C₁-C₁₀ alkylene 5- to 30-membered heterocycloalkenyl, substituted or unsubstituted C₁-C₁₀ alkylene C₆-C₃₀ aryl and substituted or unsubstituted C₁-C₁₀ alkylene 5- to 30-membered heteroaryl,
   R_{b} and Rₑ independently of each other are defined as R_{c}, R_{d}, R_{f} and R_{g}; or
   R_{b} and Rₑ are none, and Cₐ and C_{b} are connected to each other via a single bond forming a heterocycle consisting of Cₐ, C_{b}, Xₐ, X_{b} and Rₐ; or
(B) Cₐ and Rₑ form a substituted or unsubstituted C₆-C₃₀ arylene, and both R_{f} and R_{g} are none; and
   C_{b} and R_{b} form a substituted or unsubstituted C₆-C₃₀ arylene, and both R_{c} and Rₐ are none; or
(C) —Cₐ and Rₑ form a substituted or unsubstituted C₆-C₃₀ arylene, and both R_{f} and R_{g} are none; or
   C_{b} and R_{b} form a substituted or unsubstituted C₆-C₃₀ arylene, and both R_{c} and R_{d} are none;
   wherein, when Cₐ and Rₑ form a substituted or unsubstituted C₆-C₃₀ arylene, R_{b}, R_{c} and Rₐ independently of each other are defined as any one of R_{c}, R_{d}, R_{f} and R_{g} under (A);
   wherein, when C_{b} and R_{b} form a substituted or unsubstituted C₆-C₃₀ arylene, Rₑ, R_{f} and R_{g} independently of each other are defined as any one of R_{c}, R_{d}, R_{f} and R_{g} under (A),
obtaining a mixture comprising a poly(urea-urethane) polymer, more preferably the poly(urea-urethane) polymer as described herein;
and
bringing in contact the obtained mixture with (iv):
(iv) a filler, the filler being selected from the group consisting of glass fibers, carbon fibers, mineral fibers, textiles, metal meshs, metal fibers, metal rods, carbonates, wood, and a mixture of two or more thereof.

Preferably, the at least one secondary amine (iii) has the following formula (I)

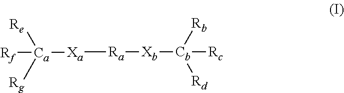

wherein —Rₐ— is selected from the group consisting of —Z₁—, —Z₂—, —Z₃—, —Z₄—, —Z₅—, —Z₆—, —Z₇—, —Z₇—, —Z₈—, —Z₉—, —Z₁₀—, —Z₁₁—, —Z₁₃—, —Z₁—Z₅—, —Z₅—Z₁—Z₅—, —Z₁—Z₆—, —Z₁—Z₇—, —Z₁—Z₈—, —Z₁—Z₉—, —Z₉—Z₁—Z₉—, —Z₁—Z₁₀—, —Z₃—Z₅—, —Z₃—Z₆—, —Z₃—Z₇—, Z₃—Z₈—, —Z₃—Z₉—, —Z₃—Z₁₀—, —Z₁—Z₅—Z₁—, Z₁—Z₉—Z₁—, —Z₉—Z₁ (—Z₁₁—Z₁)ₙ—Z₉—, with n=1, 2, 3, 4, 5, or 6, and —Z₁—Z₁₂—Z₁—; wherein
—Z₁— is a substituted or unsubstituted, linear or branched C₁-C₃₀ alkylene;
—Z₂— is a substituted or unsubstituted, linear or branched 2- to 300,000-membered heteroalkylene;
—Z₃— is a substituted or unsubstituted, linear or branched C₂-C₃₀ alkenylene;
—Z₄— is a substituted or unsubstituted, linear or branched 3- to 30-membered heteroalkenylene;
—Z₅— is a substituted or unsubstituted C₅-C₃₀ cycloalkylene;
—Z₆— is a substituted or unsubstituted 5- to 30-membered heterocycloalkylene;
—Z₇— is a substituted or unsubstituted C₅-C₃₀ cycloalkenylene;
—Z₈— is a substituted or unsubstituted 5- to 30-membered heterocycloalkenylen;
—Z₉— is a substituted or unsubstituted C₆-C₃₀ arylene;
—Z₁₀— is a substituted or unsubstituted 5- to 30-membered heteroarylene;
—Z₁₁— is a C₆-C₃₀ arylene substituted with —NHR or —OR, wherein R is selected from the group consisting of H and substituted or unsubstituted, linear or branched C₁-C₁₀ alkyl;
—Z₁₂— is —N(R_{f})—; —Z₁₃— is a substituted or unsubstituted 5- to 30-membered heterocycloalkylene, wherein at least one of the one or more heteroatoms of Z₁₃ is from Xₐ;
wherein Cₐ is a C atom or a H atom and C_{b} is a C atom or a H atom, wherein at least one of Cₐ and C_{b} is a C atom;
wherein Xₐ is a O atom or NH and Xₚ is a O atom or NH, wherein at least one of X, and Xₚ is NH, with the condition that for Xₐ and/or Xₚ being NH, the respective Cₐ and/or C_{b} is/are C atom(s);
wherein
(A) R_{c}, R_{d}, R_{f} and R_{g} independently of each other are selected from the group consisting of hydrogen, linear or branched, substituted or unsubstituted C₁-C₃₀ alkyl, linear or branched, substituted or unsubstituted C₂-C₃₀ alkenyl, substituted or unsubstituted, linear or branched 2- to 30-membered heteroalkyl, substituted or unsubstituted, linear or branched 3- to 30-membered heteroalkenyl, substituted or unsubstituted C₅-C₃₀ cycloalkyl, substituted or unsubstituted C₅-C₃₀ cycloalkenyl, substituted or unsubstituted 5- to 30-membered heterocycloalkyl, substituted or unsubstituted 5- to 30-membered heterocycloalkenyl, substituted or unsubstituted C₆-C₃₀ aryl, substituted or unsubstituted 5- to 30-membered heteroaryl, substituted or unsubstituted C₁-C₁₀ alkylene C₅-C₃₀ cycloalkyl, substituted or unsubstituted C₁-C₁₀ alkylene C₅-C₃₀ cycloalkenyl, substituted or unsubstituted C₁-C₁₀ alkylene 5- to 30-membered heterocycloalkyl, substituted or unsubstituted C₁-C₁₀ alkylene 5- to 30-membered heterocycloalkenyl, substituted or unsubstituted C₁-C₁₀ alkylene C₆-C₃₀ aryl and substituted or unsubstituted C₁-C₁₀ alkylene 5- to 30-membered heteroaryl,
   R_{b} and Rₑ independently of each other are defined as R_{c}, R_{d}, R_{f} and R_{g}; or
   R_{b} and Rₑ are none, and Cₐ and C_{b} are connected to each other via a single bond forming a heterocycle consisting of Cₐ, C_{b}, Xₐ, Xₚ and Rₐ; or
(B) Cₐ and Rₑ form a substituted or unsubstituted C₆-C₃₀ arylene, more preferably a phenyl, and both R_{f} and R_{g} are none; and
   C_{b} and R_{b} form a substituted or unsubstituted C₆-C₃₀ arylene, more preferably a phenyl, and both R_{c} and R_{d} are none.

Preferably, the filler (iv) is glass fibers.

Preferably, the at least one polyol, the at least one isocyanate, and the at least one secondary amine are defined as above for the poly(urea-urethane) polymer.

Further, the present invention relates to a process for preparing a poly(urea-urethane) polymer to the present invention comprising:
(a) reacting at least one isocyanate (i) with at least one polyol (ii), obtaining a pre-polymer;
(b) bringing in contact the pre-polymer obtained in (a) with at least one secondary amine, the at least one secondary amine having the formula (I) as defined in the present invention, obtaining the poly(urea-urethane) polymer; or
(a′) reacting at least one isocyanate (i) with at least one secondary amine, the at least one secondary amine having the formula (I) as defined in the present invention, obtaining a pre-polymer;
(b′) bringing in contact the pre-polymer obtained in (a′) with at least one polyol (ii), poly(urea-urethane) polymer.

Preferably, (a) or (a′) is performed at a temperature in the range of from 0 to 200° C., more preferably in the range of from 1 to 200° C., more preferably in the range of from 10 to 150° C., more preferably in the range of from 20 to 90° C.

Preferably, one or more of (a) and (b) or one or more of (a′) and (b′), more preferably (a) and (b) or (a′) and (b′), are performed in the absence of a solvent.

Preferably, (b) or (b′) is performed at a temperature in the range of from 0 to 200° C., more preferably in the range of from 1 to 200° C., more preferably in the range of from 10 to 150° C., more preferably in the range of from 20 to 90° C.

Preferably, the process further comprises
(c) curing the mixture obtained in (b) or (b′), more preferably at a temperature in the range of from 90 to 150° C., more preferably in the range of from 100 to 120° C.

Furthermore, the present invention relates to a process for preparing a composite according to the present invention, the process comprising:
(1) providing a poly(urea urethane) polymer comprising
   (1.1) reacting at least one isocyanate (i) with at least one polyol (ii), obtaining a prepolymer;
   (1.2) bringing in contact the pre-polymer obtained in (1.1) with at least one secondary amine, the at least one secondary amine (iii) having the formula (I) as defined in the present invention;
   or
   (1.1′) reacting at least one isocyanate (i) with at least one secondary amine, the at least one secondary amine (iii) having the formula (I) as defined in the present invention, obtaining a pre-polymer;
   (1.2′) bringing in contact the pre-polymer obtained in (1.1′) with at least one polyol (ii);
(2) bringing in contact the polymer obtained in (1.2) or (1.2′) with a filler (iv) as defined in the present invention.

Preferably, (1) is performed at a temperature in the range of from 0 to 200° C., more preferably in the range of from 1 to 200° C., more preferably in the range of from 10 to 150° C., more preferably in the range of from 20 to 90° C.

Preferably, one or more of (1) and (2), more preferably (1) and (2), are performed in the absence of a solvent.

Preferably, bringing the polymer in contact with the filler in (2) is performed by mixing or pressing.

In the context of the present invention, it is also conceivable that other thermomechanical methods are used for step (2) such as injection molding, infusion.

Preferably, pressing is performed at a pressure in the range of from 440 kPa to 1320 kPa (preferably measured as 10 to 30 KN of applied force pressed by a circular press having a diameter of 17 cm), more preferably in the range of from 660 kPa to 1100 kPa (preferably measured as 15 to 25 KN of applied force pressed by a circular press having a diameter of 17 cm), more preferably in the range of from 792 kPa to 968 kPa (preferably measured as 18 to 22 kN of applied force pressed by a circular press having a diameter of 17 cm).

Preferably, pressing is hot-pressing, more preferably performed at a temperature in the range of from 100 to 200° C., more preferably in the range of from 120 to 160° C., more preferably in the range of from 130 to 150° C.

Preferably, pressing is performed for a duration in the range of from 1 to 60 min, more preferably in the range of from 4 to 20 min, more preferably in the range of from 5 to 10 min.

Preferably, the process further comprises
(1.3) curing the polymer obtained in (1.2) or (1.2′), more preferably at a temperature in the range of from 90 to 150° C., more preferably in the range of from 100 to 120° C.;
or
(3) curing the polymer obtained in (2), more preferably at a temperature in the range of from 90 to 150° C., more preferably in the range of from 100 to 120° C.

The present invention further relates to a use of a poly(urea-urethane) polymer according to the present invention or a poly(urea-urethane) polymer composite according to the present invention as a recyclable material.

The present invention further relates to a recyclable article comprising a poly(urea-urethane) polymer according to the present invention or a poly(urea-urethane) polymer composite according to the present invention.

The present invention further relates to a process for shaping a poly(urea-urethane) polymer according to the present invention or a poly(urea-urethane) polymer obtainable or obtained by a process according to the present invention comprising:

shaping the poly(urea-urethane) polymer, wherein shaping the polymer comprises
(x) applying pressure and heat to the poly(urea-urethane) polymer, obtaining a shaped body, more preferably a foil or a sheet; or
(x′) extruding the poly(urea-urethane) polymer, obtaining a shaped body, more preferably a granulate or a paste.

Preferably, the applied pressure according to (x) is in the range of from 10³ to 10⁷ Pa, more preferably in the range of from 1.5×10³ to 10⁶ Pa.

Preferably, the heating according to (x) is performed at a temperature is the range of from 60° C. to 250° C., more preferably in the range of from 65 to 150° C., more preferably in the range of from 70 to 130° C.

Preferably, extruding according to (x′) is performed at a temperature in the range of from 140 to 220° C., more preferably in the range of from 160 to 200° C., more preferably in the range of from 170 to 190° C.

Preferably, the poly(urea-urethane) polymer is extruded at a torque in the range of from 2.0 to 2.4 kNm, more preferably at a maximum torque of 2.2 kNm.

The present invention is further illustrated by the following set of embodiments and combinations of embodiments resulting from the dependencies and back-references as indicated. In particular, it is noted that in each instance where a range of embodiments is mentioned, for example in the context of a term such as “The poly(urea-urethane) polymer of any one of embodiments 1 to 4”, every embodiment in this range is meant to be explicitly disclosed for the skilled person, i.e. the wording of this term is to be understood by the skilled person as being synonymous to “The poly(urea-urethane) polymer of any one of embodiments 1, 2, 3, and 4”. Further, it is explicitly noted that the following set of embodiments represents a suitably structured part of the general description directed to preferred aspects of the present invention, and, thus, suitably supports, but does not represent the claims of the present invention.

1. A poly(urea-urethane) polymer obtainable or obtained by a process comprising:
reacting the following components
(i) at least one isocyanate;
(ii) at least one polyol; and
(iii) at least one secondary amine having the following formula (I)

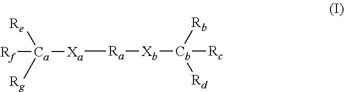

wherein —Rₐ— is selected from the group consisting of —Z₁—, —Z₂—, —Z₃—, —Z₄—, —Z₅—, —Z₆—, —Z₇—, —Z₇—, —Z₈—, —Z₉—, —Z₁₀—, —Z₁₁—, —Z₁₃—, —Z₁—Z₅—, —Z₅—Z₁—Z₅—, —Z₁—Z₆—, —Z₁—Z₇—, —Z₁—Z₈—, —Z₁—Z₉—, —Z₉—Z₁—Z₉—, —Z₁—Z₁₀—, —Z₃—Z₅—, —Z₃—Z₆—, —Z₃—Z₇—, Z₃—Z₈—, —Z₃—Z₉—, —Z₃—Z₁₀—, —Z₁—Z₅—Z₁—, Z₁—Z₉—Z₁—, —Z₉—Z₁ (—Z₁₁—Z₁)ₙ—Z₉—, with n=1, 2, 3, 4, 5, or 6, and —Z₁—Z₁₂—Z₁—; wherein
—Z₁— is a substituted or unsubstituted, linear or branched C₁-C₃₀ alkylene;
—Z₂— is a substituted or unsubstituted, linear or branched 2- to 300,000-membered heteroalkylene;
—Z₃— is a substituted or unsubstituted, linear or branched C₂-C₃₀ alkenylene;
—Z₄— is a substituted or unsubstituted, linear or branched 3- to 30-membered heteroalkenylene;
—Z₅— is a substituted or unsubstituted C₅-C₃₀ cycloalkylene;
—Z₆— is a substituted or unsubstituted 5- to 30-membered heterocycloalkylene;
—Z₇— is a substituted or unsubstituted C₅-C₃₀ cycloalkenylene;
—Z₈— is a substituted or unsubstituted 5- to 30-membered heterocycloalkenylen;
—Z₉— is a substituted or unsubstituted C₆-C₃₀ arylene;
—Z₁₀— is a substituted or unsubstituted 5- to 30-membered heteroarylene;
—Z₁₁— is a C₆-C₃₀ arylene substituted with —NHR or —OR, wherein R is selected from the group consisting of H and substituted or unsubstituted, linear or branched C₁-C₁₀ alkyl;
—Z₁₂— is —N(R_{f})—;
—Z₁₃— is a substituted or unsubstituted 5- to 30-membered heterocycloalkylene, wherein at least one of the one or more heteroatoms of Z₁₃ is from Xₐ;
wherein Cₐ is a C atom or a H atom and C_{b} is a C atom or a H atom, wherein at least one of Cₐ and C_{b} is a C atom;
wherein Xₐ is a O atom or NH and X_{b} is a O atom or NH, wherein at least one of Xₐ and X_{b} is NH, with the condition that for Xₐ and/or X_{b} being NH, the respective Cₐ and/or C_{b} is/are C atom(s);
wherein
(A) R_{c}, R_{d}, R_{f} and R_{g} independently of each other are selected from the group consisting of hydrogen, linear or branched, substituted or unsubstituted C₁-C₃₀ alkyl, linear or branched, substituted or unsubstituted C₂-C₃₀ alkenyl, substituted or unsubstituted, linear or branched 2- to 30-membered heteroalkyl, substituted or unsubstituted, linear or branched 3- to 30-membered heteroalkenyl, substituted or unsubstituted C₅-C₃₀ cycloalkyl, substituted or unsubstituted C₅-C₃₀ cycloalkenyl, substituted or unsubstituted 5- to 30-membered heterocycloalkyl, substituted or unsubstituted 5- to 30-membered heterocycloalkenyl, substituted or unsubstituted C₆-C₃₀ aryl, substituted or unsubstituted 5- to 30-membered heteroaryl, substituted or unsubstituted C₁-C₁₀ alkylene C₅-C₃₀ cycloalkyl, substituted or unsubstituted C₁-C₁₀ alkylene C₅-C₃₀ cycloalkenyl, substituted or unsubstituted C₁-C₁₀ alkylene 5- to 30-membered heterocycloalkyl, substituted or unsubstituted C₁-C₁₀ alkylene 5- to 30-membered heterocycloalkenyl, substituted or unsubstituted C₁-C₁₀ alkylene C₆-C₃₀ aryl and substituted or unsubstituted C₁-C₁₀ alkylene 5- to 30-membered heteroaryl,
   R_{b} and Rₑ independently of each other are defined as R_{c}, R_{d}, R_{f} and R_{g}; or R_{b} and Rₑ are none, and Cₐ and C_{b} are connected to each other via a single bond forming a heterocycle consisting of Cₐ, Ch, Xₐ, Xₚ and Rₐ; or
(B) Cₐ and Rₑ form a substituted or unsubstituted C₆-C₃₀ arylene, preferably a phenyl, and both R_{f} and R_{g} are none; and
   C_{b} and R_{b} form a substituted or unsubstituted C₆-C₃₀ arylene, preferably a phenyl, and both R_{c} and R_{d} are none; or
(C) —Cₐ and Rₑ form a substituted or unsubstituted C₆-C₃₀ arylene, and both R_{f} and R_{g} are none; or
   —C_{b} and R_{b} form a substituted or unsubstituted C₆-C₃₀ arylene, and both R_{c} and R_{d} are none;
   wherein, when Cₐ and Rₑ form a substituted or unsubstituted C₆-C₃₀ arylene, R_{b}, R_{c} and R_{d} independently of each other are defined as any one of R_{c}, Rₐ, R_{f} and R_{g} under (A);
   wherein, when C_{b} and R_{b} form a substituted or unsubstituted C₆-C₃₀ arylene, Rₑ, R_{f} and R_{g} independently of each other are defined as any one of R_{c}, Rₐ, R_{f} and R_{g} under (A).

2. The poly(urea-urethane) polymer of embodiment 1, wherein X, is NH, X, is NH, the secondary amine (iii) having the following formula (II)

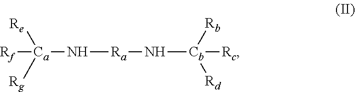

wherein Cₐ, C_{b}, R_{b}, R_{c}, R_{d}, Rₑ, R_{f}, R_{g}, and —Rₐ— are as defined in formula (I).

3. The poly(urea-urethane) polymer of embodiment 1 or 2, wherein-Rₐ— is selected from the group consisting of —Z₁—, —Z₂—, —Z₅—, —Z₉—, —Z₁₀—, —Z₁—Z₅—, —Z₅—Z₁—Z₅—, —Z₉—Z₁—Z₉—, —Z₁—Z₅—Z₁—, —Z₁—Z₉—Z₁—, and —Z₉—Z₁ (—Z₁₁—Z₁)ₙ—Z₉—, wherein n=1, 2, 3, 4, 5, or 6, preferably selected from the group consisting of —Z₂—, —Z₉—Z₁—Z₉—, and —Z₉—Z₁ (—Z₁₁—Z₁)ₙ—Z₉—, wherein n=1, 2, 3, 4, 5, or 6, more preferably selected from the group consisting of —Z₂— and —Z₉—Z₁ (—Z₁₁—Z₁)ₙ—Z₉—, wherein n=1, 2, 3, 4, 5, or 6.

4. The poly(urea-urethane) polymer of any one of embodiments 1 to 3, wherein —Z₁— is selected from the group consisting of —CH₂—, —CH₂—CH₂—, —CH₂—CH(CH₃)—, —CH(CH₃)—CH₂—, —CH(CH₃)—CH₂—CH₂—, —CH₂—CH₂—CH(CH₂CH₃)—, —C(CH₃)₂, —CH₂—C(CH₃)₂—CH₂—, —CH₂—CH(CH₃)—CH₂—C(CH₃)₂—CH₂—CH₂—, —CH₂—C(CH₃)₂—CH₂—CH(CH₃)—CH₂—CH₂—, —(CH₂)₃—, —(CH₂)₄—, —(CH₂)₅—, —(CH₂)₆—, —(CH₂)₉—, and —(CH₂)₁₀—.

5. The poly(urea-urethane) polymer of any one of embodiments 1 to 4, wherein —Z₉— is selected from the group consisting of phenylene, naphthylene, biphenylene, fluorenylene, and indenyl, wherein —Z₉— preferably is phenylene.

6. The poly(urea-urethane) polymer of embodiment 5, wherein-Rₐ— is —Z₉—Z₁—Z₉—, with —Z₉— is phenylene, preferably para-phenylene, and —Z₁— is —CH₂—.

7. The poly(urea-urethane) polymer of embodiment 5, wherein —Rₐ— is —Z₉—Z₁ (—Z₁₁—Z₁)ₙ—Z₉—, wherein n=1, 2, 3, 4, 5, or 6, with —Z₉— is phenylene and —Z₁— is —CH₂— and wherein —Z₁₁— is a C₆-arylene substituted with —NHR.

8. The poly(urea-urethane) polymer of any one of embodiments 1 to 5, wherein —Z₂— is a substituted or unsubstituted, linear or branched 2- to 500-membered heteroalkylene, preferably a substituted or unsubstituted, linear or branched 2- to 35-membered heteroalkylene, more preferably a substituted or unsubstituted, linear or branched 2- to 30-membered heteroalkylene.

9. The poly(urea-urethane) polymer of embodiment 8, wherein —Z₂— is selected from the group consisting of —CH₂—CH₂—NH—CH₂—CH₂—, —CH₂—CH₂—NH—CH₂—CH₂—CH₂—, —CH(CH₃)—CH₂—NH—CH₂—CH(CH₃)—, —CH₂—CH₂—CH₂—N(CH₃)—CH₂—CH₂—CH₂—, —CH₂—CH₂—CH₂—NH—CH₂—CH₂—CH₂, —CH₂—CH₂—CH₂—NH—CH₂—CH₂—NH—CH₂—CH₂—CH₂—, —CH₂—CH₂—NH—CH₂—CH₂—NH—CH₂—CH₂—, —CH₂—CH₂—NH—CH₂—CH₂—NH—CH₂—CH₂—NH—CH₂—CH₂, —CH₂—CH₂—O—CH₂—CH₂—, —CH₂—CH₂—CH₂—O—CH₂—CH₂—O—CH₂—CH₂—O—CH₂—CH₂—CH₂—, —CH₂—CH₂—CH₂—O—CH₂—CH₂—CH₂—CH₂—O—CH₂—CH₂—CH₂—, —CH₂—CH₂—O—CH₂—CH₂—O—CH₂—CH₂—, —(CH(CH₃)—CH₂—O)₁₋₁₀₀—CH(CH₃)—CH₂—,
—[CH(CH₃)—CH₂—O]ₘ₁—CH₂—C(Rₓ₁)(R_{y1})—[O—CH₂—CH(CH₃)]ₒ₁—, wherein Rₓ₁ is —CH₂—CH₃, wherein R_{y1} is [—O—CH₂—CH(CH₃)]ₙ₁—NH—C(Rₗ)(Rₘ)(Rₙ), wherein m1+n1+o1 is in the range of from 5 to 6,
   —[CH(CH₃)—CH₂—O]ₘ₂—CH₂—CH(R_{y2})—[O—CH₂—CH(CH₃)]ₒ₂—, wherein R_{y2} is [—O—CH₂—CH(CH₃)]ₙ₂—NH—C(Rₗ)(Rₘ)(Rₙ), and wherein m2+n2+o2 is in the range of 45 to 85,
   —[CH(CH₃)—CH₂—O]ₘ₃—[CH₂—CH₂—O]ₙ₃—[CH₂—CH(CH₃)—O]ₒ₃—CH₂—CH(CH)₃—,
wherein n3 is in the range of from 8 to 10 and m3+o3 is in the range of from 3 to 4, or wherein n3 is in the range of from 12 to 13 and m3+o3 is in the range of from 5 to 7, or wherein n3 is in the range of from 38 to 40 and m3+o3 is in the range of from 5 to 7,
—[CH—CH₂—O]ₘ₄—CH₂—CH₂, wherein m4 is in the range of from 8 to 250, and
—[CH₂—CH₂—NH]ₘ₅—, wherein m5 is in the range of from 10 to 100,000;
wherein —Z₂— is preferably —[CH(CH₃)—CH₂—O]ₘ₁—CH₂—C(Rₓ₁)(R_{y1})—CH₂—[O—CH₂—CH(CH₃)]ₒ₁—, wherein Rₓ₁ is —CH₂—CH₃, wherein R_{y1} is —CH₂—[O—CH₂—CH(CH₃)]ₙ₁—NH—C(Rₗ)(Rₘ)(Rₙ), wherein m1+n1+o1 is in the range of 5 to 6.

10. The poly(urea-urethane) polymer of any one of embodiments 1 to 9, wherein R_{c}, R_{d}, R_{f} and R_{g} independently of each other are selected from the group consisting of hydrogen, methyl, ethyl, propyl, iso-propyl, butyl, pentyl, hexyl, octyl, dodecyl, sec-butyl, tert-butyl, sec-isopentyl, 2-pentyl, 2-methyl-4-pentyl, 3-pentyl, 2-methyl-pentyl, 2,6-dimethyl-4-heptyl, 3-pinanyl-methyl, cyclopentyl, cyclohexyl, dicyclohexylmethyl, cyclohexylmethyl, cyclododecyl, phenyl, benzyl, cyclohexyl(phenyl)methyl, and —C(OH)H—Rₖ, preferably selected from the group consisting of hydrogen, methyl, and ethyl, more preferably selected from the group consisting of hydrogen, methyl and ethyl,
wherein Rₓ is selected from the group consisting of hydrogen, linear or branched, substituted or unsubstituted C₁-C₃₀ alkyl, linear or branched, substituted or unsubstituted C₂-C₃₀ alkenyl, substituted or unsubstituted, linear or branched 2- to 30-membered heteroalkyl, substituted or unsubstituted, linear or branched 3- to 30-membered heteroalkenyl, substituted or unsubstituted C₅-C₃₀ cycloalkyl, substituted or unsubstituted C₅-C₃₀ cycloalkenyl, substituted or unsubstituted 5- to 30-membered heterocycloalkyl, substituted or unsubstituted 5- to 30-membered heterocycloalkenyl, substituted or unsubstituted C₆-C₃₀ aryl, substituted or unsubstituted 5- to 30-membered heteroaryl, substituted or unsubstituted C₁-C₁₀ alkylene C₅-C₃₀ cycloalkyl, substituted or unsubstituted C₁-C₁₀ alkylene C₅-C₃₀ cycloalkenyl, substituted or unsubstituted C₁-C₁₀ alkylene 5- to 30-membered heterocycloalkyl, substituted or unsubstituted C₁-C₁₀ alkylene 5- to 30-membered heterocycloalkenyl, substituted or unsubstituted C₁-C₁₀ alkylene C₆-C₃₀ aryl and substituted or unsubstituted C₁-C₁₀ alkylene 5- to 30-membered heteroaryl.

11. The poly(urea-urethane) polymer of any one of embodiments 1 to 10, wherein R_{b} and Rₑ independently of each other are selected from the group consisting of hydrogen, methyl, ethyl, propyl, iso-propyl, butyl, pentyl, hexyl, octyl, dodecyl, sec-butyl, tert-butyl, sec-isopentyl, 2-pentyl, 2-methyl-4-pentyl, 3-pentyl, 2-methyl-pentyl, 2,6-dimethyl-4-heptyl, 3-pinanyl-methyl, cyclopentyl, cyclohexyl, dicyclohexylmethyl, cyclohexylmethyl, cyclododecyl, phenyl, benzyl, and cyclohexyl(phenyl)methyl, preferably selected from the group consisting of hydrogen, methyl, and ethyl.

12. The poly(urea-urethane) polymer of any one of embodiments 1 to 11, wherein any one of R_{b}, R_{c}, and R_{d} is H, and any one of Rₑ, R_{f}, and R_{g} is H;
wherein one of R_{b}, R_{c}, and R_{d} other than the one being H is CH₃, and one of Rₑ, R_{f}, and R_{g} other than the one being H is CH₃.

13. The poly(urea-urethane) polymer of any one of embodiments 1 to 12, wherein any one of R_{b}, R_{c}, and R_{d} is an ethyl group, and any one of Rₑ, R_{f}, and R_{g} is an ethyl group; preferably wherein
one of R_{b}, R_{c}, and R_{d} other than the one being an ethyl group is H,
one of Rₑ, R_{f}, and R_{g} other than the one being an ethyl group is H,
one of R_{b}, R_{c}, and R_{d} other than the one being an ethyl group or H is CH₃, and
one of Rₑ, R_{f}, and R_{g} other than the one being an ethyl group or H is CH₃.

14. The poly(urea-urethane) polymer of any one of embodiments 1 to 13, wherein the at least one secondary amine (iii) is 4,4′-Methylenebis(N-sec-butylaniline) (DIB-MDA);
or wherein the at least one secondary amine (iii) is DIB-butanediamine (N,N′-di-secbutyl-1,4-butanediamine);
or wherein the at least one secondary amine (iii) is 2-(ethylamino) ethanol.

15. The poly(urea-urethane) polymer of any one of embodiments 1 to 13, wherein the at least one secondary amine (iii) is an sec-butyl-modified polyether amine, CH₃—CH₂—CH(CH₃)—NH—[CH(CH₃)—CH₂—O]ₘ₁—CH₂—C(Rₓ₁)(R_{y1})—CH₂—[O—CH₂—CH(CH₃)]ₒ₁—NH—CH(CH₃)—CH₂—CH₃, wherein Rₓ₁ is —CH₂—CH₃, wherein R_{y1} is —CH₂—[O—CH₂—CH(CH₃)]ₙ₁—NH—CH(CH₃)—CH₂—CH₃, wherein m1+n1+o1 is in the range of 5 to 6.

16. The poly(urea-urethane) polymer of any one of embodiments 1 to 15, wherein the at least one isocyanate (i) has a NCO functionality of 2 or more, preferably of 2 or 3;
wherein preferably the at least one isocyanate (i) is a mixture of an isocyanate having a NCO functionality of 2 and an isocyanate having a NCO functionality of 3 or more, preferably the at least one isocyanate (i) is a mixture of an isocyanate having a NCO functionality of 2 and an isocyanate having a NCO functionality of 3.

17. The poly(urea-urethane) polymer of any one of embodiments 1 to 16, wherein the at least one isocyanate (i) is selected from the group consisting of monomeric methylene diphenylene diisocyanate (mMDI), polymethylene polyphenylene polyisocyanate (pMDI), a mixture of monomeric methylene diphenylene diisocyanate and polymethylene polyphenylene polyisocyanate (MDI), tolylene diisocyanate (TDI), isomers of xylylene diisocyanate (XDI), isomers of diisocyanatobenzene, xylene 2,6-diisocyanate, naphthylene 1,5-diisocyanate (1,5-NDI), butane 1,4-diisocyanate, pentane 1,5-diisocyanate (PDI), hexane 1,6-diisocyanate (HDI), octane 1,8-diisocyanate, nonane 1,9-diisocyanate, decane 1,10-diisocyanate, 2,2-dimethylpentane 1,5-diisocyanate, 2-methylpentane 1,5-diisocyanate (MPDI), 2,4,4 (or 2,2,4)-trimethylhexane 1,6-diisocyanate (TMDI), cyclohexane 1,3- and 1,4-diisocyanate, 1-isocyanato-3,3,5-trimethyl-5-isocyanatomethylcyclohexane (IPDI), methylene-bis(cyclohexyl isocyanate) (H12MDI), 2,4- or 2,6-diisocyanato-1-methylcyclohexane (H6TDI), 1-isocyanato-1-methyl-4 (3)isocyanatomethylcyclohexane (AMCI), 1,3-bis(isocyanatomethyl)cyclohexane, 1,4-bis(isocyanatomethyl)cyclohexane, bis(isocyanatomethyl) norbornane (NBDI), triphenylmethane-4,4′,4″-triisocyanate, toluene-2,4,6-triyl triisocyanate, ethyl ester 1-lysine triisocyanate, triisocyanatocyclohexane, tris(isocyanatomethyl)cyclohexane, triisocyanatomethylcyclohexane, 1,8-diisocyanato-4-(isocyanatomethyl) octane, undecane 1,6,11-triisocyanate, 1,7-diisocyanato-4-(3-isocyanatopropyl) heptane, 1,6-diisocyanato-3-(isocyanatomethyl) hexane, 2,2-bis[[4-(isocyanatomethyl)phenyl]methyl]butyl n-[[4-(isocyanatomethyl)phenyl]methyl]carbamate, (2,4,6-trioxotriazine-1,3,5 (2h,4h,6h)-triyl)tris(hexamethylene) isocyanate, 1,3,5-triisocyanatobenzene, tris(isocyanatohexyl) biuret, 3,3′,3″-[(1h,3h,5h)-2,4,6-trioxo-1,3,5-triazine-1,3,5-triyltris(methylene)]tris[3,5,5-trimethylcyclohexyl]triisocyanate, 1,3,5-triazine-2,4,6-triisocyanate, 2,4,4′-triisocyanato-dicyclohexylmethane, triisocyanate triphenylthiophosphate, 2,4,4′-diphenylethertriisocyanate, 1,3-Bis(3-isocyanato-4-methylphenyl)-1,3-diazetidine-2,4-dione, and a mixture of two or more thereof,
preferably selected from the group consisting of monomeric methylene diphenylene diisocyanate (mMDI), polymethylene polyphenylene polyisocyanate (pMDI), a mixture of monomer methylene diphenylene diisocyanate and polymethylene polyphenylene polyisocyanate (MDI), tolylene diisocyanate (TDI), naphthylene 1,5-diisocyanate (1,5-NDI), 1,4-diisocyanate, pentane 1,5-diisocyanate (PDI), hexane 1,6-diisocyanate (HDI), methylene-bis(cyclohexyl isocyanate) (H12MDI) and a mixture of two or more thereof.

18. The poly(urea-urethane) polymer of embodiment 17, wherein the at least one isocyanate (i) is selected from the group consisting of monomeric methylene diphenylene diisocyanate (mMDI), polymethylene polyphenylene polyisocyanate (pMDI), a mixture of monomer methylene diphenylene diisocyanate and polymethylene polyphenylene polyisocyanate (MDI) and tolylene diisocyanate (TDI).

19. The poly(urea-urethane) polymer of any one of embodiments 1 to 18, wherein the at least one polyol (i) is selected from the group consisting of polyester polyol, polyetherester polyol, polycarbonate polyol, polyacrylate polyol, polyolefine polyol, polyether polyol, and mixtures thereof.

20. The poly(urea-urethane) polymer of embodiment 19, wherein the at least one polyol (i) is selected from the group consisting of polyester polyol and polyether polyol.

21. The poly(urea-urethane) polymer of embodiment 20, wherein the at least one polyol (ii) is polyether polyol, the polyether polyol preferably being selected from the group consisting of polytetrahydrofuran, trifunctional polyether polyol containing secondary hydroxyl groups, polypropylene glycol, polyether polyol based on sucrose, tetrafunctional polyether polyol based on ethylenediamine and propylene oxide, and a mixture of two or more thereof, more preferably selected from the group consisting of polytetrahydrofuran and trifunctional polyether polyol containing secondary hydroxyl groups.

22. The poly(urea-urethane) polymer of any one of embodiments 1 to 21, wherein the at least one isocyanate (i), the at least one polyol (ii) and the at least one secondary amine (iii) are reacted in the absence of a solvent.

23. The poly(urea-urethane) polymer of any one of embodiments 1 to 22, wherein said polymer is obtainable or obtained by a process comprising reacting (i), (ii) and/or (iii), preferably (i) and (ii), with at least one additive, wherein the at least one additive selected from the group consisting of benzoyl chloride and diethylene glycol bis-chloroformate.

24. The poly(urea-urethane) polymer of any one of embodiments 1 to 23, wherein said polymer is obtainable or obtained by a process in the absence of a catalyst.

25. The poly(urea-urethane) polymer of any one of embodiments 1 to 24, being obtained or obtainable by a process comprising
reacting the at least one isocyanate (i) with the at least one polyol (ii), obtaining a pre-polymer, and
reacting the obtained pre-polymer with the at least one secondary amine (iii);
or being obtained or obtainable by a process comprising
reacting the at least one isocyanate (i) with the at least one secondary amine (iii), obtaining a pre-polymer, and
reacting the obtained pre-polymer with the at least one polyol (ii).

26. The poly(urea-urethane) polymer of any one of embodiments 1 to 25, wherein the molar ratio of —NCO of the at least one isocyanate (i) relative to —OH of the at least one polyol (ii) is in the range of from 1:0.50 to 1:0.10, preferably in the range of from 1:0.40 to 1:0.15, more preferably in the range of from 1:0.30 to 1:0.20.

27. The poly(urea-urethane) polymer of any one of embodiments 1 to 26, wherein the molar ratio of —NCO of the at least one isocyanate (i) relative to —NH— of the at least one secondary amine (iii) is in the range of from 1:1.50 to 1:0.5, preferably in the range of from 1:1.20 to 1:0.60, more preferably in the range of from 1:0.8 to 1:0.7.

28. The poly(urea-urethane) polymer of any one of embodiments 1 to 27, wherein the reaction of the components (i), (ii) and/or (iii) is performed at a temperature in the range of from more than 0 to 200° C., preferably in the range of from 1 to 200° C., more preferably in the range of from 10 to 150° C., more preferably in the range of from 20 to 90° C.

29. The poly(urea-urethane) polymer of any one of embodiments 1 to 27, being obtained or obtainable by a process further comprising curing the mixture of (i), (ii) and (iii), preferably at a temperature in the range of from 90 to 200° C., more preferably in the range of from 100 to 150° C.

30. The poly(urea-urethane) polymer of any one of embodiments 1 to 29, being a thermoplastic or a thermoset.

31. The poly(urea-urethane) polymer of any one of embodiments 1 to 30, having a solubility in toluene in the range of 0.05:1 to 1:1 g/mL (grams of dissolved polymer:mL of solvent) measured at a temperature of 110° C. and after a duration of at least 12 hours of heating at ambient pressure, preferably a solubility in toluene in the range of 0.075:1 to 0.5:1 g/mL (grams of dissolved polymer:mL of solvent) measured at a temperature of 110° C. and after a duration of at least 12 hours of heating at ambient pressure.

32. The poly(urea-urethane) polymer of any one of embodiments 1 to 31, having a solubility in 1,3-dimethyl-2-imidazolidinone in the range of 0.05:1 to 1:1 g/mL (grams of dissolved polymer:mL of solvent) measured at a temperature of 130° C. and after a duration of at least 20 hours of heating at ambient pressure, preferably a solubility in an organic solvent in the range of 0.075:1 to 0.5:1 g/mL (grams of dissolved polymer:mL of solvent) measured at a temperature of 130° C. and after a duration of at least 20 hours of heating at ambient pressure.

33. The poly(urea-urethane) polymer of any one of embodiments 1 to 32, having a melting point in the range of from 10° C. to 200° C. at 880 kPa pressure determined by hot press (preferably measured with 20 kN of applied force using a circle shaped press having a 17 cm diameter), more preferably in the range of from 50° C. to 190° C. at 880 kPa pressure determined by hot press (preferably measured with 20 kN of applied force using a circle shaped press having a 17 cm diameter), more preferably in the range of from 60° C. to 180° C. at 880 kPa pressure determined by hot press (preferably measured with 20 kN of applied force using a circle shaped press having a 17 cm diameter).

34. A poly(urea-urethane) polymer-based composite obtainable or obtained by
reacting the following components
(i) at least one isocyanate;
(ii) at least one polyol; and
(iii) at least one secondary amine having the following formula (1)

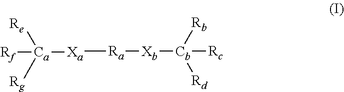

wherein —Rₐ— is selected from the group consisting of —Z₁—, —Z₂—, —Z₃—, —Z₄—, —Z₅—, —Z₆—, —Z₇—, —Z₇—, —Z₈—, —Z₉—, —Z₁₀—, —Z₁₁—, —Z₁₃—, —Z₁—Z₅—, —Z₅—Z₁—Z₅—, —Z₁—Z₆—, —Z₁—Z₇—, —Z₁—Z₈—, —Z₁—Z₉—, —Z₉—Z₁—Z₉—, —Z₁—Z₁₀—, —Z₃—Z₅—, —Z₃—Z₆—, —Z₃—Z₇—, Z₃—Z₈—, —Z₃—Z₉—, —Z₃—Z₁₀—, —Z₁—Z₅—Z₁—, —Z₁—Z₉—Z₁—, —Z₉—Z₁ (—Z₁₁—Z₁)ₙ—Z₉—, with n=1, 2, 3, 4, 5, or 6, and —Z₁—Z₁₂—Z₁—; wherein —Z₁— is a substituted or unsubstituted, linear or branched C₁-C₃₀ alkylene;
—Z₂— is a substituted or unsubstituted, linear or branched 2- to 300,000-membered heteroalkylene;
—Z₃— is a substituted or unsubstituted, linear or branched C₂-C₃₀ alkenylene;
—Z₄— is a substituted or unsubstituted, linear or branched 3- to 30-membered heteroalkenylene;
—Z₅— is a substituted or unsubstituted C₅-C₃₀ cycloalkylene;
—Z₆— is a substituted or unsubstituted 5- to 30-membered heterocycloalkylene;
—Z₇— is a substituted or unsubstituted C₅-C₃₀ cycloalkenylene;
—Z₈— is a substituted or unsubstituted 5- to 30-membered heterocycloalkenylen;
—Z₉— is a substituted or unsubstituted C₆-C₃₀ arylene;
—Z₁₀— is a substituted or unsubstituted 5- to 30-membered heteroarylene;
—Z₁₁— is a C₆-C₃₀ arylene substituted with —NHR or —OR, wherein R is selected from the group consisting of H and substituted or unsubstituted, linear or branched C₁-C₁₀ alkyl;
—Z₁₂— is —N(R_{f})—;
—Z₁₃— is a substituted or unsubstituted 5- to 30-membered heterocycloalkylene, wherein at least one of the one or more heteroatoms of Z₁₃ is from Xₐ;
wherein Cₐ is a C atom or a H atom and C_{b} is a C atom or a H atom, wherein at least one of Cₐ and C_{b} is a C atom;
wherein Xₐ is a O atom or NH and X_{b} is a O atom or NH, wherein at least one of Xₐ and X_{b} is NH, with the condition that for Xₐ and/or X_{b} being NH, the respective Cₐ and/or C_{b} is/are C atom(s);
wherein
(A) R_{c}, R_{d}, R_{f} and R_{g} independently of each other are selected from the group consisting of hydrogen, linear or branched, substituted or unsubstituted C₁-C₃₀ alkyl, linear or branched, substituted or unsubstituted C₂-C₃₀ alkenyl, substituted or unsubstituted, linear or branched 2- to 30-membered heteroalkyl, substituted or unsubstituted, linear or branched 3- to 30-membered heteroalkenyl, substituted or unsubstituted C₅-C₃₀ cycloalkyl, substituted or unsubstituted C₅-C₃₀ cycloalkenyl, substituted or unsubstituted 5- to 30-membered heterocycloalkyl, substituted or unsubstituted 5- to 30-membered heterocycloalkenyl, substituted or unsubstituted C₆-C₃₀ aryl, substituted or unsubstituted 5- to 30-membered heteroaryl, substituted or unsubstituted C₁-C₁₀ alkylene C₅-C₃₀ cycloalkyl, substituted or unsubstituted C₁-C₁₀ alkylene C₅-C₃₀ cycloalkenyl, substituted or unsubstituted C₁-C₁₀ alkylene 5- to 30-membered heterocycloalkyl, substituted or unsubstituted C₁-C₁₀ alkylene 5- to 30-membered heterocycloalkenyl, substituted or unsubstituted C₁-C₁₀ alkylene C₆-C₃₀ aryl and substituted or unsubstituted C₁-C₁₀ alkylene 5- to 30-membered heteroaryl,
   R_{b} and Rₑ independently of each other are defined as R_{c}, Rₐ, R_{f} and R_{g}; or R_{b} and Rₑ are none, and Cₐ and C_{b} are connected to each other via a single bond forming a heterocycle consisting of Cₐ, C_{b}, Xₐ, X_{b} and Rₐ; or
(B) Cₐ and Rₑ form a substituted or unsubstituted C₆-C₃₀ arylene, preferably a phenyl, and both R_{f} and R_{g} are none; and
   C_{b} and R_{b} form a substituted or unsubstituted C₆-C₃₀ arylene, preferably a phenyl, and both R_{c} and R_{d} are none; or
(C) —Cₐ and Rₑ form a substituted or unsubstituted C₆-C₃₀ arylene, and both R_{f} and R_{g} are none; or
   —C_{b} and R_{b} form a substituted or unsubstituted C₆-C₃₀ arylene, and both R_{c} and R_{d} are none;
   wherein, when Cₐ and Rₑ form a substituted or unsubstituted C₆-C₃₀ arylene, R_{b}, R_{c} and R_{d} independently of each other are defined as any one of R_{c}, R_{d}, R_{f} and R_{g} under (A);
   wherein, when C_{b} and R_{b} form a substituted or unsubstituted C₆-C₃₀ arylene, Rₑ, R_{f} and R_{g} independently of each other are defined as any one of R_{c}, Rₐ, R_{f} and R_{g} under (A),
obtaining a mixture comprising a poly(urea-urethane) polymer, more preferably according to any one of embodiments 1 to 33;
and
bringing in contact the obtained mixture with component (iv):
(iv) a filler, the filler being selected from the group consisting of glass fibers, carbon fibers, mineral fibers, textiles, metal meshs, metal fibers, metal rods, carbonates, wood, and a mixture of two or more thereof.

35. The composite of embodiment 34, wherein the filler (iv) is glass fibers.

36. Process for preparing a poly(urea-urethane) polymer to any one of embodiments 1 to 33 comprising:
(a) reacting at least one isocyanate (i) with at least one polyol (ii), obtaining a prepolymer;
(b) bringing in contact the pre-polymer obtained in (a) with at least one secondary amine, the at least one secondary amine having the formula (I) as defined in any one of embodiments 1 to 15, obtaining the poly(urea-urethane) polymer; or
(a′) reacting at least one isocyanate (i) with at least one secondary amine, the at least one secondary amine having the formula (I) as defined in any one of embodiments 1 to 15, obtaining a pre-polymer;
(b′) bringing in contact the pre-polymer obtained in (a′) with at least one polyol (ii), poly(urea-urethane) polymer.

37. The process of embodiment 36, wherein (a) or (a′) is performed at a temperature in the range of from 0 to 200° C., preferably in the range of from 1 to 200° C., more preferably in the range of from 10 to 150° C., more preferably in the range of from 20 to 90° C.

38. The process of embodiment 36 or 37, wherein one or more of (a) and (b) or one or more of (a′) and (b′), preferably (a) and (b) or (a′) and (b′), are performed in the absence of a solvent.

39. The process of any one of embodiments 36 to 38, wherein (b) or (b′) is performed at a temperature in the range of from 0 to 200° C., preferably in the range of from 1 to 200° C., more preferably in the range of from 10 to 150° C., more preferably in the range of from 20 to 90° C.

40. The process of any one of embodiments 36 to 39, further comprising
(c) curing the mixture obtained in (b) or (b′), preferably at a temperature in the range of from 90 to 150° C., more preferably in the range of from 100 to 120° C.

41. Process for preparing a composite according to embodiment 34 or 35, the process comprising:
(1) providing a poly(urea urethane) polymer comprising
   (1.1) reacting at least one isocyanate (i) with at least one polyol (ii), obtaining a pre-polymer;
   (1.2) bringing in contact the pre-polymer obtained in (1.1) with at least one secondary amine, the at least one secondary amine (iii) having the formula (I) as defined in any one of embodiments 1 to 15;
   or
   (1.1′) reacting at least one isocyanate (i) with at least one secondary amine, the at least one secondary amine (iii) having the formula (I) as defined in any one of embodiments 1 to 15, obtaining a pre-polymer;
   (1.2′) bringing in contact the pre-polymer obtained in (1.1′) with at least one polyol (ii);
(2) bringing in contact the polymer obtained in (1.2) or (1.2′) with a filler as defined in embodiment 31 or 32.

42. The process of embodiment 41, wherein (1) is performed at a temperature in the range of from 0 to 200° C., preferably in the range of from 1 to 200° C., more preferably in the range of from 10 to 150° C., more preferably in the range of from 20 to 90° C.

43. The process of embodiment 41 or 42, wherein one or more of (1) and (2), preferably (1) and (2), are performed in the absence of a solvent.

44. The process of any one of embodiments 41 to 43, wherein bringing the polymer in contact with the filler in (2) is performed by mixing or pressing.

45. The process of embodiment 44, wherein pressing is performed at a pressure in the range of from 440 kPa to 1320 kPa (preferably measured as 10 to 30 kN of applied force pressed by a circular press having a diameter of 17 cm), more preferably in the range of from 660 kPa to 1100 kPa (preferably measured as 15 to 25 KN of applied force pressed by a circular press having a diameter of 17 cm), more preferably in the range of from 792 kPa to 968 kPa (preferably measured as 18 to 22 kN of applied force pressed by a circular press having a diameter of 17 cm).

46. The process of any one of embodiments 41 to 44, further comprising
(1.3) curing the polymer obtained in (1.2) or (1.2′), preferably at a temperature in the range of from 90 to 150° C., more preferably in the range of from 100 to 120° C.;
or
(3) curing the polymer obtained in (2), preferably at a temperature in the range of from 90 to 150° C., more preferably in the range of from 100 to 120° C.

47. Use of a poly(urea-urethane) polymer according to any one of embodiments 1 to 33 or a poly(urea-urethane) polymer composite according to embodiment 34 or 35 as a recyclable material.

48. A recyclable article comprising a poly(urea-urethane) polymer according to any one of embodiments 1 to 33 or a poly(urea-urethane) polymer composite according to embodiment 34 or 35.

49. A process for shaping a poly(urea-urethane) polymer according to any one of embodiments 1 to 33 or a poly(urea-urethane) polymer obtainable or obtained by a process according to any one of embodiments 36 to 40 comprising:
shaping the poly(urea-urethane) polymer, wherein shaping the polymer comprises
(x) applying pressure and heat to the poly(urea-urethane) polymer, obtaining a shaped body, preferably a foil or a sheet; or
(x′) extruding the poly(urea-urethane) polymer, obtaining a shaped body, preferably a granulate or a paste.

50. The process of embodiment 49, wherein the applied pressure according to (x) is in the range of from 10³ to 10⁷ Pa, preferably in the range of from 1.5×10³ to 10⁶ Pa.

51. The process of embodiment 49 or 50, wherein the heating according to (x) is performed at a temperature is the range of from 60° C. to 250° C., preferably in the range of from 65 to 150° C., more preferably in the range of from 70 to 130° C.

52. The process of any one of embodiments 49 to 51, wherein extruding according to (x′) is performed at a temperature in the range of from 140 to 220° C., preferably in the range of from 160 to 200° C., more preferably in the range of from 170 to 190° C.

In the context of the present invention, the term “alkylene” relates to acyclic saturated hydrocarbon groups, which may be acyclic saturated hydrocarbon chains, which combine different moieties, as in the case of C₁-C₃₀ alkylene with 1 to 30 (i.e. 1, 2, 3, 4, 5, 6, 7, 8, 9, 10, 11, 12, 13, 14, 15, 16, 17, 18, 19, 20, 21, 22, 23, 24, 25, 26, 27, 28, 29 or 30) C atoms or with, as in the case of C₁-C₅ alkylene, 1 to 5 (i.e. 1, 2, 3, 4 or 5) C atoms. Representative examples of alkylene include, but are not limited to, —CH₂—, —CH₂—CH₂—, —CH₂—CH(CH₃)—, —CH(CH₃)—CH₂—, —CH(CH₃)—CH₂—CH₂—, —CH₂—CH(CH₂CH₃)—, —CH₂—CH₂—CH(CH₂CH₃)—, —CH₂—CH (n-C₃H₇)—, —CH₂—CH(n-C₄H₉)—, —CH₂—CH (n-C₅H₁₁)—, —CH₂—CH (n-C₆H₁₃)—, —CH₂—CH (n-C₇H₁₅)—, —CH₂—CH(n-C₈H₁₇)—, —CH(CH₃)—CH(CH₃)—, —C(CH₃)₂—, —CH₂—C(CH₃)₂—CH₂, —CH₂—[C(CH₃)₂]₂—CH₂—, —CH₂—CH(CH₃)—CH₂—C(CH₃)₂—CH₂—CH₂—, —CH₂—C(CH₃)₂—CH₂—CH(CH₃)—CH₂—CH₂—, —(CH₂)₃—, —(CH₂)₄—, —(CH₂)₅, —(CH₂)₆, —(CH₂)₈—, —(CH₂)₁₀—, —(CH₂)₇—, —(CH₂)₉—, —(CH₂)₁₁—, —(CH₂)₁₂, —(CH₂)₁₃—, —(CH₂)₁₄—, —(CH₂)₁₅—, —(CH₂)₁₆—, —(CH₂)₁₇, —(CH₂)₁₈, —(CH₂)₁₉—, —(CH₂)₂₀—, —(CH₂)₂₁—, —(CH₂)₂₂—, —(CH₂)₂₃—, —(CH₂)₂₄—, —(CH₂)₂₅, —(CH₂)₂₆—, —(CH₂)₂₇—, —(CH₂)₂₈—, —(CH₂)₂₉— and —(CH₂)₃₀—.

In the context of the present invention, the term “heteroalkylene” relates to an alkylene group as described above, in which one or more carbon atoms have been replaced with heteroatoms each independently selected from the group consisting of oxygen, sulfur and nitrogen (—NH—). The heteroalkylene groups can preferably have 1, 2 or 3 heteroatom(s), particularly preferably 1 heteroatom selected from the group consisting of oxygen, sulfur and nitrogen (—NH—) as chain link(s). The heteroalkylene groups can preferably be 2- to 30-membered, particularly preferably 2- to 12-membered, very particularly preferably 2- or 6-membered. More preferably, oxygen (—O—) is the most preferred heteroatom in “heteroalkylene”. Representative examples of the heteroalkylene groups include, but are not limited to, (—CH₂—O—CH₂—)₁₋₅₀₀, (—CH₂—O—CH(CH₃)—)₁₋₅₀₀, —(CH(CH₃)—CH₂—O)₁₋₁₀₀—CH(CH₃)—CH₂—, —CH₂—CH₂—O—CH₂—CH₂—, —CH₂—O—CH(CH₃)—, —CH₂—O—CH(CH₂CH₃)—, —CH₂—O—CH (n-C₃H₇)—, —CH₂—O—CH (n-C₄H₉)—, —CH₂—O—CH(n-C₅H₁₁)—, —CH₂—O—CH (n-C₆H₁₃)—, —CH₂—O—CH (n-C₇H₁₅)—, —CH₂—O—CH (n-C₈H₁₇)—, —CHO—(CH₃)—CHO—(CH₃)—, —CO—(CH₃)₂—, —CH₂—O—C(CH₃)₂—CH₂—, —CH₂—[O—C(CH₃)₂]₂—CH₂—, —(CH₂)₃—O—CH₂—, —(CH₂)₄—O—CH₂—, —(CH₂)₅—O—CH₂—, —(CH₂)₆—O—CH₂—, —(CH₂)₈—OCH₂—, —(CH₂)₁₀—O—CH₂—, —(CH₂)₇—O—CH₂—, —(CH₂)₉—O—CH₂—, —(CH₂)₁₁—O—CH₂—, —(CH₂)₁₂—O—CH₂—, —(CH₂)₁₃—O—CH₂—, —(CH₂)₁₄—O—CH₂—, —(CH₂)₁₅—O—CH₂—, —(CH₂)₁₆—O—CH₂—, —(CH₂)₁₇—O—CH₂—, —(CH₂)₁₈—O—CH₂—, —(CH₂)₁₉—O—CH₂—, —(CH₂)₂₀—O—CH₂—, —(CH₂)₂₁—OCH₂—, —(CH₂)₂₂—OCH₂—, —(CH₂)₂₃—O—CH₂—, —(CH₂)₂₄—OCH₂—, —(CH₂)₂₅—OCH₂—, —(CH₂)₂₆—OCH₂—, —(CH₂)₂₇—O—CH₂, —(CH₂)₂₈—O—CH₂—, —(CH₂)₂₉—O—CH₂—, —(CH₂)₃₀—O—CH₂—, —CH₂—S—CH₂—, —CH₂—NH—CH₂—, —CH₂—NH—, —CH₂—CH₂—NH—CH₂—CH₂—CH₂—, —CH₂—CH₂—CH₂—N(CH₃)—CH₂—CH₂—CH₂—, —CH₂—CH₂—CH₂—NH—CH₂—CH₂—CH₂—, —CH₂—CH₂—CH₂—NH—CH₂—CH₂—NH—CH₂—CH₂—CH₂—, —CH₂—CH₂—NH—CH₂—CH₂—NH—CH₂—CH₂—, —CH₂—CH₂—NH—CH₂—CH₂—NH—CH₂—CH₂—NH—CH₂—CH₂—, —CH₂—CH₂—CH₂—O—CH₂—CH₂—O—CH₂—CH₂—O—CH₂—CH₂—CH₂—, —CH₂—CH₂—CH₂—O—CH₂—CH₂—CH₂—CH₂—O—CH₂—CH₂—CH₂—, —CH₂—CH₂—O—CH₂—CH₂—O—CH₂—CH₂—, —CH(CH₃)—CH₂—NH—CH₂—CH(CH₃)—, —CH₂—CH₂—NH—CH₂—CH₂—,
—[CH(CH₃)—CH₂—O]ₘ₁—CH₂—C(Rₓ₁)(R_{y1})—[O—CH₂—CH(CH₃)]ₒ₁—, wherein Rₓ₁ is —CH₂—CH₃, wherein R_{y1} is [—O—CH₂—CH(CH₃)]ₙ₁—NH—C_{d}(Rₗ)(Rₘ)(Rₙ), and wherein m1+n1+o1 is in the range of 5 to 6,
—[CH(CH₃)—CH₂—O]ₘ₂—CH₂—CH(R_{y2})—[O—CH₂—CH(CH₃)]ₒ₂—, wherein R_{y2} is [—O—CH₂—CH(CH₃)]ₙ₂—NH—C_{d}(Rₗ)(Rₘ)(Rₙ), and wherein m2+n2+o2 is in the range of 45 to 85,
—[CH(CH₃)—CH₂—O]ₘ₃—[CH₂—CH₂—O]ₙ₃—[CH₂—CH(CH₃)—O]ₒ₃—CH₂—CH(CH)₃—,
wherein n3 is in the range of 8 to 10 and m3+o3 is in the range of 3 to 4, or
wherein n3 is in the range of 12 to 13 and m3+o3 is in the range of 5 to 7, or
wherein n3 is in the range of 38 to 40 and m3+o3 is in the range of 5 to 7,
—[CH—CH₂—O]ₘ₄—CH₂—CH₂—, wherein m4 is in the range of 8 to 250, and
—[CH₂—CH₂—NH]ₘ₅—, wherein m5 is in the range of 10 to 100,000.

In the context of the present invention, the term “alkenylene” relates to acyclic unsaturated hydrocarbon groups having at least one double bond, preferably 1, 2 or 3 double bonds, and may be branched or linear and unsubstituted or at least monosubstituted with as in the case of C₂-C₃₀ alkenylene 2 to 30 (i.e. 2, 3, 4, 5, 6, 7, 8, 9, 10, 11, 12, 13, 14, 15, 16, 17, 18, 19, 20, 21, 22, 23, 24, 25, 26, 27, 28, 29 or 30) C-atoms, more preferably C₂-C₂₀ alkenylene, most preferably C₂-C₁₀ alkenylene, and in particular C₂-C₆ alkenylene. Representative examples of alkenylene include, but are not limited to, —CH═CH— and —CH₂—CH═CH—.

In the context of the present invention, the term “heteroalkenylene” relates to an alkenylene group as described above, in which one or more carbon atoms have been replaced with heteroatoms each independently selected from the group consisting of oxygen, sulfur and nitrogen (NH). The heteroalkenylene groups can preferably have 1, 2 or 3 heteroatom(s), particularly preferably 1 heteroatom selected from the group consisting of oxygen, sulfur and nitrogen (NH) as chain link(s). The heteroalkenylene groups can preferably be 3- to 30-membered, particularly preferably 3- to 12-membered, very particularly preferably 3- or 6-membered. Representative examples of the heteroalkenylene groups include, but are not limited to, —CH═CH—NH—, —CH═CH—O—, —CH═CH—CH₂—O— and —CH═CH—S—.

In the context of the present invention, it is conceivable that if one or more of the substituents denote an alkylene, alkenylene, heteroalkylene and heteroalkenylene or comprises such a group, which is mono- or polysubstituted, this group is preferably substituted with 1, 2, 3, 4 or 5, particularly preferably with 1, 2 or 3, substituents mutually independently selected from the group consisting of phenyl, F, Cl, Br, I, —NO₂, —CN, —O-phenyl, —O—CH₂-phenyl, —SH, —S-phenyl, —S—CH₂-phenyl, —NH₂, —N(C₁₋₅-alkyl)₂, —NH-phenyl, —N(C₁₋₅-alkyl) (phenyl), —N(C₁₋₅-alkyl) (CH₂-phenyl), —N(C₁₋₅-alkyl) (CH₂—CH₂-phenyl), —C(═O)—H, —C(═O)—C₁₋₅-alkyl, —C(═O)phenyl, —C(═S)—C₁₋₅-alkyl, —C(═S)-phenyl, —C(═O)—OH, —C(═O)—O—C₁₋₅-alkyl, —C(═O)—O—phenyl, —C(═O)—NH₂, —C(═O)—NH—C₁₋₅-alkyl, —C(═O)—N(C₁₋₅-alkyl)₂, —S(═O)—C₁₋₅-alkyl, —S(═O)-phenyl, —S(═O)₂—C₁₋₅-alkyl, —S(═O)₂-phenyl, —S(═O)₂—NH₂ and —SO₃H, wherein the above-stated —C₁₋₅ alkyl residues in each case are linear or branched and the above-stated phenyl residues are unsubstituted or substituted with 1, 2, 3, 4 or 5, preferably with 1, 2, 3 or 4, substituents mutually independently selected from the group consisting of F, Cl, Br, I, —CN, —NO₂, —SH, —NH₂, —C(═O)—OH, —C₁₋₅ alkyl, —(CH₂)—O—C₁₋₅-alkyl, —C₂₋₅ alkenyl, —C₂₋₅ alkynyl, —C≡C—Si(CH₃)₃, —C≡C—Si(C₂H₅)₃, —S—C₁₋₅-alkyl, —S-phenyl, —S—CH₂-phenyl, —O—C₁₋₅-alkyl, —O-phenyl, —O—CH₂-phenyl, —CF₃, —CHF₂, —CH₂F, —O—CF₃, —O—CHF₂, —O—CH₂F, —C(═O)—CF₃, —S—CF₃, —S—CHF₂ and —S—CH₂F. It is conceivable that alkylene, alkenylene, heteroalkylene and heteroalkenylene groups are independently from one another unsubstituted or substituted with 1, 2 or 3 substituents mutually independently selected from the group consisting of phenyl, F, Cl, Br, I, —NO₂, —CN, —O-phenyl, —SH, —S-phenyl, —NH₂, —N(CH₃)₂, —N(C₂H₅)₂ and —N(CH₃)(C₂H₅), wherein the phenyl residue are unsubstituted or substituted with 1, 2, 3, 4 or 5 substituents mutually independently selected from the group consisting of F, Cl, Br, I, —OH, SH, —NO₂, —CN, —O—CH₃, —O—CF₃, and —O—C₂H₅.

In the context of the present invention, the term “cycloalkylene” relates to saturated cyclic hydrocarbon groups. Representative examples of C₅-C₃₀ cycloalkylene include, but are not limited to, cyclopentylene (e.g., cyclopenta-1,3-ylene, cyclopenta-1,2-ylene), cyclohexylene (eg, cyclohexa-1,4-ylene, cyclohexa-1,3-ylene and cyclohexa-1,2-ylene), cycloheptylene, cyclooctylene groups (e.g. 1,5-cyclooctylene),

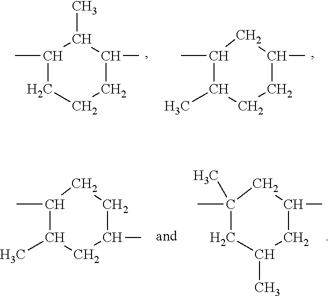

In the context of the present invention, the term “cycloalkylene” also relates to a bridged cyclic hydrocarbon group such as a cyclic hydrocarbon group with 2 to 4 rings having 5 to 30 carbon atoms. Representative examples include, but are not limited to, norbornylene groups (e.g. 1,4-norbornylene group and 2,5-norbornylene group), norbornyl groups (e.g. 2,6-norbornyl), and adamantylene groups (e.g. 1,5-adamantylene group and 2,6-adamantylene group).

In the context of the present invention, the term “heterocycloalkylene” also relates to a cyclic or polycyclic, saturated divalent radical having from 5 to 30 ring members in which carbon atoms are replaced with 1, 2 or 3 heteroatom(s) selected from the group consisting of N, O and S. Representative examples include, but are not limited to, 1,5-dioxaoctylene, 4,8-dioxabicyclo[3.3.0]octylene.

In the context of the present invention, the term “cycloalkenylene” relates to a bivalent cycloalkenyl ring structure, i.e., the cycloalkenyl as defined herein having two single bonds as points of attachment to other groups. Representative examples of “cycloalkenylene” include, but are not limited to, cyclopent-1,2-en-3,5-ylene, 3-cyclohexene-1,2-ylene, 2,5-cyclohexadiene-1,4-ylene, cyclohex-1,2-en-3,5-ylene, 2,5-cyclohexadiene-1,4-ylene and cyclohept-1,2-en-3,5-ylene.

In the context of the present invention, the term “heterocycloalkenylene” relates to a cyclic or polycyclic, nonaromatic unsaturated divalent radical having from 5 to 30 carbon atoms in which carbon atoms are replaced with 1, 2 or 3 heteroatom(s) selected from N, O and S heteroatom and having 1, 2 or 3 double bond(s).

In the context of the present invention, it is conceivable that if one or more of the substituents denote a cycloalkylene, cycloalkenylene, heterocycloalkylene, and heterocycloalkenylene which is mono- or polysubstituted, this group is preferably substituted with 1, 2, 3, 4 or 5, particularly preferably with 1, 2 or 3, substituents mutually independently selected from the group consisting of phenyl, F, Cl, Br, I, —NO₂, —CN, —O-phenyl, —O—CH₂-phenyl, —SH, —S-phenyl, —S—CH₂-phenyl, —NH₂, —N(C₁₋₅-alkyl)₂, —NH-phenyl, —N(C₁₋₅-alkyl) (phenyl), —N(C₁₋₅-alkyl) (CH₂-phenyl), —N(C₁₋₅-alkyl) (CH₂—CH₂-phenyl), —C(═O)—H, —C(═O)—C₁₋₅-alkyl, —C(═O)-phenyl, —C(═S)—C₁₋₅-alkyl, —C(═S)-phenyl, —C(═O)—OH, —C(═O)—O—C₁₋₅-alkyl, —C(═O)—O-phenyl, —C(═O)—NH₂, —C(═O)—NH—C₁₋₅-alkyl, —C(═O)—N(C₁₋₅-alkyl)₂, —S(═O)—C₁₋₅-alkyl, —S(═O)-phenyl, —S(═O)₂—C₁₋₅-alkyl, —S(═O)₂-phenyl, —S(═O)₂—NH₂ and —SO₃H, wherein the above-stated —C₁₋₅ alkyl residues in each case are linear or branched and the above-stated phenyl residues are unsubstituted or substituted with 1, 2, 3, 4 or 5, preferably with 1, 2, 3 or 4, substituents mutually independently selected from the group consisting of F, Cl, Br, I, —CN, —NO₂, —SH, —NH₂, —C(═O)—OH, —C₁₋₅ alkyl, —(CH₂)—O—C₁₋₅-alkyl, —C₂₋₅ alkenyl, —C₂₋₅ alkynyl, —C≡C—Si(CH₃)₃, —C≡C—Si(C₂H₅)₃, —S—C₁₋₅-alkyl, —S-phenyl, —S—CH₂-phenyl, —O—C₁₋₅-alkyl, —O-phenyl, —O—CH₂-phenyl, —CF₃, —CHF₂, —CH₂F, —O—CF₃, —O—CHF₂, —O—CH₂F, —C(═O)—CF₃, —S—CF₃, —S—CHF₂ and —S—CH₂F. It is conceivable that alkylene, alkenylene, heteroalkylene and heteroalkenylene groups are independently from one another unsubstituted or substituted with 1, 2 or 3 substituents mutually independently selected from the group consisting of phenyl, F, Cl, Br, I, —NO₂, —CN, —O-phenyl, —SH, —S-phenyl, —NH₂, —N(CH₃)₂, —N(C₂H₅)₂ and —N(CH₃)(C₂H₅), wherein the phenyl residue is unsubstituted or substituted with 1, 2, 3, 4 or 5 substituents mutually independently selected from the group consisting of F, Cl, Br, I, —SH, —NO₂, —CN, —O—CH₃, —O—CF₃, and —O—C₂H₅.

In the context of the present invention, the term “arylene”, refers to a closed aromatic divalent ring or ring system such as phenylene, naphthylene, biphenylene, fluorenylene, and indenyl.

In the context of the present invention, the term “heteroarylene”, refers to a closed aromatic divalent ring or ring system having at least one heteroatom selected from nitrogen, oxygen and sulfur. Representative examples heteroarylene groups include, but are not limited to, furylene, thienylene, pyridylene, quinolinylene, isoquinolinylene, indolylene, isoindolylene, triazolylene, pyrrolylene, tetrazolylene, imidazolylene, pyrazolylene, oxazolylene, thiazolylene, benzofuranylene, benzothiophenylene, carbazolylene, benzoxazolylene, pyrimidinylene, benzimidazolylene, quinoxalinylene, benzothiazolylene, naphthyridinylene, isoxazolylene, isothiazolylene, purinylene, quinazolinylene, pyrazinylene, 1-oxidopyridylene, pyridazinylene, triazinylene (preferably one or more of vic-triazinylene, asym-triazinylene, and sym-triazinylene), tetrazinylene, oxadiazolylene and thiadiazolylene.

In the context of the present invention, it is conceivable that if one or more of the substituents denote an arylene and a heteroarylene which is mono- or polysubstituted, this is preferably substituted with 1, 2, 3 or 4, particularly preferably with 1, 2 or 3, substituents mutually independently selected from the group consisting of phenyl, F, Cl, Br, I, —NO₂, —CN, —O-phenyl, —O—CH₂-phenyl, —SH, —S-phenyl, —S—CH₂-phenyl, —NH₂, —N(C₁₋₅-alkyl)₂, —NH-phenyl, —N(C₁₋₅-alkyl) (phenyl), —N(C₁₋₅-alkyl) (CH₂-phenyl), —N(C₁₋₅-alkyl) (CH₂—CH₂-phenyl), —C(═O)—H, —C(═O)—C₁₋₅-alkyl, —C(═O)-phenyl, —C(═S)—C₁₋₅-alkyl, —C(═S)-phenyl, —C(═O)—OH, —C(═O)—O—C₁₋₅-alkyl, —C(═O)—O-phenyl, —C(═O)—NH₂, —C(═O)—NH—C₁₋₅-alkyl, —C(═O)—N(C₁₋₅-alkyl)₂, —S(═O)—C₁₋₅-alkyl, —S(═O)-phenyl, —S(═O)₂—C₁₋₅-alkyl, —S(═O)₂-phenyl, —S(═O)₂—NH₂ and —SO₃H, wherein the above-stated-C₁₋₅ alkyl residues in each case are linear or branched and the above-stated phenyl residues are unsubstituted or substituted with 1, 2, 3, 4 or 5, preferably with 1, 2, 3 or 4, substituents mutually independently selected from the group consisting of F, Cl, Br, I, —CN, —NO₂, —SH, —NH₂, —C(═O)—OH, —C₁₋₅ alkyl, —(CH₂)—O—C₁₋₅-alkyl, —C₂₋₅ alkenyl, —C₂₋₅ alkynyl, —C≡C—Si(CH₃)₃, —C≡C—Si(C₂H₅)₃, —S—C₁₋₅-alkyl, —S-phenyl, —S—CH₂-phenyl, —O—C₁₋₅-alkyl, —O-phenyl, —O—CH₂-phenyl, —CF₃, —CHF₂, —CH₂F, —O—CF₃, —O—CHF₂, —O—CH₂F, —C(═O)—CF₃, —S—CF₃, —S—CHF₂ and —S—CH₂F. It is conceivable that alkylene, alkenylene, heteroalkylene and heteroalkenylene groups are independently from one another unsubstituted or substituted with 1, 2 or 3 substituents mutually independently selected from the group consisting of phenyl, F, Cl, Br, I, —NO₂, —CN, —O-phenyl, —SH, —S-phenyl, —NH₂, —N(CH₃)₂, —N(C₂H₅)₂ and —N(CH₃)(C₂H₅), wherein the phenyl residue is unsubstituted or substituted with 1, 2, 3, 4 or 5 substituents mutually independently selected from the group consisting of F, Cl, Br, I, —SH, —NO₂, —CN, —O—CH₃, —O—CF₃, and —O—C₂H₅.

In the context of the present invention, the term “alkyl” refers to acyclic saturated hydrocarbon residues, which may be branched or linear and unsubstituted or at least monosubstituted with, as in the case of C₁-C₃₀ alkyl, 1 to 30 (i.e. 1, 2, 3, 4, 5, 6, 7, 8, 9, 10, 11, 12, 13, 14, 15, 16, 17, 18, 19, 20, 21, 22, 23, 24, 25, 26, 27, 28, 29 or 30) C atoms or with, as in the case of C₁-C₅ alkyl, 1 to 5 (i.e. 1, 2, 3, 4 or 5) C atoms. In the context of the present invention, it is conceivable that if one or more of the substituents denote an alkyl or comprise an alkyl which is mono- or polysubstituted, this is preferably substituted with 1, 2, 3, 4 or 5, particularly preferably with 1, 2 or 3, substituents mutually independently selected from the group consisting of F, Cl, Br, I, —OH, —NO₂, —CN, —SH, —NH₂, —N(C₁₋₅-alkyl)₂, —N(C₁₋₅-alkyl) (phenyl), —N(C₁₋₅-alkyl) (CH₂-phenyl), —N(C₁₋₅-alkyl) (CH₂—CH₂-phenyl), —C(═O)—H, —C(═O)—C₁₋₅-alkyl, —C(═O)-phenyl, —C(═S)—C₁₋₅-alkyl, —C(═S)-phenyl, —C(═O)—OH, —C(═O)—O—C₁₋₅-alkyl, —C(═O)—)-phenyl, —C(═O)—NH₂, —C(═O)—NH—C₁₋₅-alkyl, —C(═O)—N(C₁₋₅-alkyl)₂, —S(═O)—C₁₋₅-alkyl, —S(═O)-phenyl, —S(═O)₂—C₁₋₅-alkyl, —S(═O)₂-phenyl, —S(═O)₂—NH₂ and —SO₃H, wherein the above-stated C₁₋₅-alkyl residues are in each case linear or branched and the above-stated phenyl residues are unsubstituted or substituted with 1, 2, 3, 4 or 5 substituents mutually independently selected from the group consisting of F, Cl, Br, I, —CN, —CF₃, —NH₂, —O—CF₃, —SH, —O—CH₃, —O—C₂H₅, —O—C₃H₇, methyl, ethyl, n-propyl, isopropyl, n-butyl, 2-butyl, isobutyl and tert-butyl. Particularly preferred substituents may be selected mutually independently from the group consisting of F, Cl, Br, I, —NO₂, —CN, —SH, —NH₂, —N(CH₃)₂, —N(C₂H₅)₂ and —N(CH₃)(C₂H₅).

In the context of the present invention, an unsubstituted linear C₁-C₃₀ alkyl preferably refers to an alkyl selected from the group consisting of methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, henicosyl, docosyl, tricosyl and tetracosyl; more preferably selected from the group consisting of hexyl, heptyl, octyl, nonyl, decyl, undecyl, dodecyl, tridecyl, tetradecyl, pentadecyl, hexadecyl, heptadecyl, octadecyl, nonadecyl, eicosyl, henicosyl, docosyl, tricosyl and tetracosyl; more preferably selected from the group consisting of methyl, ethyl, propyl, butyl, pentyl, hexyl, heptyl, octyl, nonyl, decyl, undecyl, dodecyl, tridecyl, tetradecyl and pentadecyl; more preferably selected from the group consisting of methyl, ethyl, propyl, butyl, pentyl, hexyl, heptyl, octyl, nonyl, decyl, undecyl and dodecyl; and more preferably selected from the group consisting of methyl, ethyl, propyl, butyl, pentyl, hexyl, heptyl, octyl, nonyl and decyl.

In the context of the present invention, an unsubstituted branched C₁-C₃₀ alkyl preferably refers to an alkyl selected from the group consisting of isopropyl, iso-butyl, sec-butyl, tert-butyl, sec-isopentyl, 2-pentyl, 2-methyl-4-pentyl, 3-pentyl, neo-pentyl, 2-methyl-pentyl, 2-ethyl-hexyl, 2-propyl-heptyl, 2-butyl-octyl, 2-pentyl-nonyl, 2-hexyl-decyl, iso-hexyl, iso-heptyl, 2,6-dimethyl-4-heptyl, iso-octyl, iso-nonyl, iso-decyl, iso-dodecyl, iso-tetradecyl, iso-hexadecyl, iso-octadecyl, iso-eicosyl, and 3-pinanyl-methyl, more preferably selected from the group consisting of 2-ethyl-hexyl, 2-propyl-heptyl, 2-butyl-octyl, 2-pentyl-nonyl, 2-hexyldecyl, iso-hexyl, iso-heptyl, iso-octyl, iso-nonyl, iso-decyl, iso-dodecyl, iso-tetradecyl, isohexadecyl, iso-octadecyl, iso-eicosyl, 2-methyltricosyl, 2-ethyldocosyl, 3-ethylhenicosyl, 3-ethylicosyl, 4-propylhenicosyl, propylnonadecyl, 6-butyldodecyl and 5-ethylundecyl. In the context of the present invention, a polysubstituted alkyl is understood to be an alkyl which is either poly-, preferably di- or trisubstituted, either on different or on the same C atoms, for example trisubstituted on the same C atom as in the case of —CF₃, or at different locations as in the case of —(CHCl)—(CH₂F). Polysubstitution may proceed with identical or different substituents. Representative examples of substituents include, but are not limited to, —CH₃, —CF₃, —CF₂H, —CFH₂, —(CH₂)—OH, —(CH₂)—NH₂, —(CH₂)—CN, —(CH₂)—(CF₃), —(CH₂)—(CHF₂), —(CH₂)—(CH₂F), —(CH₂)—(CH₂)—O—CH₃, —(CH₂)—(CH₂)—NH₂, —(CH₂)—(CH₂)—CN, —(CF₂)—(CF₃), —(CH₂)—(CH₂)—(CF₃), and —(CH₂)—(CH₂)—(CH₂)—O—CH₃.

In the context of the present invention, a substituted, linear or branched, C₁-C₃₀ alkyl also refers to a branched or linear saturated hydrocarbon group having C₁-C₃₀ carbon atoms substituted with functional groups selected from the group consisting of F, Cl, Br, I, —OH, 2-furanyl, —NO₂, —CN, —SH, —NH₂, —N(C₁₋₅-alkyl)₂, —N(C₁₋₅-alkyl) (phenyl), —N(C₁₋₅-alkyl) (CH₂-phenyl), —N(C₁₋₅-alkyl) (CH₂—CH₂-phenyl), —C(═O)—H, —C(═O)—C₁₋₅-alkyl, —C(═O)-phenyl, —C(═S)—C₁₋₅-alkyl, —C(═S)-phenyl, —C(═O)—OH, —C(═O)—O—C₁₋₅-alkyl, —C(═O)—)-phenyl, —C(═O)—NH₂, —C(═O)—NH—C₁₋₅-alkyl, —C(═O)—N(C₁₋₅-alkyl)₂, —S(═O)—C₁₋₅-alkyl, —S(═O)-phenyl, —S(═O)₂—C₁₋₅-alkyl, —S(═O)₂-phenyl, —S(═O)₂—NH₂ and —SO₃H, wherein the above-stated C₁₋₅-alkyl residues are in each case linear or branched and the above-stated phenyl residues are preferably unsubstituted or substituted with 1, 2, 3, 4 or 5 substituents mutually independently selected from the group consisting of F, Cl, Br, I, —CN, —CF₃, —NH₂, —O—CF₃, —SH, —O—CH₃, —O—C₂H₅, —O—C₃H₇, methyl, ethyl, n-propyl, isopropyl, n-butyl, 2-butyl, isobutyl and tert-butyl. Particularly preferred substituents may be selected mutually independently from the group consisting of F, Cl, Br, I, —NO₂, —CN, —SH, —NH₂, —N(CH₃)₂, —N(C₂H₅)₂ and —N(CH₃)(C₂H₅).

In the context of the present invention, a substituted, linear or branched, C₁-C₃₀ alkyl also refers to a branched or linear saturated hydrocarbon group having C₁-C₃₀ carbon atoms substituted with functional groups selected from the group consisting of hydroxy, alkoxy, C(═O)R, CN and SR, preferably selected from the group consisting of 1-methoxy methyl, 1-methoxy methyl, 1-methoxy ethyl, 1-methoxy propyl, 1-methoxy butyl, 2-hydroxy-butyl, 1-methoxy pentyl, 1-methoxy hexyl, 1-methoxy heptyl, 1-methoxy octyl, 1-methoxy nonyl, decyl, 1-methoxy undecyl, 1-methoxy dodecyl, 1-methoxy tridecyl, 1-methoxy tetradecyl, 1-methoxy pentadecyl, 1-methoxy hexadecyl, 1-methoxy heptadecyl, 1-methoxy octadecyl, 1-methoxy nonadecyl, 1-methoxy eicosyl, 1-methoxy henicosyl, 1-methoxy docosyl, 1-methoxy tricosyl, 1-methoxy tetracosyl, 2-methoxy propyl, 2-methoxy butyl, 2-methoxy pentyl, 2-methoxy hexyl, 2-methoxy heptyl, 2-methoxy octyl, 2-methoxy nonyl, decyl, 2-methoxy undecyl, 2-methoxy dodecyl, 2-methoxy tridecyl, 2-methoxy tetradecyl, 2-methoxy pentadecyl, 2-methoxy hexadecyl, 2-methoxy heptadecyl, 2-methoxy octadecyl, 2-methoxy nonadecyl, 2-methoxy eicosyl, 2-methoxy henicosyl, 2-methoxy docosyl, 2-methoxy tricosyl, 2-methoxy tetracosyl, 1-acetoxy methyl, 1-acetoxy ethyl, 1-acetoxy propyl, 1-acetoxy butyl, 1-acetoxy pentyl, 1-acetoxy hexyl, 1-acetoxy heptyl, 1-acetoxy octyl, 1-acetoxy nonyl, decyl, 1-acetoxy undecyl, 1-acetoxy dodecyl, 1-acetoxy tridecyl, 1-acetoxy tetradecyl, 1-acetoxy pentadecyl, 1-acetoxy hexadecyl, 1-acetoxy heptadecyl, 1-acetoxy octadecyl, 1-acetoxy nonadecyl, 1-acetoxy eicosyl, 1-acetoxy henicosyl, 1-acetoxy docosyl, 1-acetoxy tricosyl, 1-acetoxy tetracosyl, 1-cyano methyl, 1-cyano ethyl, 1-cyano propyl, 1-cyano butyl, 1-cyano pentyl, 1-cyano hexyl, 1-cyano heptyl, 1-cyano octyl, 1-cyano nonyl, decyl, 1-cyano undecyl, 1-cyano dodecyl, 1-cyano tridecyl, 1-cyano tetradecyl, 1-cyano pentadecyl, 1-cyano hexadecyl, 1-cyano heptadecyl, 1-cyano octadecyl, 1-cyano nonadecyl, 1-cyano eicosyl, 1-cyano henicosyl, 1-cyano docosyl, 1-cyano tricosyl, 1-cyano tetracosyl, 2-cyano propyl, 2-cyano butyl, 2-cyano pentyl, 2-cyano hexyl, 2-cyano heptyl, 2-cyano octyl, 2-cyano nonyl, decyl, 2-cyano undecyl, 2-cyano dodecyl, 2-cyano tridecyl, 2-cyano tetradecyl, 2-cyano pentadecyl, 2-cyano hexadecyl, 2-cyano heptadecyl, 2-cyano octadecyl, 2-cyano nonadecyl, 2-cyano eicosyl, 2-cyano henicosyl, 2-cyano docosyl, 2-cyano tricosyl, 2-cyano tetracosyl, 1-thioyl methyl, 1-thioyl ethyl, 1-thioyl propyl, 1-thioyl butyl, 1-thioyl pentyl, 1-thioyl hexyl, 1-thioyl heptyl, 1-thioyl octyl, 1-thioyl nonyl, decyl, 1-thioyl undecyl, 1-thioyl dodecyl, 1-thioyl tridecyl, 1-thioyl tetradecyl, 1-thioyl pentadecyl, 1-thioyl hexadecyl, 1-thioyl heptadecyl, 1-thioyl octadecyl, 1-thioyl nonadecyl, 1-thioyl eicosyl, 1-thioyl henicosyl, 1-thioyl docosyl, 1-thioyl tricosyl and 1-thioyl tetracosyl.

In the context of the present invention, the term “alkenyl” refers to unsubstituted, linear C₂-C₃₀ alkenyl. Representative examples of the alkenyl include, but are not limited to, 1-propenyl, 1-butenyl, 1-pentenyl, 1-hexenyl, 2-hexenyl, 1-heptenyl, 2-heptenyl, 1-octenyl, 2-octenyl, 1-nonenyl, 2-nonenyl, 1-decenyl, 2-decenyl, 1-undecenyl, 2-undecenyl, 1-dodecenyl, 2-dodecenyl, 1-tridecenyl, 2-tridecenyl, 1-tetradecenyl, 2-tetradecenyl, 1-pentadecenyl, 2-pentadecenyl, 1-hexadecenyl, 2-hexadecenyl, 1-heptadecenyl, 2-heptadecenyl, 1-octadecenyl, 2-octadecenyl, 1-nonadecenyl, 2-nonadecenyl, 1-eicosenyl and 2-eicosenyl, more preferably selected from 1-hexenyl, 2-hexenyl, 1-heptenyl, 2-heptenyl, 1-octenyl, 2-octenyl, 1-nonenyl, 2-nonenyl, 1-decenyl, 2-decenyl, 1-undecenyl, 2-undecenyl, 1-dodecenyl, 2-dodecenyl, 1-tridecenyl, 2-tridecenyl, 1-tetradecenyl, 2-tetradecenyl, 1-pentadecenyl, 2-pentadecenyl, 1-hexadecenyl, 2-hexadecenyl, 1-heptadecenyl, 2-heptadecenyl, 1-octadecenyl, 2-octadecenyl, 1-nonadecenyl, 2-nonadecenyl, 1-eicosenyl and 2-eicosenyl, 20-henicosenyl, 2-docosenyl, 6-tricosenyl and 2-tetracosenyl.

Representative examples of the unsubstituted branched C₂-C₃₀ alkenyl include, but are not limited to, isopropenyl, iso-butenyl, neo-pentenyl, 2-ethyl-hexenyl, 2-propyl-heptenyl, 2-butyl-octenyl, 2-pentyl-nonenyl, 2-hexyl-decenyl, iso-hexenyl, iso-heptenyl, iso-octenyl, isononenyl, iso-decenyl, iso-dodecenyl, iso-tetradecenyl, iso-hexadecenyl, iso-octadecenyl, iso-eicosenyl, 2-methyl tricosenyl, 2-ethyl docosenyl, 3-ethylhenicosenyl, 3-ethyl icosenyl, 4-propylhenicosenyl, 4-propylnonadecenyl, 6-butyldodecenyl, 5-ethylundedcenyl, 1,4-hexadienyl, 1,3-hexadienyl, 2,5-hexadienyl, 3,5-hexadienyl, 2,4-hexadienyl, 1,3,5-hexatrienyl, 1,3,6-heptatrienyl, 1,4,7-octatrienyl or 2-methyl-1,3,5hexatrienyl, 1,3,5,7-octatetraenyl, 1,3,5,8-nonatetraenyl, 1,4,7,10-undecatetraenyl, 2-ethyl-1,3,6,8-nonatetraenyl, 2-ethenyl-1,3,5,8-nonatetraenyl, 1,3,5,7,9-decapentaenyl, 1,4,6,8,10-undecapentaenyl, and 1,4,6,9,11-dodecapentaenyl.

In the context of the present invention, a substituted, linear or branched, C₂-C₃₀ alkenyl refers to a branched or a linear unsaturated hydrocarbon group having C₂-C₃₀ carbon atoms substituted with functional groups selected from alkoxy, C(═O)R, CN and SR; wherein R is hydrogen, substituted or unsubstituted, linear or branched C₁-C₃₀ alkyl, substituted or unsubstituted, linear or branched C₂-C₃₀ alkenyl, substituted or unsubstituted C₅-C₃₀ cycloalkyl, substituted or unsubstituted C₅-C₃₀ cycloalkenyl, substituted or unsubstituted C₆-C₃₀ aryl, substituted or unsubstituted C₇-C₃₀ arylalkyl.

In the context of the present invention, the term “alkenyl” further refers to a branched or an linear unsaturated hydrocarbon group having C₂-C₃₀ carbon atoms substituted with functional groups selected from, alkoxy, C(═O)R, CN and SR; preferably selected from the group consisting of 1-methoxy ethenyl, 2-methoxy propenyl, 4-methoxy butenyl, 3-methoxy pentenyl, 5-methoxy hexenyl, 2-methoxy heptenyl, 5-methoxy octenyl, 3-methoxy nonenyl, 6-methoxy undecenyl, 1-methoxy dodec-2-enyl, 1-methoxy tridec-5-enyl, 3-methoxy tetradic-5-enyl, 3-methoxy pentade-12-encyl, 10-methoxy hexadec-15-enyl, 12-methoxy heptadic-16-enyl, 1-methoxy octadec-3-enyl, 1-methoxy nonadec-2-enyl, 1-methoxy eicos-20-enyl, 1-methoxy henicos-2-enyl, 1-methoxy docos-4-enyl, 1-methoxy tricos-22-enyl, 1-methoxy tetracos-23-enyl, 2-methoxy prop-1-enyl, 2-methoxy but-1-enyl, 2-methoxy pent-4-enyl, 2-methoxy hex-2-enyl, 2-methoxy hept-3-enyl, 2-methoxy oct-7-enyl, 2-methoxy non-5-enyl, 2-methoxy undec-10-enyl, 2-methoxy dodec-4-enyl, 2-methoxy tridec-12-enyl, 2-methoxy tetradic-10-enyl, 2-methoxy pentadec-14-enyl, 2-methoxy hexadec-1-enyl, 2-methoxy heptadic-1-enyl, 2-methoxy octadic-12-enyl, 2-methoxy nonadec-10-enyl, 2-methoxy eicos-18-enyl, 2-methoxy henicos-2-enyl, 2-methoxy docos-3-enyl, 20-methoxy tricos-2-enyl, 21-methoxy tetracos-4-enyl, 1-acetoxy ethenyl, 1-acetoxy prop-1-enyl, 1-acetoxy but-2-enyl, 1-acetoxy pent-4-enyl, 1-acetoxy hex-2-enyl, 1-acetoxy hept-1-enyl, 1-acetoxy oct-7-enyl, 1-acetoxy non-2-enyl, 5-acetoxy dec-3-enyl, 1-acetoxy undec-10-enyl, 1-acetoxy dodec-2-enyl, 1-acetoxy tridec-12-enyl, 10-acetoxy tetradec-2-enyl, 15-acetoxy pentadec-2-enyl, 10-acetoxy hexadec-2-enyl, 11-acetoxy heptadec-1-enyl, 13-acetoxy octadec-2-enyl, 1-acetoxy nonadec-14-enyl, 20-acetoxy eicos-19-enyl, 1-acetoxy henicos-2-enyl, 1-acetoxy docos-10-enyl, 1-acetoxy tricos-22-enyl, 1-acetoxy tetracos-23-enyl, 1-cyano eth-1-enyl, 1-cyano prop-2-enyl, 1-cyano but-2-enyl, 1-cyano pent-3-enyl, 1-cyano hex-5-enyl, 1-cyano hept-6-enyl, 1-cyano oct-2-enyl, 1-cyano non-3-enyl, 11-cyano undec-2-enyl, 10-cyano dodec-2-enyl, 10-cyano tridec-12-enyl, 1-cyano tetradec-3-enyl, 1-cyano pentadec-14-enyl, 1-cyano hexadec-15-enyl, 1-cyano heptadec-2-enyl, 1-cyano octadec-3-enyl, 1-cyano nonadec-18-enyl, 1-cyano eicos-10-enyl, 1-cyano henicos-20-enyl, 15-cyano docos-3-enyl, 1-cyano tricos-20-enyl, 1-cyano tetracos-2-enyl, 2-cyano prop-2-enyl, 2-cyano but-1-enyl, 2-cyano pent-1-enyl, 2-cyano hex-3-enyl, 2-cyano hept-6-enyl, 2-cyano oct-1-enyl, 2-cyano non-8-enyl, 2-cyano undec-10-enyl, 2-cyano dodec-1-enyl, 2-cyano tridec-12-enyl, 2-cyano tetradec-10-enyl, 2-cyano pentadec-3-enyl, 2-cyano hexadec-2-enyl, 2-cyano heptadec-1-enyl, 2-cyano octadec-12-enyl, 2-cyano nonadec-15-enyl, 2-cyano eicos-1-enyl, 2-cyano henicos-5-enyl, 2-cyano docos-20-enyl, 2-cyano tricos-22-enyl, 2-cyano tetracos-20-enyl, 1-thionyl eth-1-enyl, 1-thionyl prop-2-enyl, 1-thionyl but-2-enyl, 1-thionyl pent-4-enyl, 1-thionyl hex-2-enyl, 1-thionyl hept-5-enyl, 1-thionyl oct-3-enyl, 1-thionyl non-5-enyl, 1-thionyl undec-10-enyl, 1-thionyl dodec-11-enyl, 1-thionyl tridec-2-enyl, 1-thionyl tetradec-4-enyl, 1-thionyl pentadec-5-enyl, 1-thionyl hexadec-3-enyl, 1-thionyl heptadec-2-enyl, 1-thionyl octadec-3-enyl, 1-thionyl nonadec-15-enyl, 1-thionyl eicos-18-enyl, 1-thionyl henicos-20-enyl, 1-thionyl docos-21-enyl, 1-thionyl tricos-20-enyl and 1-thionyl tetracos-22-enyl.

In the context of the present invention, the term “heteroalkyl” refers to an alkyl group, in which one or more carbon atoms have in each case been replaced by a heteroatom mutually independently selected from the group consisting of oxygen, sulfur and nitrogen (NH). A heteroalkyl preferably comprises 1, 2 or 3 heteroatom(s) mutually independently selected from the group consisting of oxygen, sulfur and nitrogen (NH) as chain link(s). Further, a heteroalkyl may be 2- to 12-membered, preferably 2- to 6-membered.

In the context of the present invention, the term “heteroalkenyl” refers to an alkenyl group, in which one or more carbon atoms have in each case been replaced by a heteroatom mutually independently selected from the group consisting of oxygen, sulfur and nitrogen (NH). A heteroalkenyl preferably comprises 1, 2 or 3 heteroatom(s) mutually independently selected from the group consisting of oxygen, sulfur and nitrogen (NH) as chain link(s). Further, a heteroalkenyl may be 3- to 12-membered, preferably 3- to 6-membered.

In the context of the present invention, the term “cycloalkyl” refers to a monocyclic and bicyclic saturated cycloaliphatic radical having 5 to 30 carbon atoms. Representative examples of unsubstituted or branched C₅-C₃₀ monocyclic and bicyclic cycloalkyl include, but are not limited to, cyclopentyl, cyclohexyl, dicyclohexylmethyl, cyclohexylmethyl, cyclododecyl, cycloheptyl, cyclooctyl, bicyclo[2.2.1]heptyl, and bicyclo[3.1.1]heptyl.

In the context of the present invention, a C₅-C₃₀ monocyclic and bicyclic cycloalkyl can be further branched with one or more equal or different alkyl groups such as methyl, ethyl, n-propyl, iso-propyl, n-butyl, iso-butyl, n-pentyl, iso-pentyl, neo-pentyl etc. The representative examples of branched C₃-C₁₀ monocyclic and bicyclic cycloalkyl include, but are not limited to, methyl cyclohexyl and dimethyl cyclohexyl.

In the context of the present invention, the term “cycloalkenyl” refers to a monocyclic and bicyclic unsaturated cycloaliphatic radical having 5 to 30 carbon atoms, which comprises one or more double bonds. Representative examples of C₅-C₃₀ cycloalkenyl include, but are not limited to, cyclopentenyl, cyclohexenyl, cycloheptenyl, cyclooctenyl, cyclononenyl or cyclodecenyl. These radicals can be branched with one or more equal or different alkyl radical, preferably with methyl, ethyl, n-propyl or iso-propyl. The representative examples of branched C₅-C₃₀ monocyclic and bicyclic cycloalkenyl include, but are not limited to, methyl cyclohexenyl and dimethyl cyclohexenyl.

In the context of the present invention, the term “heterocycloalkyl” means a non-aromatic monocyclic or polycyclic ring comprising 5 to 30 ring members in which at least one carbon atom as a ring member is replaced with at least one heteroatom selected from O, S, and N. Representative examples of heterocycloalkyl include, but are not limited to, aziridinyl, pyrrolidinyl, pyrrolidino, piperidinyl, piperidino, piperazinyl, piperazino, morpholinyl, morpholino, thiomorpholinyl, thiomorpholino, tetrahydrofuranyl, tetrahydrothiofuranyl, tetrahydropyranyl and pyranyl.

In the context of the present invention, the term “heterocycloalkenyl” refers to a non-aromatic unsaturated monocyclic or polycyclic ring comprising 5 to 30 ring members in which at least carbon atom as ring member is replaced with at least one heteroatom selected from O, S, and N and having at least one double bond. Representative examples include, but are not limited to, (2,3)-dihydrofuranyl, (2,3)-dihydrothienyl, (2,3)-dihydropyrrolyl, (2,5)-dihydropyrrolyl, (2,5)-dihydropyrrolyl, (2,3)-dihydroisoxazolyl, (1,4)-dihydropyridin-1-yl, di-hydropyranyl, 2,3-dihydropyrazol-1-yl, 2,3-dihydropyrazol-2-yl, 2,3-dihydropyrazol-3-yl, 2,3-dihydropyrazol-4-yl, 2,3-dihydropyrazol-5-yl, 3,4-dihydropyrazol-1-yl, 3,4-dihydropyrazol-3-yl, 3,4-dihydropyrazol-4-yl, 3,4-dihydropyrazol-5-yl, 4,5-dihydropyrazol-1-yl, 4,5-dihydropyrazol-3-yl, 4,5-dihydropyrazol-4-yl, 4,5-dihydropyrazol-5-yl, 2,3-dihydrooxazol-2-yl, 2,3-dihydrooxazol-3-yl, 2,3-dihydrooxazol-4-yl, 2,3-dihydrooxazol-5-yl, 3,4-dihydrooxazol-2-yl, 3,4-dihydrooxazol-3-yl, 3,4-dihydrooxazol-4-yl, 4,5-dihydropyrazol-2-yl, 4,5-dihydropyrazol-3-yl, 4,5-dihydropyrazol-4-yl, 4,5-dihydropyrazol-5-yl, 2,5-dihydrothienyl and (1,2,3,4)-tetrahydropyridin-1-yl.

In the context of the present invention it is conceivable that if one or more of the substituents denote a heteroalkyl, heteroalkenyl, cycloalkyl, cycloalkenyl, heterocycloalkyl and heterocycloalkenyl which is mono- or polysubstituted, this group is preferably substituted with 1, 2, 3, 4 or 5, particularly preferably with 1, 2 or 3, substituents mutually independently selected from the group consisting of F, Cl, Br, I, —CN, —NO₂, —OH, —SH, —NH₂, oxo (═O), thioxo (═S), —C(═O)—OH, C₁₋₅ alkyl, —C₂₋₅ alkenyl, —C₂₋₅ alkynyl, —C≡C—Si(CH₃)₃, —C≡C—Si(C₂H₅)₃, —(CH₂)—O—C₁₋₅-alkyl, —S—C₁₋₅-alkyl, —S-phenyl, —S—CH₂-phenyl, —O—C₁₋₅-alkyl, —O-phenyl, —O—CH₂-phenyl, —CF₃, —CHF₂, —CH₂F, —O—CF₃, —O—CHF₂, —O—CH₂F, —C(═O)—CF₃, —S—CF₃, —S—CHF₂, —S—CH₂F, —S(═O)₂-phenyl, —S(═O)₂—C₁₋₅-alkyl, —S(═O)—C₁₋₅-alkyl, —NH—C₁₋₅-alkyl, N(C₁₋₅alkyl) (C₁₋₅-alkyl), —C(═O)—O—C₁₋₅-alkyl, —C(═O)—H, —C(═O)—C₁₋₅-alkyl, —CH₂—O—C(═O)-phenyl, —O—C(═O)-phenyl, —NH—S(═O)₂—C₁₋₅-alkyl, —NH—C(═O)—C₁₋₅-alkyl, —C(═O)—NH₂, —C(═O)NH—C₁₋₅-alkyl, —C(═O)—N(C₁₋₅-alkyl)₂, pyrazolyl, phenyl, furyl (furanyl), thiadiazolyl, thiophenyl (thienyl) and benzyl, wherein the above-stated C₁₋₅ alkyl residues are in each case linear or branched and the cyclic substituents or the cyclic residues of these substituents themselves are in each case unsubstituted or substituted with 1, 2, 3, 4 or 5, preferably with 1, 2, 3 or 4, substituents mutually independently selected from the group consisting of F, Cl, Br, I, —CN, —CF₃, —OH, —NH₂, —O—CF₃, —SH, —O—C₁₋₅-alkyl, —O-phenyl, —O—CH₂-phenyl, —(CH₂)—O—C₁₋₅-alkyl, —S—C₁₋₅-alkyl, —S-phenyl, —S—CH₂-phenyl, —C₁₋₅ alkyl, —C₂₋₅ alkenyl, —C₂₋₅ alkynyl, —C≡C—Si(CH₃)₃, —C≡C—Si(C₂H₅)₃, —C(═O)—O—C₁₋₅-alkyl and —C(═O)—CF₃.

In the context of the present invention, the term “aryl” refers to aromatic compounds that may have more than one aromatic ring. The representative examples for substituted and unsubstituted C₆-C₃₀ aryl include, but are not limited to, phenyl, benzyl, cyclohexyl(phenyl)methyl, naphthyl, anthracenyl, tetraphenyl, phenalenyl and phenanthrenyl.

In the context of the present invention, the term “heteroaryl” refers to a monocyclic or polycyclic, preferably a mono-, bi- or tricyclic aromatic hydrocarbon residue with preferably 5, 6, 7, 8, 9, 10, 11, 12, 13, 14, 15, 16, 17, 18, 19, 20, 21, 22, 23, 24, 25, 26, 27, 28, 29 or 30 ring members, particularly preferably with 5, 6, 9, 10, 13 or 14 ring atoms, very particularly preferably with 5 or 6 ring members, in which one or more carbon atoms as ring members have been replaced with heteroatoms each independently selected from the group consisting of oxygen, sulfur and nitrogen (NH). A heteroaryl may comprise 1, 2, 3, 4 or 5, preferably 1, 2 or 3, heteroatom(s) mutually independently selected from the group consisting of oxygen, sulfur and nitrogen (NH) as ring member(s) A heteroaryl can be unsubstituted or monosubstituted or identically or differently polysubstituted. Representative examples of heteroaryl include, but are not limited to, thienyl, furyl, pyrrolyl, pyrazolyl, pyrazinyl, pyranyl, triazolyl, pyridinyl, imidazolyl, indolyl, isoindolyl, benzo[b]furanyl, benzo[b]thiophenyl, benzo[d]thiazolyl, benzodiazolyl, benzotriazolyl, benzoxazolyl, benzisoxazolyl, thiazolyl, thiadiazolyl, oxazolyl, oxadiazolyl, isoxazolyl, pyridazinyl, pyrimidinyl, indazolyl, quinoxalinyl, quinazolinyl, quinolinyl, naphthridinyl and isoquinolinyl.

In the context of the present invention, aryl or heteroaryl may be fused (anellated) with a mono- or bicyclic ring system. Representative examples of aryl which are fused with a mono- or bicyclic ring system include, but are not limited to, (1,2,3,4)-tetrahydroquinolinyl, (1,2,3,4)tetrahydroisoquinolinyl, (2,3)-dihydro-1H-isoindolyl, (1,2,3,4)-tetrahydronaphthyl, (2,3)-dihydrobenzo[1.4]dioxinyl, benzo[1.3]dioxolyl and (3,4)-dihydro-2H-benzo[1.4]oxazinyl.

In the context of the present invention, the term “arylalkyl” refers to an aryl ring attached to an alkyl chain. The representative examples for the arylalkyl include, but are not limited to, 1-phenylmethyl, 1-phenylethyl, 1-phenylpropyl, 1-phenylbutyl, 1-methyl-1-phenyl-propyl, 3-phenylpropyl, 4-phenylbutyl, 3-phenylbutyl and 2-methyl-3-phenyl-propyl.

In the context of the present invention it is conceivable that if one or more of the substituents denote an aryl, heteroaryl or arylalkyl or comprise an aryl or heteroaryl which is mono- or polysubstituted, this may preferably be substituted with 1, 2, 3, 4 or 5, particularly preferably with 1, 2 or 3, substituents mutually independently selected from the group consisting of F, CI, Br, I, —CN, —NO₂, —SH, —NH₂, —C(═O)—OH, —C₁₋₅ alkyl, —(CH₂)—O—C₁₋₅-alkyl, —C₂₋₅ alkenyl, —C₂₋₅ alkynyl, —C≡C—Si(CH₃)₃, —C≡C—Si(C₂H₅)₃, —S—C₁₋₅-alkyl, —S-phenyl, —S—CH₂-phenyl, —O—C₁₋₅-alkyl, —O-phenyl, —O—CH₂-phenyl, —CF₃, —CHF₂, —CH₂F, —O—CF₃, —O—CHF₂, —O—CH₂F, —C(═O)—CF₃, —S—CF₃, —S—CHF₂, —S—CH₂F, —S(═O)₂-phenyl, —S(═O)₂—C₁₋₅-alkyl, —S(═O)—C₁₋₅-alkyl, —NH—C₁₋₅-alkyl, N(C₁₋₅alkyl)₂, —C(═O)—O—C₁₋₅-alkyl, —C(═O)—H; —C(═O)—C₁₋₅-alkyl, —CH₂—O—C(═O)-phenyl, —O—C(═O)-phenyl, —NH—S(═O)₂—C₁₋₅-alkyl, —NH—C(═O)—C₁₋₅-alkyl, —C(═O)—NH₂, —C(═O)—NH—C₁₋₅-alkyl, —C(═O)—N(C₁₋₅-alkyl)₂, pyrazolyl, phenyl, furyl (furanyl), thiazolyl, thiadiazolyl, thiophenyl (thienyl), benzyl and phenethyl, wherein the above-stated C₁₋₅ alkyl residues are in each case linear or branched and the cyclic substituents or the cyclic residues of these substituents themselves are unsubstituted or substituted with 1, 2, 3, 4 or 5, preferably with 1, 2, 3 or 4, substituents mutually independently selected from the group consisting of F, Cl, Br, I, —CN, —NO₂, —SH, —NH₂, —C(═O)—OH, —C₁₋₅ alkyl, —(CH₂)—O—C₁₋₅-alkyl, —C₂₋₅ alkenyl, —C₂₋₅ alkynyl, —C≡C—Si(CH₃)₃, —C≡C—Si(C₂H₅)₃, —S—C₁₋₅-alkyl, —S-phenyl, —S—CH₂-phenyl, —O—C₁₋₅-alkyl, —O-phenyl, —O—CH₂-phenyl, —CF₃, —CHF₂, —CH₂F, —O—CF₃, —O—CHF₂, —O—CH₂F, —C(═O)—CF₃, —S—CF₃, —S—CHF₂ and —S—CH₂F; most preferably, the substituents are in each case mutually independently selected from the group consisting of F, Cl, Br, I, —CN, —NO₂, methyl, ethyl, n-propyl, isopropyl, n-butyl, isobutyl, 2-butyl, tert.-butyl, n-pentyl, neopentyl, ethenyl, allyl, ethynyl, propynyl, —C≡C—Si(CH₃)₃, —C≡C—Si(C₂H₅)₃, —CH₂—O—CH₃, —CH₂—O—C₂H₅, —SH, —NH₂, —C(═O)—OH, —S—CH₃, —S—C₂H₅, —S(═O)—CH₃, —S(═O)₂—CH₃, —S(═O)—C₂H₅, —S(═O)₂—C₂H₅, —O—CH₃, —O—C₂H₅, —O—C₃H₇, —O—C(CH₃)₃, —CF₃, —CHF₂, —CH₂F, —O—CF₃, —O—CHF₂, —O—CH₂F, —C(═O)—CF₃, —S—CF₃, —S—CHF₂, —S—CH₂F, —S(═O)₂-phenyl, pyrazolyl, phenyl, —N(CH₃)₂, —N(C₂H₅)₂, —NH—CH₃, —NH—C₂H₅, —CH₂—O—C(═O)-phenyl, —NH—S(═O)₂—CH₃, —C(═O)—O—CH₃, —C(═O)—O—C₂H₅, —C(═O)—O—C(CH₃)₃, —C(═O)—H, —C(═O)—CH₃, —C(═O)—C₂H₅, —NH—C(═O)—CH₃, —NH—C(═O)—C₂H₅, —O—C(═O)-phenyl, —C(═O)—NH₂, —C(═O)—NH—CH₃, —C(═O)—N(CH₃)₂, phenyl, furyl (furanyl), thiadiazolyl, thiophenyl (thienyl) and benzyl, wherein the cyclic substituents or the cyclic residues of these substituents themselves are in each case unsubstituted or substituted with 1, 2, 3, 4, or 5, preferably with 1, 2, 3 or 4, substituents mutually independently selected from the group consisting of F, Cl, Br, I, —CN, —NO₂, —SH, —NH₂, —C(═O)—OH, methyl, ethyl, n-propyl, isopropyl, n-butyl, isobutyl, 2-butyl, tert.-butyl, n-pentyl, neopentyl, ethenyl, allyl, ethynyl, propynyl, —C≡C—Si(CH₃)₃, —C≡C—Si(C₂H₅)₃, —CH₂—O—CH₃, —CH₂—O—C₂H₅, —S—CH₃, —S—C₂H₅, —S(═O)—CH₃, —S(═O)₂—CH₃, —S(═O)—C₂H₅, —S(═O)₂—C₂H₅, —O—CH₃, —O—C₂H₅, —O—C₃H₇, —O—C(CH₃)₃, —CF₃, —CHF₂, —CH₂F, —O—CF₃, —O—CHF₂, —O—CH₂F, —C(═O)—CF₃, —S—CF₃, —S—CHF₂ and —S—CH₂F.

In the context of the present invention, a substituted aryl may be selected from the group consisting of 2-methylphenyl, 3-methylphenyl, 4-methylphenyl, 2-fluorophenyl, 3-fluorophenyl, 4-fluorophenyl, 2-cyanophenyl, 3-cyanophenyl, 4-cyanophenyl, 2-aminophenyl, 3-aminophenyl, 4-aminophenyl, 2-dimethylaminophenyl, 3-dimethylaminophenyl, 4-dimethylaminophenyl, 2-methylaminophenyl, 3-methylaminophenyl, 4-methylaminophenyl, 2-acetylphenyl, 3-acetylphenyl, 4-acetylphenyl, 2-methylsulfinylphenyl, 3-methylsulfinylphenyl, 4-methylsulfinylphenyl, 2-methylsulfonylphenyl, 3-methylsulfonylphenyl, 4-methylsulfonylphenyl, 2-methoxyphenyl, 3-methoxyphenyl, 4-methoxyphenyl, 2-chlorophenyl, 3-chlorophenyl, 4-chlorophenyl, 2-ethoxyphenyl, 3-ethoxyphenyl, 4-ethoxyphenyl, 2-trifluoromethylphenyl, 3-trifluoromethylphenyl, 4-trifluoromethylphenyl, 2-difluoromethylphenyl, 3-difluoromethylphenyl, 4-difluoromethylphenyl, 2-fluoromethylphenyl, 3-fluoromethylphenyl, 4-fluoromethylphenyl, 2-nitrophenyl, 3-nitrophenyl, 4-nitrophenyl, 2-ethylphenyl, 3-ethylphenyl, 4-ethylphenyl, 2-propylphenyl, 3-propylphenyl, 4-propylphenyl, 2-isopropylphenyl, 3-isopropylphenyl, 4-isopropylphenyl, 2-tert.-butylphenyl, 3-tert.-butylphenyl, 4-tert.-butylphenyl, 2-carboxyphenyl, 3-carboxyphenyl, 4-carboxyphenyl, 2-ethenylphenyl, 3-ethenylphenyl, 4-ethenylphenyl, 2-ethynylphenyl, 3-ethynylphenyl, 4-ethynylphenyl, 2-allylphenyl, 3-allylphenyl, 4-allylphenyl, 2-trimethylsilanylethynylphenyl, 3-trimethylsilanylethynylphenyl, 4-trimethylsilanylethynylphenyl, 2-formylphenyl, 3-formylphenyl, 4-formylphenyl, 2-acetaminophenyl, 3-acetaminophenyl, 4-acetaminophenyl, 2-dimethylaminocarbonylphenyl, 3-dimethylaminocarbonylphenyl, 4-dimethylaminocarbonylphenyl, 2-methoxymethylphenyl, 3-methoxymethylphenyl, 4-methoxymethylphenyl, 2-ethoxymethylphenyl, 3-ethoxymethylphenyl, 4-ethoxymethylphenyl, 2-aminocarbonylphenyl, 3-aminocarbonylphenyl, 4-aminocarbonylphenyl, 2-methylaminocarbonylphenyl, 3-methylaminocarbonylphenyl, 4-methylaminocarbonylphenyl, 2-carboxymethyl ester phenyl, 3-carboxymethyl ester phenyl, 4-carboxymethyl ester phenyl, 2-carboxyethyl ester phenyl, 3-carboxyethyl ester phenyl, 4-carboxyethyl ester phenyl, 2-carboxy-tert.-butyl ester phenyl, 3-carboxy-tert.-butyl ester phenyl, 4-carboxy-tert.-butyl ester phenyl, 2-methylmercaptophenyl, 3-methylmercaptophenyl, 4-methylmercaptophenyl, 2-ethylmercaptophenyl, 3-ethylmercaptophenyl, 4-ethylmercaptophenyl, 2-biphenyl, 3-biphenyl, 4-biphenyl, 2-bromophenyl, 3-bromophenyl, 4-bromophenyl, 2-iodophenyl, 3-iodophenyl, 4-iodophenyl, 2-trifluoromethoxyphenyl, 3-trifluoromethoxyphenyl, 4-trifluoro-methoxyphenyl, 2-fluoro-3-trifluoromethylphenyl, 2-fluoro-4-methylphenyl, (2,3)-difluorophenyl, (2,3)-dimethylphenyl, (2,3)-dichlorophenyl, 3-fluoro-2-trifluoro-methylphenyl, (2,4)-dichlorophenyl, (2,4)-difluorophenyl, 4-fluoro-2-trifluoromethylphenyl, (2,4)-dimethoxyphenyl, 2-chloro-4-fluorophenyl, 2-chloro-4-nitrophenyl, 2-chloro-4-methylphenyl, 2-chloro-5-trifluoromethylphenyl, 2-chloro-5-methoxyphenyl, 2-bromo-5-trifluoromethylphenyl, 2-bromo-5-methoxyphenyl, (2,4)-dibromophenyl, (2,4)-dimethylphenyl, 2-fluoro-4-trifluoromethylphenyl, (2,5)-difluorophenyl, 2-fluoro-5-trifluoromethylphenyl, 5-fluoro-2-trifluoromethylphenyl, 5-chloro-2-trifluoromethylphenyl, 5-bromo-2-trifluoromethylphenyl, (2,5)-dimethoxyphenyl, (2,5)-bis-trifluoromethylphenyl, (2,5)-dichlorophenyl, (2,5)-dibromophenyl, 2-methoxy-5-nitrophenyl, 2-fluoro-6-trifluoromethylphenyl, (2,6)-dimethoxyphenyl, (2,6)-dimethylphenyl, (2,6)-dichlorophenyl, 2-chloro-6-fluorophenyl, 2-bromo-6-chlorophenyl, 2-bromo-6-fluorophenyl, (2,6)-difluorophenyl, (2,6)-difluoro-3-methylphenyl, (2,6)-dibromophenyl, (2,6)-dichlorophenyl, 3-chloro-2-fluorophenyl, 3-chloro-5-methylphenyl, (3,4)-dichlorophenyl, (3,4)-dimethylphenyl, 3-methyl-4-methoxyphenyl, 4-chloro-3-nitrophenyl, (3,4)-dimethoxyphenyl, 4-fluoro-3-trifluoromethylphenyl, 3-fluoro-4-trifluoromethylphenyl, (3,4)-difluorophenyl, 3-cyano-4-fluorophenyl, 3-cyano-4-methylphenyl, 3-cyano-4-methoxyphenyl, 3-bromo-4-fluorophenyl, 3-bromo-4-methylphenyl, 3-bromo-4-methoxyphenyl, 4-chloro-2-fluorophenyl, 4-chloro-3-trifluoromethyl, 4-bromo-3-methylphenyl, 4-bromo-5-methylphenyl, 3-chloro-4-fluorophenyl, 4-fluoro-3-nitrophenyl, 4-bromo-3-nitrophenyl, (3,4)-dibromophenyl, 4-chloro-3-methylphenyl, 4-bromo-3-methylphenyl, 4-fluoro-3-methylphenyl, 3-fluoro-4-methylphenyl, 3-fluoro-5-methylphenyl, 2-fluoro-3-methylphenyl, 4-methyl-3-nitrophenyl, (3,5)-dimethoxyphenyl, (3,5)-dimethylphenyl, (3,5)-bis-trifluoromethylphenyl, (3,5)-difluorophenyl, (3,5)-dinitrophenyl, (3,5)-dichlorophenyl, 3-fluoro-5-trifluoromethylphenyl, 5-fluoro-3-trifluoromethylphenyl, (3,5)-dibromophenyl, 5-chloro-4-fluorophenyl, 5-chloro-4-fluorophenyl, 5-bromo-4-methylphenyl, (2,3,4)-trichlorophenyl, (2,3,6)-trifluorophenyl, 5-chloro-2-methoxyphenyl, (2,3)-difluoro-4-methyl, (2,4,5)-trifluorophenyl, (2,4,5)trichlorophenyl, (2,4)-dichloro-5-fluorophenyl, (2,4,6)-trichlorophenyl, (2,4,6)-trimethylphenyl, (2,4,6)-trifluorophenyl, (2,4,6)-trimethoxyphenyl, (3,4,5)-trimethoxyphenyl, (2,3,4,5)-tetrafluorophenyl, 4-methoxy-(2,3,6)-trimethylphenyl, 4-methoxy-(2,3,6)-trimethylphenyl, 4-chloro-2,5-dimethylphenyl, 2-chloro-6-fluoro-3-methylphenyl, 6-chloro-2-fluoro-3-methyl, (2,4,6)-trimethylphenyl and (2,3,4,5,6)-pentafluorophenyl.

In the context of the present invention, examples of a substituted heteroaryl are 3-methylpyrid-2-yl, 4-methylpyrid-2-yl, 5-methylpyrid-2-yl, 6-methylpyrid-2-yl, 2-methylpyrid-3-yl, 4-methylpyrid-3-yl, 5-methylpyrid-3-yl, 6-methylpyrid-3-yl, 2-methylpyrid-4-yl, 3-methylpyrid-4-yl, 3-fluoropyrid-2-yl, 4-fluoropyrid-2-yl, 5-fluoropyrid-2-yl, 6-fluoropyrid-2-yl, 3-chloropyrid-2-yl, 4-chloropyrid-2-yl, 5-chloropyrid-2-yl, 6-chloropyrid-2-yl, 3-trifluoromethylpyrid-2-yl, 4-trifluoromethylpyrid-2-yl, 5-trifluoromethylpyrid-2-yl, 6-trifluoromethylpyrid-2-yl, 3-methoxypyrid-2-yl, 4-methoxypyrid-2-yl, 5-methoxypyrid-2-yl, 6-methoxypyrid-2-yl, 4-methylthiazol-2-yl, 5-methylthiazol-2-yl, 4-trifluoromethylthiazol-2-yl, 5-trifluoromethylthiazol-2-yl, 4-chlorothiazol-2-yl, 5-chlorothiazol-2-yl, 4-bromothiazol-2-yl, 5-bromothiazol-2-yl, 4-fluorothiazol-2-yl, 5-fluorothiazol-2-yl, 4-cyanothiazol-2-yl, 5-cyanothiazol-2-yl, 4-methoxythiazol-2-yl, 5-methoxythiazol-2-yl, 4-methyloxazol-2-yl, 5-methyloxazol-2-yl, 4-trifluoromethyloxazol-2-yl, 5-trifluoromethyloxazol-2-yl, 4-chlorooxazol-2-yl, 5-chlorooxazol-2-yl, 4-bromooxazol-2-yl, 5-bromooxazol-2-yl, 4-fluorooxazol-2-yl, 5-fluorooxazol-2-yl, 4-cyanooxazol-2-yl, 5-cyanooxazol-2-yl, 4-methoxyoxazol-2-yl, 5-methoxyoxazol-2-yl, 2-methyl-(1,2,4)-thiadiazol-5-yl, 2-trifluoromethyl-(1,2,4)-thiadiazolyl-5-yl, 2-chloro(1,2,4)-thiadiazol-5-yl, 2-fluoro-(1,2,4)-thiadiazol-5-yl, 2-methoxy-(1,2,4)-thiadiazol-5-yl, 2-cyano-(1,2,4)-thiadiazol-5-yl, 2-methyl-(1,2,4)-oxadiazol-5-yl, 2-trifluoromethyl-(1,2,4)oxadiazol-5-yl, 2-chloro-(1,2,4)-oxadiazol-5-yl, 2-fluoro-(1,2,4)-oxadiazol-5-yl, 2-methoxy(1,2,4)-oxadiazol-5-yl and 2-cyano-(1,2,4)-oxadiazol-5-yl.

In the context of the present invention, the term “substituted” for any one of the alkylene; heteroalkylene; alkenylene; heteroalkenylene; cycloalkylene; heterocycloalkylene; cycloalkenylene; heterocycloalkenylen; arylene and heteroarylene disclosed herein refers to mono- or polysubstituted alkylene; heteroalkylene; alkenylene; heteroalkenylene; cycloalkylene; heterocycloalkylene; cycloalkenylene; heterocycloalkenylen; arylene and heteroarylene, respectively, they may preferably be substituted with 1, 2, 3, 4 or 5, more preferably with 1, 2 or 3 substituents. Examples of substituents are —NHR¹, with R¹ is —C(Rᵤ)(Rᵥ)(R_{w})—, wherein Rᵤ, Rᵥ and R_{w} independently of each other are selected from the group consisting of hydrogen, linear or branched, substituted or unsubstituted C₁-C₃₀ alkyl, linear or branched, substituted or unsubstituted C₂-C₃₀ alkenyl, substituted or unsubstituted, linear or branched 2- to 30-membered heteroalkyl, substituted or unsubstituted, linear or branched 3- to 30-membered heteroalkenyl, substituted or unsubstituted C₅-C₃₀ cycloalkyl, substituted or unsubstituted C₅-C₃₀ cycloalkenyl, substituted or unsubstituted 5- to 30-membered heterocycloalkyl, substituted or unsubstituted 5- to 30-membered heterocycloalkenyl, substituted or unsubstituted C₆-C₃₀ aryl, substituted or unsubstituted 5- to 30-membered heteroaryl, substituted or unsubstituted C₁-C₁₀ alkylene C₅-C₃₀ cycloalkyl, substituted or unsubstituted C₁-C₁₀ alkylene C₅-C₃₀ cycloalkenyl, substituted or unsubstituted C₁-C₁₀ alkylene 5- to 30-membered heterocycloalkyl, substituted or unsubstituted C₁-C₁₀ alkylene 5- to 30-membered heterocycloalkenyl, substituted or unsubstituted C₁-C₁₀ alkylene C₆-C₃₀ aryl and substituted or unsubstituted C₁-C₁₀ alkylene 5- to 30-membered heteroaryl. More preferably, Rᵤ, Rᵥ and R_{w} independently of each other are selected from the group consisting of hydrogen, linear or branched, substituted or unsubstituted C₁-C₃₀ alkyl. More preferably, Rᵤ, Rᵥ and R_{w} independently of each other are selected from the group consisting of hydrogen, methyl, ethyl, propyl, iso-propyl, butyl, pentyl, hexyl, octyl, dodecyl, sec-butyl, tert-butyl, sec-isopentyl, 2-pentyl, 2-methyl-4-pentyl, 3-pentyl, 2-methyl-pentyl, 2,6-dimethyl-4-heptyl, 3-pinanyl-methyl, cyclopentyl, cyclohexyl, dicyclohexylmethyl, cyclohexylmethyl, cyclododecyl, phenyl, benzyl, and cyclohexyl (phenyl)methyl, preferably selected from the group consisting of hydrogen, methyl, and ethyl, more preferably selected from the group consisting of hydrogen, methyl and ethyl. Alternatively, preferably, in —NHR¹, R¹ is —C(Rᵤ)(Rᵥ)(R_{w}), wherein C and Rᵤ form a substituted or unsubstituted C₆-C₃₀ arylene, and both Rᵥ and R_{w} are none. For example, —NHR¹ can be —NH-Ph.

In the context of the present invention, for —Z₁₂—, —N(R_{f})— means that the N atom is bonded with the R_{f} which is bonded to Cₐ in formula (I), forming thus a heterocycle.

In the context of the present invention, a reversible NCO bond designates the bond between N (from secondary hindered amine) and C (of NCO) of a urea group which can be reversibly formed and broken.

In the context of the present invention, a “thermoset polymer” refers to a network polymer, comprising covalently bonded structures having at least three points of covalent bond attachment between polymer chains, wherein preferably the at least three points of covalent bond attachment between polymer chains forms part of a polymer network.

In the context of the present invention, a “thermoplastic polymer” refers to a linear polymer, comprising covalently bonded structures having two points of covalent bond attachment between polymer chains, wherein preferably the two points of covalent bond attachment between polymer chains forms part of a linear polymer system.

In the context of the present invention, an isocyanate is a general term for a molecule that comprises at least one isocyanate functional group. Therefore, the interpretation of the term “at least one isocyanate” encompases monoisocyanate(s), diisocyanate(s), triisocyanate(s), tetraisocyanate(s) and isocyanate(s) with higher numbers of isocyanate functional groups such as polymers having one or more isocyanate functional groups. An example of an isocyanate in the context of the present invention is polymethylene polyphenylisocyanate also commonly referred to as pMDI.

In the context of the present invention, the abbreviation “SHA” stands for a Secondary Hindered Amine. A secondary hindered amine is a general term well-known in the art. In particular, in said term, the secondary amine is given it's usual definition of an amine bound to two separate carbons of any hybridization, said carbons cannot be carbonyl group carbons. The hindered substituent is defined as at least one carbon bound to the amino group, said carbon being further directly bound to at least two other carbon groups. Non-limiting examples of secondary hindered amines in the context of the present invention are 4,4′-methylenebis(N-sec-butylaniline) (DIB-MDA), DIB-butanediamine (N,N′-di-sec-butyl-1,4-butanediamine) or a sec-butyl-modified polyether amine, with the following formula CH₃—CH₂—CH(CH₃)—NH—[CH(CH₃)—CH₂—O]ₘ₁—CH₂—C(Rₓ₁)(R_{y1})—CH₂—[O—CH₂—CH(CH₃)]ₒ₁—NH—CH(CH₃)CH₂—CH₃, wherein Rₓ₁ is —CH₂—CH₃ and R_{y1} is —CH₂—[O—CH₂—CH(CH₃)]ₙ₁—NH—CH(CH₃)—CH₂—CH₃, wherein m1+n1+o1 is in the range of 5 to 6.

The present invention is further illustrated by the examples below.

### EXAMPLES

### Material Abbreviations

PolyTHF (a commercial product from BASF): Polytetrahydrofurane (Polytetramethylene ether glycol) (functionality=2; average molecular weight Mn=2000 g/mol, OH=56 mg KOH/g).
MDI: 4,4′-Methylenebis(phenyl isocyanate) purchased from BASF Polyurethanes GmbH
BDO: 1,4-butanediol purchased from Alfa Aesar
DIBIS: diethylene glycol bis chloroformate purchased from BASF Polyurethanes GmbH Benzoyl Chloride purchased from Sigma Aldrich
TDI, Mixture of 80% 2,4- and 20% 2,6-toluene diisocyanate purchased from BASF
pMDI: polymeric diphenylmethane diisocyanate (BASF product)
DIB-MDA: 4,4′-Methylenebis(N-sec-butylaniline) purchased from abcr
DIB-butanediamine: N,N′-di-sec-butyl-1,4-butanediamine DIB-polyetheramine T403 prepared from polyetheramine T403 purchased from BASF
Polyol 1=trifunctional polyether polyol and contains predominantly secondary hydroxyl groups-functionality=3, Mn=3500 g/mol, OH=48 mg KOH/g, Viscosity (25° C.)=600 mPa·s.
Polyol 2=trifunctional polyether polyol based on glycerine-functionality=3, Mn=420 g/mol, OH=400 mg KOH/g, Viscosity (25° C.)=373 mPa·s
Polymer type TP: Thermoplastics
Polymer type TS: Thermosets

### Analytical Methods

TGA (thermogravimetrical analysis): Spectra were obtained according to ISO 11358 under N2 atmosphere in gold crucibles.

NCO content: The content of NCO was determined according to DIN EN ISO 14896 determined with a Metrohm Modell 916 TI-Touch.

Melting points: Samples of polyurethane ureas were cut into cubes having dimension of 0.2×0.2×0.2 cm³, which were transferred to a hot press, P/O/Weber model number: PW20H of 2006. The sample was pressed applying 20 kN of force using a circular press having a diameter of 17 cm, equivalent to about 880 kPa of pressure for at least 5 minutes and the temperature was increased. The melting point was determined when solid polymer visibly transitioned in phase.

DSC (Differential Scanning calorimetry) measurements: DSC analysis was carried out on samples of about 5-10 mg using a TA Instruments brand DSC model Q20 according to ASTM D 3418.

Swelling ratio, insoluble and soluble fractions: Samples of polyurethane ureas were cut into cubes having dimension of 0.5×0.5×0.5 cm³. The samples were allowed to swell in THE at room temperature for 24 h. Subsequently, the excess of THF was removed. The swelled samples were weighted (m (swollen)). The samples were dried first at ambient conditions, then under vacuum at 65° C. to remove the THF that was taken up. In the end the mass of the dried sample was evaluated (m (dried)). The swelling ratio and insoluble fraction was determined via the following equations:

Swelling ratio=[m(swollen)−m(dried)]/m(dried)

Insoluble fraction=m(dried)/m(dry)

Soluble fraction=1−Insoluble fraction

TABLE 1
Brief summary

| | | | | | Soluble | Swelling | NCO | |
|---|---|---|---|---|---|---|---|---|
| | Prepolymer | | Chain | | fraction | Ratio | band | TGA −5% |
| | Polyol / | S (Standard)/ | Extender / | Polymer | (THF, 24 | (THF, | gone | mass |
| Example | Isocyanate | CAN /CAS | Cross-linker | Type | h) [%] | 24 h) | (IR) | [° C.] |
| 1A | polyTHF | Comparative: S | BDO | TP | 100 | — | yes | >300 |
| | (f = 2)/ | | (f = 2) | | | | | |
| | mMDI | Inventive: CAS | DIB-MDA | | 100 | — | yes | 289 |
| | (f = 2) | | (f = 2) | | | | | |
| 1B | polyTHF | Comparative: S | BDO | TP | 100 | — | yes | 297 |
| | (f = 2)/ | | (f = 2) | | | | | |
| | TDI | Inventive: CAS | DIB-MDA | | 100 | — | yes | 272 |
| | (f = 2) | | (f = 2) | | | | | |
| 1C | polyTHF | Comparative: S | BDO | TS | 1 | 2.25 | yes | >300 |
| | (f = 2)/ | | (f = 2) | | | | | |
| | pMDI | Inventive: CAN | DIB-MDA | | 0 | 2.56 | yes | 292 |
| | (f = 2-3) | | (f = 2) | | | | | |
| 1D | polyTHF | Comparative: S | BDO | TS | 1 | 2.03 | yes | >300 |
| | (f = 2)/ | | (f = 2) | | | | | |
| | mMDI:pMDI | Inventive: CAN | DIB-MDA | | 2 | 2.41 | Yes | 290 |
| | (1:1) | | (f = 2) | | | | | |
| | (f = 2-3) | | | | | | | |
| 2 | Polyol 1 | Comparative: S | BDO | TS | 2 | 3.40 | yes | 316 |
| | (f = 3)/ | | (f = 2) | | | | | |
| | mMDI | Inventive: CAN | DIB-MDA | | 2 | 3.48 | yes | 287 |
| | (f = 2) | | (f = 2) | | | | | |
| 3 | polyTHF | Comparative: S | Polyol 2 | TS | 0 | 2.55 | Yes | >300 |
| | (f = 2)/ | | (f = 3) | | | | | |
| | mMDI | Inventive: CAN | DIB- | | 16 | 4.78 | yes | 293 |
| | (f = 2) | | polyetheramine | | | | | |
| | | | T403 | | | | | |
| | | | (f = 3) | | | | | |

### Reference Example 1A: Preparation of a Prepolymer

100 g of 4,4′-methylenebis(phenyl isocyanate) (mMDI) (0.400 mol) were immersed in a flask, put under N₂. The mixture was heated. When the MDI was melted, 0.02 g benzoyl chloride (141 μmol) were added. 233 g polytetrahydrofuran (poly THF) (functionality=2, Mₙ=2000 g/mol, hydroxyl value=55 mg KOH/g) were melted and added slowly at 80° C. to the mMDI-containing mixture. The reaction was terminated by cooling when the NCO value reached <8% (molar ratio NCO:OH about 1:0.3). The prepolymer 1a was obtained as a colorless, slightly opaque liquid.

### Reference Example 1B: Preparation of a Prepolymer

17.4 g of toluene diisocyanate (TDI) (0.100 mol) were immersed in a flask, put under N₂. The mixture was heated to 80° C. and 0.008 g diglycol bis chloroformate (DIBIS) (35 μmol) were added. 62 g polyTHF (functionality=2, Mₙ=2000 g/mol, hydroxyl value=55 mgKOH/g) were melted and added slowly at 80° C. to the TDI mixture. The reaction was terminated by cooling when the NCO value reached <8% (molar ratio NCO:OH˜1:0.3). The prepolymer 1b was obtained as a colorless, slightly opaque liquid.

### Reference Example 1C: Preparation of a Prepolymer

34.0 g of polymeric diphenylmethane diisocyanate (pMDI) (0.100 mol) and 8 mg DIBIS (35 μmol) were mixed. 75.0 g polyTHF (functionality=2, Mₙ=2000 g/mol, hydroxyl value=55 mgKOH/g) were melted and added slowly at 80° C. to the pMDI-containing mixture. The reaction was terminated by cooling when the NCO value reached <8% (molar ratio NCO:OH about 1:0.25). The prepolymer 1c was obtained as a brownish, slightly opaque liquid.

### Reference Example 1D: Preparation of a Prepolymer

20.0 g of mMDI (0.060 mol) was added to 20.0 g of pMDI (0.080 mol) and 8 mg DIBIS (35 μmol). 77.5 g poly THF (functionality=2, Mₙ=2000 g/mol, hydroxyl value=55 mgKOH/g) were melted and added slowly at 80° C. to the mMDI/pMDI-containing mixture. The reaction was terminated by cooling when the NCO value reached <8% (molar ratio NCO:OH about 1:0.3)). The prepolymer was obtained as a brownish, slightly opaque liquid.

### Reference Example 2: Preparation of a Prepolymer

75.0 g of MDI (0.300 mol) were immersed in a flask, put under N₂. It was heated to 80° C. and a mixture of 188 g Polyol 1 (trifunctional polyether polyol with propylene oxide (PO) end-capping, having secondary hydroxyl groups, functionality=3, Mₙ=3500 g/mol, hydroxyl value=48 mgKOH/g, viscosity (25° C.)=600 mPa*s) and 0.008 g DIBIS (35 μmol) were added slowly at 80° C. The reaction was terminated by cooling when the NCO value reached <8% (molar ratio NCO:OH about 1:0.3)). The prepolymer 2 was obtained as a colorless, slightly opaque liquid.

### Reference Example 3: Preparation of DIB-Polyetheramine T403

A 300 mL steel pressure autoclave was charged with 100 g (0.21 mol, 1 eq) polyetheramine T403 and 26.6 g butan-2-on (0.36 mol, 1.7 eq) in the presence of a palladium catalyst (Pd/Ag on alumina with predominantly theta content, with 0.3 wt.-% Pd, 0.1 wt.-% Ag based on alumina, the EM distribution is egg-shell, catalyst purchased from BASF-such catalyst are described in WO 2006/040159 A1) (17.75 g, 14.06 wt %). The autoclave was sealed, purged with nitrogen and heated to 140° C. under normal pressure. Subsequently, the autoclave was pressurized with H₂ (160 bar) at the same temperature for 20 h. The autoclave was cooled down and vented. The crude compound was filtered, and volatiles and water were removed under reduced pressure to give 98 g of a colorless, transparent liquid that was used without any further purification.

### Comparative Example 1A: Preparation of a Poly(Urea-Urethane) Polymer According to the Prior Art and Recyclability Testing Thereof

60.0 g of the prepolymer 1a obtained according to Ref. Ex. 1A (7.94% NCO) were heated to 70° C., degassed and set under N₂. 4.67 g 1,4-butanediol (BDO) (51.8 mmol) were added (molar ratio NCO:OH 1.00:1.00 to 1.05:1.00) and the mixture was stirred in a speedmixer at 2000 rpm for 20 seconds. The mixture was casted into a silicon rubber mold lined with separating foil and cured for 40 min at 105° C. in a drying oven. The material was obtained as a white opaque solid plate. The characteristics of the obtained material are noted in Tables 1 & 2.

Recyclability testing (melting). A sample of the obtained plate was cut into small cubes (0.2×0.2×0.2 cm³), which were transferred to a hot press. The sample was pressed applying 880 kPa pressure for at least 5 minutes (20 kN of force applied in a circular press having a diameter of 17 cm according to the melting point analytical method above). The sample started to melt around 110 to 120° C. and formed a cookie shaped plate after cooling down. Further testing are disclosed in Example 9 and 10 below.

### Example 1A: Preparation of a Covalent Adaptable System (CAS) Poly(Urea-Urethane) Polymer According to the Present Invention and Recyclability Testing Thereof

60.0 g of the prepolymer 1a obtained according to Ref. Ex. 1A (7.94% NCO) were heated to 70° C., degassed and set under N₂. 16.1 g 4,4′-methylene-bis[N-(1-methylpropyl)-phenylamine] (DIB-MDA) (51.8 mmol) (molar ratio NCO:NH 1.00:1.00 to 1.05:1.00) and were added and the mixture was stirred in a speedmixer at 2000 rpm for 20 seconds. The obtained mixture was casted into a silicon rubber mold lined with separating foil and cured for 40 min at 105° C. in a drying oven. The material was obtained as a yellow transparent solid plate. The characteristics of the obtained material are noted in Tables 1 & 2.

Recyclability testing (melting). A sample of the obtained plate was cut into small cubes (about 0.2×0.2×0.2 cm³), which were transferred to a hot press. The sample was pressed applying 880 kPa pressure for at least 5 minutes (20 kN of force applied in a circular press having a diameter of 17 cm according to the melting point analytical method above). The sample started to melt around 70° C. and formed a thin foil after cooling down. Further testing are disclosed in Example 9 and 10 below.

Conclusion: the product obtained according to the present invention starts melting at temperature of about 70° C., at much lower temperatures than Comp. Ex. 1A, and permits to form a thin foil—it is recyclable.

### Comparative Example 1B: Preparation of a Poly(Urea-Urethane) Polymer According to the Prior Art

30.0 g of the prepolymer 1b obtained according to Ref. Ex. 1B (7.47% NCO) were heated to 70° C., degassed and set under N₂. 2.29 g 1,4-butanediol (BDO) (25.4 mmol) were added (molar ratio NCO:OH 1.00:1.00 to 1.05:1.00) and the mixture was stirred in a speedmixer at 2000 rpm for 20 seconds. The mixture was casted into a silicon rubber mold lined with a separating foil and cured for 16 h at 105° C. in a drying oven. The material was obtained as a colorless transparent viscoelastic plate that showed to flow already at room temperature. The characteristics of the obtained material are noted in Tables 1 & 2.

### Example 1B: Preparation of a Covalent Adaptable System (CAS) Poly(Urea-Urethane) Polymer According to the Present Invention

30.0 g of the prepolymer 1b according to Ref. Ex. 1B (7.47% NCO) were heated to 70° C., degassed and set under N₂. 8.39 g DIB-MDA (25.4 mmol) (molar ratio NCO:NH 1.00:1.00 to 1.05:1.00) were added and the mixture was stirred in a speedmixer at 2000 rpm for 20 seconds. The mixture was casted into a silicon rubber mold lined with separating foil and cured for 40 min at 105° C. in a drying oven. The material was obtained as a yellow transparent viscoelastic plate that showed to flow already at room temperature. The characteristics of the obtained material are noted in Tables 1 & 2.

### Comparative Example 1C: Preparation of a Poly(Urea-Urethane) Polymer According to the Prior Art and Recyclability Testing Thereof

30.0 g of the prepolymer 1c according to Ref. Ex. 1C (7.15% NCO) were mixed with 2.19 g BDO (24.2 mmol) (molar ratio NCO:OH 1.05:1.00) and stirred in a speedmixer at 2000 rpm for 20 seconds. The mixture was casted into a silicon rubber mold lined with separating foil and cured for 90 min at 105° C. in a drying oven. The material was obtained as a brownish opaque solid plate. The characteristics of the obtained material are noted in Tables 1 & 2.

Recyclability testing (melting). A sample of the obtained plate was cut into small cubes (about 0.2×0.2×0.2 cm³), which were transferred to a hot press. The sample was pressed applying 880 kPa pressure for at least 5 minutes (20 kN of force applied in a circular press having a diameter of 17 cm according to the melting point analytical method above). The sample did not melt up to a temperature of 180° C.

### Example 1C: Preparation of a Covalent Adaptable Network (CAN) Poly(Urea-Urethane) Polymer According to the Present Invention and Recyclability Testing Thereof

30.0 g of the prepolymer 1c according to Ref. Ex. 1C (7.15% NCO) were mixed with 8.03 g DIB-MDA (24.2 mmol) (molar ratio NCO:OH 1.05:1.00) and stirred in a speedmixer at 2000 rpm for 20 seconds. The mixture was casted into a silicon rubber mold lined with separating foil and cured for 90 min at 105° C. in a drying oven. The material was obtained as a brownish opaque solid plate. The characteristics of the obtained material are noted in Tables 1 & 2.

Recyclability testing (melting). A sample of the obtained plate was cut into small cubes (about 0.2×0.2×0.2 cm³), which were transferred to a hot press. The sample was pressed applying 880 kPa pressure for at least 5 minutes (20 kN of force applied in a circular press having a diameter of 17 cm according to the melting point analytical method above). The sample started to melt around 160° C. and formed a thin foil after cooling down.

Conclusion: Contrary to Comp. Ex. 1C, the product obtained according to the present invention is able to melt and permits to form a thin foil—it is recyclable.

### Comparative Example 1D: Preparation of a Poly(Urea-Urethane) Polymer According to the Prior Art and Recyclability Testing Thereof

25.0 g of the prepolymer 1d obtained according to Ref. Ex. 1D (7.85% NCO) were mixed with 2.00 g BDO (22.2 mmol) (molar ratio NCO:OH 1.05:1.00) and stirred in a speedmixer at 2000 rpm for 20 seconds. The mixture was casted into a silicon rubber mold lined with separating foil and cured for 90 min at 105° C. in a drying oven. The material was obtained as an off-white opaque solid plate. The characteristics of the obtained material are noted in Tables 1 & 2.

Recyclability testing (melting). A sample of the obtained plate was cut into small cubes (about 0.2×0.2×0.2 cm³), which were transferred to a hot press. The sample was pressed applying 880 kPa pressure for at least 5 minutes (20 kN of force applied in a circular press having a diameter of 17 cm according to the melting point analytical method above). The sample did not melt up to a temperature of 180° C.

### Example 1D: Preparation of a Covalent Adaptable Network (CAN) Poly(Urea-Urethane) Polymer According to the Present Invention and Recyclability Testing Thereof

25.0 g of the prepolymer 1d obtained according to Ref. Ex. 1D (7.85% NCO) were mixed with 7.35 g DIB-MDA (22.2 mmol) (molar ratio NCO:OH 1.05:1.00) and stirred in a speedmixer at 2000 rpm for 20 seconds. The mixture was casted into a silicon rubber mold lined with separating foil and cured for 90 min at 105° C. in a drying oven. The material was obtained as a yellow slightly opaque solid plate. The characteristics of the obtained material are noted in Tables 1 & 2.

Recyclability testing (melting). A sample of the obtained plate was cut into small cubes (about 0.2×0.2×0.2 cm³), which were transferred to a hot press. The sample was pressed applying 880 kPa pressure for at least 5 minutes (20 kN of force applied in a circular press having a diameter of 17 cm according to the melting point analytical method above). The sample started to melt around 140° C. and formed a thin foil after cooling down.

Conclusion: Contrary to Comp. Ex. 1D, the product obtained according to the present invention is able to melt and permits to form a thin foil—it is recyclable.

### Comparative Example 2: Preparation of a Poly(Urea-Urethane) Polymer According to the Prior Art and Recyclability Testing Thereof

30.0 g of the prepolymer 2 obtained according to Ref. Ex. 2 (7.50% NCO) and 2.30 g BDO (25.3 mmol) were added (molar ratio NCO:OH was 1.00:1.00 to 1.05:1.00) and the mixture was stirred in a speedmixer at 2000 rpm for 20 seconds. The mixture was casted into a silicon rubber mold lined with separating foil and cured for 90 min at 105° C. in a drying oven. The material was obtained as a white opaque solid plate. The characteristics of the obtained material are noted in Tables 1 & 2.

Recyclability testing (melting). A sample of the obtained plate was cut into small cubes (about 0.2×0.2×0.2 cm³), which were transferred to a hot press. The sample was pressed applying 880 kPa pressure for at least 5 minutes (20 kN of force applied in a circular press having a diameter of 17 cm according to the melting point analytical method above). The sample did not melt up to a temperature of 180° C.

Recyclability testing (extruding). For testing the extruding properties, a sample of the obtained plate was cut into small cubes (about 0.2×0.2×0.2 cm³), which were transferred to an extruder. The sample was extruded at 200° C., it did not melt, the material blocked the extruder. When the extrusion chamber was opened the material was reobtained as crumbly solid.

### Example 2: Preparation of a Covalent Adaptable Network (CAN) Poly(Urea-Urethane) Polymer According to the Present Invention and Recyclability Testing Thereof

30.0 g of the prepolymer 2 obtained according to Ref. Ex. 2 (7.50% NCO) and 8.43 g DIB-MDA (25.5 mmol) were added (molar ratio NCO:NH 1.00:1.00 to 1.05:1.00), and the mixture was stirred in a speedmixer at 2000 rpm for 20 seconds. The mixture was casted into a silicon rubber mold lined with separating foil and cured for 90 min at 105° C. in a drying oven. The material was obtained as a yellow opaque solid plate. The characteristics of the obtained material are noted in Tables 1 & 2.

Recyclability testing (melting). A sample of the obtained plate was cut into small cubes (about 0.2×0.2×0.2 cm³), which were transferred to a hot press. The sample was pressed applying 880 kPa pressure for at least 5 minutes (20 kN of force applied in a circular press having a diameter of 17 cm according to the melting point analytical method above). The sample started to melt around 100° C. and formed a thin foil after cooling down.

Conclusion: Contrary to Comp. Ex. 2, the product obtained according to the present invention is able to melt and permits to form a thin foil—it is recyclable.

Recyclability testing (extruding). For testing the extruding properties, a sample of the obtained plate was cut into small cubes (about 0.2×0.2×0.2 cm³), which were transferred to an extruder. The sample was extruded at 180° C. At this temperature the sample was able to be extruded as a homogeneous, flowable paste with a maximum torque of 2.2 kNm.

Conclusion: Contrary to Comp. Ex. 2, the product obtained according to the present invention is able to be extruded and permits to form an homogeneous paste—it is recyclable.

### Comparative Example 3: Preparation of a Poly(Urea-Urethane) Polymer According to the Prior Art

60.0 g of the prepolymer 1a obtained according to Ref. Ex. 1A (7.43% NCO) and 14.15 g Polyol 2 (functionality=3, Mₙ=400 g/mol, hydroxyl value=400 mgKOH/g) were added (molar ratio NCO:OH was 1.05:1.00) and the mixture was stirred in a speedmixer at 2000 rpm for 20 seconds. The mixture was casted into a silicon rubber mold lined with separating foil and cured for 90 min at 105° C. in a drying oven. The material was obtained as a yellowish transparent solid plate. The characteristics of the obtained material are noted in Tables 1 & 2.

Recyclability testing (melting). A sample of the obtained plate was cut into small cubes (about 0.2×0.2×0.2 cm³), which were transferred to a hot press. The sample was pressed applying 880 kPa pressure for at least 5 minutes (20 kN of force applied in a circular press having a diameter of 17 cm according to the melting point analytical method above). The sample did not melt up to a temperature of 180° C.

### Example 3: Preparation of a Covalent Adaptable Network (CAN) Poly(Urea-Urethane) Polymer According to the Present Invention

60.0 g of the prepolymer 1a obtained according to Ref. Ex. 1A (7.50% NCO) and 21.1 g of DIB-polyetheramine T403 (sec-butyl-modified polyetheramine T403, functionality=3, Mₙ=600 g/mol, amine value=270 mgKOH/g) prepared as described in Ref. Ex. 3 were added (molar ratio NCO:NH was 1.05:1.00), and the mixture was stirred in a speedmixer at 2000 rpm for 20 seconds. The mixture was casted into a silicon rubber mold lined with separating foil and cured for 90 min at 105° C. in a drying oven. The material was obtained as a yellow opaque solid. The characteristics of the obtained material are noted in Tables 1 & 2.

Recyclability testing (melting). A sample of the obtained plate was cut into small cubes (about 0.2×0.2×0.2 cm³), which were transferred to a hot press. The sample was pressed applying 880 kPa pressure for at least 5 minutes (20 kN of force applied in a circular press having a diameter of 17 cm according to the melting point analytical method above). The sample started to melt around 100° C. and formed a thin foil after cooling down.

Conclusion: Contrary to Comp. Ex. 3, the product obtained according to the present invention is able to melt and permits to form a thin foil—it is recyclable.

TABLE 2
Properties/Recyclability of prepared materials

| | | | | | | | Melting @ |
|---|---|---|---|---|---|---|---|
| | | | | | | DSC | 880 kPa, |
| | Prepolymer | | Chain | | TGA −5% | exothermic | 5 min |
| | Polyol / | S (Standard)/ | Extender / | Polymer | mass | peak | (Yes at |
| Example | Isocyanate | CAN /CAS | Cross-linker | Type | [° C.] | [° C./J/g] | T° C./No) |
| 1A | polyTHF | Comparative: S | BDO | TP | >300 | 195/2.22 | Yes, |
| | (f = 2)/ | | (f = 2) | | | | 110° C. |
| | mMDI | Inventive: CAS | DIB-MDA | | 289 | 186/14.75 | Yes, |
| | (f = 2) | | (f = 2) | | | | 70° C. |
| 1B | polyTHF | Comparative: S | BDO | TP | 297 | 209/2.83 | already |
| | (f = 2)/ | | (f = 2) | | | | liquid |
| | TDI | Inventive: CAS | DIB-MDA | | 272 | 160/15.87 | already |
| | (f = 2) | | (f = 2) | | | | liquid |
| 1C | polyTHF | S | BDO | TS | >300 | — | No |
| | (f = 2)/ | | (f = 2) | | | | |
| | pMDI | Inventive: CAN | DIB-MDA | | 292 | 215/3.27 | Yes, |
| | (f = 2-3) | | (f = 2) | | | | 160° C. |
| 1D | polyTHF | Comparative: S | BDO | TS | >300 | 178/3.48 | No |
| | (f = 2)/ | | (f = 2) | | | | |
| | mMDI:pMDI | Inventive: CAN | DIB-MDA | | 290 | 222/3.00 | Yes, |
| | (1:1) | | (f = 2) | | | | 140° C. |
| | (f = 2-3) | | | | | | |
| 2 | Polyol 1 | Comparative: S | BDO | TS | 316 | 180/4.51 | No |
| | (f = 3)/ | | (f = 2) | | | | |
| | mMDI | Inventive: CAN | DIB-MDA | | 287 | 197/6.34 | Yes, |
| | (f = 2) | | (f = 2) | | | | 100° C. |
| 3 | poly- | Comparative: S | Polyol 2 | TS | >300 | — | No |
| | THF2000 | | (f = 3) | | | | |
| | (f = 2)/ | Inventive: CAN | DIB- | | 293 | — | Yes, |
| | mMDI | | polyetheramine | | | | 100° C. |
| | (f = 2) | | T403 | | | | |
| | | | (f = 3) | | | | |

### Example 4: Preparation of a Composite According to the Present Invention Comprising Glass Fibers

30.0 g of the prepolymer 2 obtained according to Ref. Ex. 2 (6.87% NCO) were heated to 70° C., degassed and set under N₂. 7.26 g DIB-MDA (51.8 mmol) (molar ratio NCO:NH 1.05:1.00) were added. The mixture was stirred in a speedmixer at 2000 rpm for 20 seconds. Subsequently, 300 mg of single glass fibers as filling material were stirred in. The mixture was casted into a silicon rubber mold lined with separating foil and cured for 40 min at 105° C. in a drying oven. The material was obtained as a yellow opaque plate.

### Example 5: Mechanical Recycling

The material obtained from Example 4 was cut and pressed applying 880 kPa pressure for at least 5 minutes at 140° C. (20 kN of force applied in a circular press having a diameter of 17 cm according to the melting point analytical method above). As a result, a thin foil was obtained showing that the composite was mechanically recyclable.

### Example 6: Mechanical Recycling Test of a Composite According to the Present Invention

A sample of the obtained yellow opaque solid plate according to Example 2 was cut to small cubes (about 0.2×0.2×0.2 cm³), which were transferred to a hot press. The sample was pressed applying 880 kPa of pressure for at least 5 minutes at 140° C. to obtain thin foils (20 kN of force applied in a circular press having a diameter of 17 cm according to the melting point analytical method above). Single glass fibers were put between two foils and the construct was pressed applying 880 kPa of pressure for at least 5 minutes at 140° C. to obtain a composite in form of a thin foil (20 kN of force applied in a circular press having a diameter of 17 cm according to the melting point analytical method above).

Recycling testing: The obtained composite in the form of a thin foil was cut into pieces and the pieces pressed applying 880 kPa of pressure for at least 5 minutes at 140° C. (20 kN of force applied in a circular press having a diameter of 17 cm according to the melting point analytical method above). As a result, a thin foil was obtained showing that the composite was mechanically recyclable.

### Example 7: Chemical Recycling of a Composite According to the Present Invention

22.0 g of the composite according to Example 4 was immersed in 150 mL of dry toluene and heated to reflux under stirring. The material started to swell, before the resin was completely dissolved after 4 h. When the solution was cooled down, the mixture underwent a sol-gel transition that was reversible when heated again. Then, the dissolved gel was filtered hot, and the glass fibers were filtered off.

The filtrate was collected in a flask. The filtrate gelled and was dried under reduced pressure at elevated temperatures first at the rotation evaporator at 120° C. and 50 mbar, then in a vacuum oven at 80° C.

The resulting solid was pressed with 880 kPa of pressure for at least 5 minutes at 140° C. to obtain thin foils (20 kN of force applied in a circular press having a diameter of 17 cm according to the melting point analytical method above). Single glass fibers were put between two foils and the construct was pressed applying 880 kPa of pressure for at least 5 minutes at 140° C. to obtain a new composite from recycled polymer (20 kN of force applied in a circular press having a diameter of 17 cm according to the melting point analytical method above). The chemical recycling according to Example 7 is illustrated in FIG. 3.

### Example 8: Chemical Recycling in the Presence of an Amine

About 5 g of the bulk material (poly(urea urethane) polymer) obtained according to Example 2 were immersed in 50 mL of toluene. 2.6 g DIB-MDA (1 eq. in relation to reversible NCO bonds) were added to scavenge the open NCO-bonds that were formed by the thermal breaking of the urea bonds. After 16 h stirring under reflux the material was completely dissolved. The toluene was removed under reduced pressure for obtaining a mixture comprising an amine terminated pre-polymer as a viscous liquid that did not solidify. Said mixture was diluted with 1 mL of toluene and the amine terminated pre-polymer was precipitated by addition to 50 g of n-heptane in order to remove the excess of DIB-MDA. The amine terminated pre-polymer was separated from the solvent and therein dissolved DIB-MDA by decantation. The amine terminated pre-polymer was then dried yielding 4.51 g of amine (DIB-MDA) terminated pre-polymer with an amine number of 75.2 mg KOH/g.

Formation of a new poly(urea urethane) polymer (bulk material): This amine (DIB-MDA) terminated pre-polymer was reacted with the pre-polymer of Example 2 to obtain a recycled covalent adaptable network (CAN) poly(urea-urethane) polymer, which is the same material as the bulk material (poly(urea urethane) polymer) obtained according to Example 2.

### Example 9: Testing of the Polymers Obtained in Example 1A and Comparative Example 1A—Recycling Properties

The plates obtained according to Example 1A and Comparative Example 1A were cut to small cubes (about 0.2× 0.2× 0.2 cm³).
19.1 About 5 g of a sample of the material according to Example 1A were mixed with 50 mL toluene and heated under reflux for 16 h. The mixture was then cooled down. The CAS material according to Example 1A was dissolved completely in toluene, such that a homogeneous yellowish liquid mixture was obtained. After removal of the solvent, a transparent yellowish solid was obtained.
19.2 About 5 g of a sample of the material according to Comparative Example 1A were mixed with 50 mL toluene and heated under reflux for 16 h. The mixture was then cooled down. The material did not dissolve.

This example is illustrated in FIG. 1. It has thus been demonstrated by this example that contrary to a material of the prior art, the CAS material in accordance to the present invention is reversibly soluble in toluene allowing chemical recycling thereof.

### Example 10: Testing of the Polymers Obtained in Example 1A and Comparative Example 1A—Melting Behavior

The materials obtained in Example 1A and Comparative Example 1A were cut into small cubes (about 0.2×0.2×0.2 cm³), transferred to a hot press, and then subjected to compression molding in the hot press at 20 kN for 5 minutes at different temperatures, namely 80, 100 and 120° C. The obtained products are illustrated in FIG. 2.

With the material of Example 1A a foil was obtained already at 80° C. while at 80° C. and even 100° C. the material of the comparative example remained as white pieces. At 120° C., a fine white opaque plate was formed for the comparative example while a fine transparent foil was obtained for the inventive example. Thus, it is shown that the material according to the present invention melts at much lower temperatures compared to a common material.

### Example 11: Preparation of a Covalent Adaptable Network (CAN) Poly(Urea-Urethane) Polymer According to the Present Invention from an Aliphatic Diamine

60.0 g of Reference Example 2 (7.50% NCO) and 9.44 g DIB-butanediamine (N,N′-di-secbutyl-1,4-butanediamine) (47.1 mmol) were added (molar ratio NCO:NH 1.05:1.00), and the mix was stirred in a speedmixer at 2000 rpm for 20 seconds. The mix turned solid immediately and was cured at 105° C. for 1 h and at room temperature for 48 h to yield an off-white opaque material.

Recyclability testing (melting). A sample of the obtained plate was cut into small cubes (0.2×0.2×0.2 cm³), which were transferred to a hot press. The sample was pressed applying 880 kPa of pressure for at least 5 minutes (20 kN of force applied in a circular press having a diameter of 17 cm according to the melting point analytical method above). The sample started to melt around 100° C. and formed a circular shaped plate after cooling down.

Recyclability testing (solution, toluene). 2 g of the plate obtained from the melting test was cut into small cubes (0.2×0.2×0.2 cm³) and immersed into 20 mL of toluene. The mixture was heated to 110° C. for 24 h. The sample did not dissolve.

Recyclability testing (solution, DMI). 2 g of the obtained plate was cut into small cubes (0.2×0.2×0.2 cm³) and immersed into 20 mL of 1,3-dimethyl-2-imidazolidinone. The mixture was heated to 130° C. for 24 h. The sample dissolved completely to give a clear solution.

Higher temperatures are needed to recycle polymers comprising aliphatic amines according to the invention by means of dissolving in an organic solvent.

### Reference Example 4: Preparation of a Prepolymer

20 g of 4,4′-methylene-bis-(phenylisocyanate) (MDI, functionality of 2) (0.080 mol) and 20 g Lupranat M20 FB (pMDI, functionality of about 2.5) (0.06 mol) were immersed in a flask, put under N₂. The mixture was heated, when the MDI was melted, 0.02 g benzoylchloride (141 μmol) was added. 82.6 g Polytetrahydrofuran (polyTHF) (f=2, Mₙ=2000 g/mol, #OH=55 mgKOH/g) were melted and added slowly at 80° C. to the MDI/pMDI mixture. The reaction was terminated by cooling when the NCO value reached <8% (molar ratio NCO:OH is about 1:0.3). The prepolymer was obtained as a yellow clear liquid.

### Example 12: Preparation of a Covalent Adaptable Network (CAN) Poly(Urea-Urethane) Polymer According to the Present Invention from N-(2-Hydroxyethyl) Aniline

15.0 g of the prepolymer according to Reference Example 4 (7.3% NCO) and 1.70 g N-(2-Hydroxyethyl) aniline (12.4 mmol) were added (molar ratio NCO:XH 1.05:1.00, X=total sum of O and N), and the mixture was stirred in a speedmixer at 2000 rpm for 20 seconds.

The mixture was casted into a silicon rubber mold lined with separating foil and cured for 90 min at 105° C. in a drying oven. The material was obtained as a yellow opaque solid plate.

Recyclability testing (melting). A sample of the obtained plate was cut into small cubes (0.2×0.2×0.2 cm³), which were transferred to a hot press. The sample was pressed applying 880 kPa of pressure for at least 5 minutes (20 kN of force applied in a circular press having a diameter of 17 cm according to the melting point analytical method above). The sample started to melt around 180° C. and formed a cookie shaped plate after cooling down.

Recyclability testing (solution, toluene): 3 g of the obtained plate was cut into small cubes (0.2×0.2×0.2 cm³) and immersed into 13 mL of toluene. 1 g of N-butylamine was added to scavenge the open NCO bonds. The mixture was heated to 110° C. The sample dissolved completely, but gave a turbid solution.

Recyclability testing (solution, DMI). 3 g of the obtained plate was cut into small cubes (0.2×0.2×0.2 cm³) and immersed into 30 mL of 1,3-Dimethyl-2-imidazolidinon. 1 g of N-butylamine was added to scavenge the open NCO bonds. The mixture was heated to 120° C. The sample dissolved completely after 1 h to give a clear solution.

### Example 13: Preparation of a Covalent Adaptable Network (CAN) Poly(Urea-Urethane) Polymer According to the Present Invention from 2-(Ethylamino) Ethanol

15.0 g of the prepolymer according to Reference Example 4 (7.3% NCO) and 1.10 g 2-(ethylamino) ethanol (12.8 mmol) were added (molar ratio NCO:XH 1.05:1.00, X=total sum of O and N), and the mixture was stirred in a speedmixer at 2000 rpm for 20 seconds. The mixture was casted into a silicon rubber mold lined with separating foil and cured for 90 min at 105° C. in a drying oven. The material was obtained as a yellow opaque solid plate.

Recyclability testing (melting). A sample of the obtained plate was cut into small cubes (0.2×0.2×0.2 cm³), which were transferred to a hot press. The sample was pressed applying 880 kPa of pressure for at least 5 minutes (20 kN of force applied in a circular press having a diameter of 17 cm according to the melting point analytical method above). The sample started to melt around 150° C. and formed a cookie shaped plate after cooling down.

Recyclability testing (solution, toluene): 3 g of the obtained plate was cut into small cubes (0.2×0.2×0.2 cm³) and immersed into 13 mL of toluene. 1 g of N-butylamine was added to scavenge the open NCO bonds. The mixture was heated to 110° C. The sample did not dissolve, but swelled.

Recyclability testing (solution, DMI). 3 g of the obtained plate was cut into small cubes (0.2×0.2×0.2 cm³) and immersed into 30 mL of 1,3-dimethyl-2-imidazolidinon. 1 g of N-butylamine was added to scavenge the open NCO bonds. The mixture was heated to 120° C. The sample dissolved completely after 4 h to give a clear solution.

### Comparative Example 14: Preparation of a Covalent Adaptable Network (CAN) Poly(Urea-Urethane) Polymer from 1,4-Butanediol

15.0 g of the prepolymer according to Reference Example 4 (7.3% NCO) and 1.12 g 1,4-butanediol (12.4 mmol) were added (molar ratio NCO:XH 1.05:1.00, X=0), and the mixture was stirred in a speedmixer at 2000 rpm for 20 seconds. The mixture was casted into a silicon rubber mold lined with separating foil and cured for 90 min at 105° C. in a drying oven. The material was obtained as a yellow opaque solid plate.

Recyclability testing (melting). A sample of the obtained plate was cut into small cubes (about 0.2×0.2×0.2 cm³), which were transferred to a hot press. The sample was pressed applying 880 kPa of pressure for at least 5 minutes (20 kN of force applied in a circular press having a diameter of 17 cm according to the melting point analytical method above). The sample did not melt up to a temperature of 180° C.

Recyclability testing (solution, toluene): 3 g of the obtained plate was cut into small cubes (0.2×0.2×0.2 cm³) and immersed into 13 mL of toluene. 1 g of N-butylamine was added to scavenge the open NCO bonds. The mixture was heated to 110° C. The sample did not dissolve.

Recyclability testing (solution, DMI). 1 g of the obtained plate was cut into small cubes (0.2×0.2×0.2 cm³) and immersed into 10 mL of 1,3-dimethyl-2-imidazolidinone. 0.33 g of N-butylamine was added to scavenge the open NCO bonds. The mixture was heated to 120° C. The sample did not dissolve after 7 h, the sample swelled in the solvent.

### Comparative Example 15: Preparation According to WO2022189242

16.5 g pMDI was dissolved in THF and cooled down to 0° C. A DIB-MDA (20.23 g) in THF was dropped into the pMDI/THE solution under stirring. The reaction mixture was stirred for 1 h at 0° C. and then slowly heated to reflux for 6 h. The solvent was removed, and the sample was cured at 140° C. for 24 h. The product 15a was obtained as a yellow solid.

Recyclability testing (solution, toluene). 3 g of the solid 15a was cut into small cubes (0.2×0.2×0.2 cm³) and immersed into 30 mL of toluene. The mixture was heated to 110° C. for 4 h. The sample did not dissolve.

3 g of the plate 15a were immersed into 30 mL of toluene and 0.9 g of 1,4-butandiol was added (2.00 eq of OH butanediol/eq HUBs in plate). The mixture was stirred under reflux for 24 h. After this time the substance was swollen, but not dissolved.

3 g of 15a were cut to pieces and immersed into a small amount of toluene (5 mL), 0.4 g of diisopropylamine were added. The mixture was heated for 8 h under reflux. The cubes dissolved and a yellow liquid was obtained.

3 g of the plate 15a were immersed into 30 mL of toluene and 0.4 g of DIB-MDA was added (0.25 eq of SHA DIB-MDA/eq HUBs in plate). The mixture was stirred under reflux overnight. When cooled down the mixture did not gel. When the solvent was removed a sticky liquid was obtained that was still soluble in THF.

### BRIEF DESCRIPTION OF THE FIGURES

FIG. 1 shows the different steps relative to the testing of the recycling properties of the plates obtained in Comp. Example 1A and Example 1A. 1. Shredding/cutting; 2. Addition of toluene; 3. Heating for 16 h, followed by cooling down; 4. Removal of toluene.

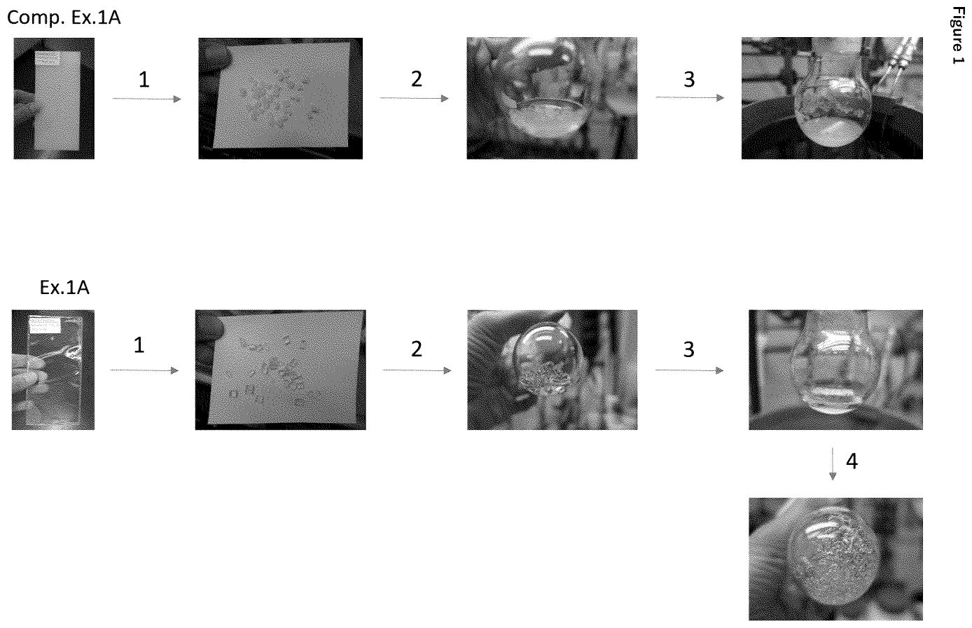

FIG. 2 shows the results of the test after compression molding at different temperatures for Example 1A and Comparative Example 1A. The arrows shows that only small pieces are obtained at 80 and 100° C. for the Comparative Example suggesting no melting at these temperatures while a foil is obtained already at 80° C. with the material of Example 1A.

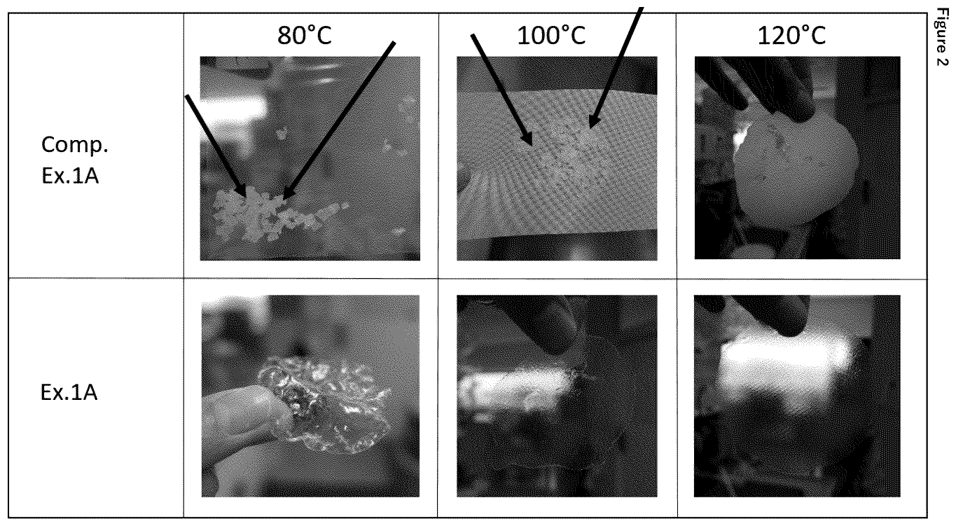

FIG. 3 shows the different steps relative to the testing of the recycling properties of the plates obtained in Comp. Example 2 and Example 2. 1. Shredding/cutting; 2. Addition of toluene; Heating for 16 h, followed by cooling down;

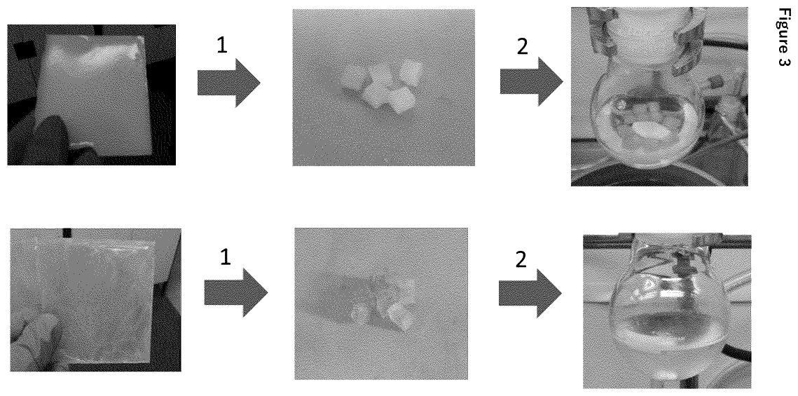

FIG. 4 shows the results of the test after compression molding at different temperatures for Example 2 and Comparative Example 2. Comparative Example 2 does not melt at all up to temperatures of 180° C., whereas Example 2 melts at around 130° C.

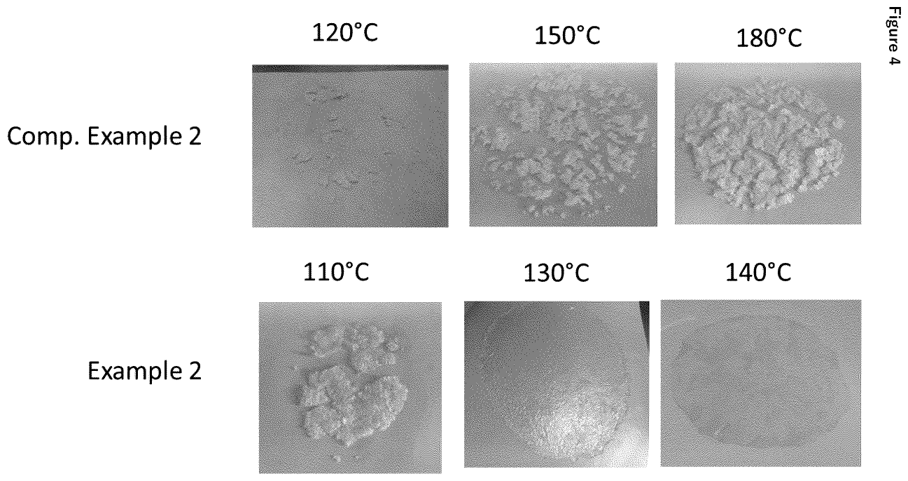

FIG. 5 shows the different steps relative to the testing of the recycling properties of the composite of Example 4. 1. Addition of toluene to pieces of the composite of Example 4, heating under reflux for 16 h 2. Hot filtration; a: separated glass fibers, b: the filtrate gelled and was dried; 3.: b was pressed at 880 kPa for 5 min at 140° C. (20 kN of force applied in a circular press having a diameter of 17 cm according to the melting point analytical method above) to obtain a thin foil, 4. Recycled composite with glass fibers obtained by pressing glass fibers in between two foils.

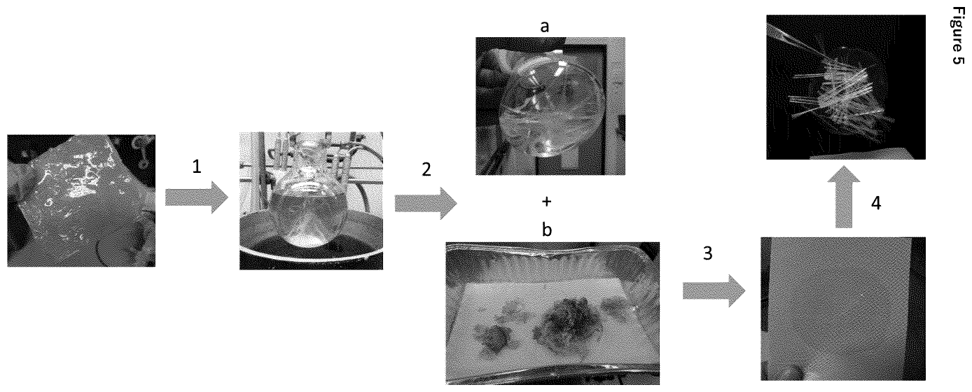

### CITED LITERATURE

Kunststoffhandbuch [Plastics handbook], volume 7, Polyurethane [Polyurethanes]”, Carl Hanser Verlag, 3rd edition 1993, chapter 3.1, 3.2 and 3.3.2
Ullmann's Encyclopedia of Industrial Chemistry], 4th edition, volume 19, pp. 62 to 65 WO 2006/040159 A1

1.-17. (canceled)

18. A poly(urea-urethane) polymer obtained by a process comprising:
reacting the following components
(i) at least one isocyanate;
(ii) at least one polyol; and
(iii) at least one secondary amine having the following formula (I) 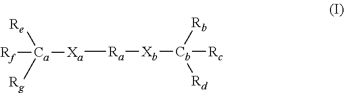
wherein —Rₐ— is selected from the group consisting of —Z₁—, —Z₂—, —Z₃—, —Z₄—, —Z₅—, —Z₆—, —Z₇—, —Z₇—, —Z₈—, —Z₉—, —Z₁₀—, —Z₁₁—, —Z₁₃—, —Z₁—Z₅—, —Z₅—Z₁—Z₅—, —Z₁—Z₆—, —Z₁—Z₇—, —Z₁—Z₈—, —Z₁—Z₉—, —Z₉—Z₁—Z₉—, —Z₁—Z₁₀—, —Z₃—Z₅—, —Z₃—Z₆—, —Z₃—Z₇—, —Z₃—Z₈—, —Z₃—Z₉—, —Z₃—Z₁₀—, —Z₁—Z₅—Z₁—, —Z₁—Z₉—Z₁—, —Z₉—Z₁(—Z₁₁—Z₁)ₙ—Z₉—, with n=1, 2, 3, 4, 5, or 6, and —Z₁—Z₁₂—Z₁—;
wherein
—Z₁— is a substituted or unsubstituted, linear or branched C₁-C₃₀ alkylene;
—Z₂— is a substituted or unsubstituted, linear or branched 2- to 300,000-membered heteroalkylene;
—Z₃— is a substituted or unsubstituted, linear or branched C₂-C₃₀ alkenylene;
—Z₄— is a substituted or unsubstituted, linear or branched 3- to 30-membered heteroalkenylene;
—Z₅— is a substituted or unsubstituted C₅-C₃₀ cycloalkylene;
—Z₆— is a substituted or unsubstituted 5- to 30-membered heterocycloalkylene;
—Z₇— is a substituted or unsubstituted C₅-C₃₀ cycloalkenylene;
—Z₈— is a substituted or unsubstituted 5- to 30-membered heterocycloalkenylen;
—Z₉— is a substituted or unsubstituted C₆-C₃₀ arylene;
—Z₁₀— is a substituted or unsubstituted 5- to 30-membered heteroarylene;
—Z₁₁— is a C₆-C₃₀ arylene substituted with —NHR or —OR, wherein R is selected from the group consisting of H and substituted or unsubstituted, linear or branched C₁-C₁₀ alkyl;
—Z₁₂— is —N(R_{f})—;
—Z₁₃— is a substituted or unsubstituted 5- to 30-membered heterocycloalkylene, wherein at least one of the one or more heteroatoms of Z₁₃ is from Xₐ;
wherein Cₐ is a C atom or a H atom and C_{b} is a C atom or a H atom, wherein at least one of Cₐ and C_{b} is a C atom;
wherein Xₐ is a O atom or NH and X_{b} is a O atom or NH, wherein at least one of Xₐ and X_{b} is NH, with the condition that for Xₐ or X_{b} being NH, the respective Cₐ or C_{b} is/are C atom(s);
wherein
(A) R_{c}, R_{d}, R_{f} and R_{g} independently of each other are selected from the group consisting of hydrogen, linear or branched, substituted or unsubstituted C₁-C₃₀ alkyl, linear or branched, substituted or unsubstituted C₂-C₃₀ alkenyl, substituted or unsubstituted, linear or branched 2- to 30-membered heteroalkyl, substituted or unsubstituted, linear or branched 3- to 30-membered heteroalkenyl, substituted or unsubstituted C₅-C₃₀ cycloalkyl, substituted or unsubstituted C₅-C₃₀ cycloalkenyl, substituted or unsubstituted 5- to 30-membered heterocycloalkyl, substituted or unsubstituted 5- to 30-membered heterocycloalkenyl, substituted or unsubstituted C₆-C₃₀ aryl, substituted or unsubstituted 5- to 30-membered heteroaryl, substituted or unsubstituted C₁-C₁₀ alkylene C₅-C₃₀ cycloalkyl, substituted or unsubstituted C₁-C₁₀ alkylene C₅-C₃₀ cycloalkenyl, substituted or unsubstituted C₁-C₁₀ alkylene 5- to 30-membered heterocycloalkyl, substituted or unsubstituted C₁-C₁₀ alkylene 5- to 30-membered heterocycloalkenyl, substituted or unsubstituted C₁-C₁₀ alkylene C₆-C₃₀ aryl and substituted or unsubstituted C₁-C₁₀ alkylene 5- to 30-membered heteroaryl,
R_{b} and Rₑ independently of each other are defined as R_{c}, Rₐ, R_{f} and R_{g}; or
R_{b} and Rₑ are none, and Cₐ and C_{b} are connected to each other via a single bond forming a heterocycle consisting of Cₐ, C_{b}, Xₐ, X_{b} and Rₐ, or
(B) Cₐ and Rₑ form a substituted or unsubstituted C₆-C₃₀ arylene, and both R_{f} and R_{g} are none; and
C_{b} and R_{b} form a substituted or unsubstituted C₆-C₃₀ arylene, and both R_{c} and R_{d} are none; or
(C) —Cₐ and Rₑ form a substituted or unsubstituted C₆-C₃₀ arylene, and both R_{f} and R_{g} are none; or
—C_{b} and R_{b} form a substituted or unsubstituted C₆-C₃₀ arylene, and both R_{c} and R_{d} are none;
wherein, when Cₐ and Rₑ form a substituted or unsubstituted C₆-C₃₀ arylene, R_{b}, R_{c} and Rₐ independently of each other are defined as any one of R_{c}, R_{d}, R_{f} and R_{g} under (A);
wherein, when C_{b} and R_{b} form a substituted or unsubstituted C₆-C₃₀ arylene, Rₑ, R_{f} and R_{g} independently of each other are defined as any one of R_{c}, Rₐ, R_{f} and R_{g} under (A).

19. The poly(urea-urethane) polymer of claim 18, wherein Xₐ is NH, X_{b} is NH, the secondary amine (iii) having the following formula (II) 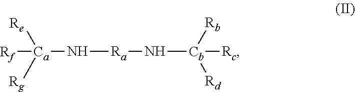
wherein Cₐ, C_{b}, R_{b}, R_{c}, Rₐ, Rₑ, R_{f}, R_{g}, and —Rₐ— are as defined in formula (I).

20. The poly(urea-urethane) polymer of claim 18, wherein —Rₐ— is selected from the group consisting of —Z₁—, —Z₂—, —Z₅—, —Z₉—, —Z₁₀—, —Z₁—Z₅—, —Z₅—Z₁—Z₅—, —Z₉—Z₁—Z₉—, —Z₁—Z₅—Z₁—, —Z₁—Z₉—Z₁—, and —Z₉—Z₁(—Z₁₁—Z₁)ₙ—Z₉—, wherein n=1, 2, 3, 4, 5, or 6.

21. The poly(urea-urethane) polymer of claim 18, wherein R_{c}, Rₐ, R_{f} and R_{g} independently of each other are selected from the group consisting of hydrogen, methyl, ethyl, propyl, iso-propyl, butyl, pentyl, hexyl, octyl, dodecyl, sec-butyl, tert-butyl, sec-isopentyl, 2-pentyl, 2-methyl-4-pentyl, 3-pentyl, 2-methyl-pentyl, 2,6-dimethyl-4-heptyl, 3-pinanyl-methyl, cyclopentyl, cyclohexyl, dicyclohexylmethyl, cyclohexylmethyl, cyclododecyl, phenyl, benzyl, cyclohexyl(phenyl)methyl, and —C(OH) H—Rₖ,
wherein Rₖ is selected from the group consisting of hydrogen, linear or branched, substituted or unsubstituted C₁-C₃₀ alkyl, linear or branched, substituted or unsubstituted C₂-C₃₀ alkenyl, substituted or unsubstituted, linear or branched 2- to 30-membered heteroalkyl, substituted or unsubstituted, linear or branched 3- to 30-membered heteroalkenyl, substituted or unsubstituted C₅-C₃₀ cycloalkyl, substituted or unsubstituted C₅-C₃₀ cycloalkenyl, substituted or unsubstituted 5- to 30-membered heterocycloalkyl, substituted or unsubstituted 5- to 30-membered heterocycloalkenyl, substituted or unsubstituted C₆-C₃₀ aryl, substituted or unsubstituted 5- to 30-membered heteroaryl, substituted or unsubstituted C₁-C₁₀ alkylene C₅-C₃₀ cycloalkyl, substituted or unsubstituted C₁-C₁₀ alkylene C₅-C₃₀ cycloalkenyl, substituted or unsubstituted C₁-C₁₀ alkylene 5- to 30-membered heterocycloalkyl, substituted or unsubstituted C₁-C₁₀ alkylene 5- to 30-membered heterocycloalkenyl, substituted or unsubstituted C₁-C₁₀ alkylene C₆-C₃₀ aryl and substituted or unsubstituted C₁-C₁₀ alkylene 5- to 30-membered heteroaryl.

22. The poly(urea-urethane) polymer of claim 18, wherein R_{b} and Rₑ independently of each other are selected from the group consisting of hydrogen, methyl, ethyl, propyl, iso-propyl, butyl, pentyl, hexyl, octyl, dodecyl, sec-butyl, tert-butyl, sec-isopentyl, 2-pentyl, 2-methyl-4-pentyl, 3-pentyl, 2-methyl-pentyl, 2,6-dimethyl-4-heptyl, 3-pinanyl-methyl, cyclopentyl, cyclohexyl, dicyclohexylmethyl, cyclohexylmethyl, cyclododecyl, phenyl, benzyl, and cyclohexyl(phenyl)methyl.

23. The poly(urea-urethane) polymer of claim 18, wherein any one of R_{b}, R_{c}, and R_{d} is H, and any one of Rₑ, R_{f}, and R_{g} is H;
wherein one of R_{b}, R_{c}, and Rₐ other than the one being H is CH₃, and one of Rₑ, R_{f}, and R_{g} other than the one being H is CH₃.

24. The poly(urea-urethane) polymer of claim 18, wherein any one of R_{b}, R_{c}, and R_{d} is an ethyl group, and any one of Rₑ, R_{f}, and R_{g} is an ethyl group.

25. The poly(urea-urethane) polymer of claim 18, wherein the at least one secondary amine (iii) is 4,4′-Methylenebis(N-sec-butylaniline) (DIB-MDA).

26. The poly(urea-urethane) polymer of claim 18, wherein the at least one secondary amine (iii) is DIB-butanediamine (N,N′-di-sec-butyl-1,4-butanediamine).

27. The poly(urea-urethane) polymer of claim 18, wherein the at least one secondary amine (iii) is a sec-butyl-modified polyether amine, with the following formula CH₃—CH₂—CH(CH₃)NH—[CH(CH₃)—CH₂—O]ₘ₁—CH₂—C(Rₓ₁)(R_{y1})—CH₂—[O—CH₂—CH(CH₃)]ₒ₁—NH—CH(CH₃)—CH₂—CH₃, wherein Rₓ₁ is —CH₂—CH₃ and R_{y1} is —CH₂—[O—CH₂—CH(CH₃)]ₙ₁—NH—CH(CH₃)—CH₂—CH₃, wherein m1+n1+o1 is in the range of 5 to 6.

28. The poly(urea-urethane) polymer of claim 18, wherein the at least one isocyanate (i) is selected from the group consisting of monomeric methylene diphenylene diisocyanate (mMDI), polymethylene polyphenylene polyisocyanate (pMDI), a mixture of monomeric methylene diphenylene diisocyanate and polymethylene polyphenylene polyisocyanate (MDI), tolylene diisocyanate (TDI), isomers of xylylene diisocyanate (XDI), isomers of diisocyanatobenzene, xylene 2,6-diisocyanate, naphthylene 1,5-diisocyanate (1,5-NDI), butane 1,4-diisocyanate, pentane 1,5-diisocyanate (PDI), hexane 1,6-diisocyanate (HDI), octane 1,8-diisocyanate, nonane 1,9-diisocyanate, decane 1,10-diisocyanate, 2,2-dimethylpentane 1,5-diisocyanate, 2-methylpentane 1,5-diisocyanate (MPDI), 2,4,4 (or 2,2,4)-trimethylhexane 1,6-diisocyanate (TMDI), cyclohexane 1,3- and 1,4-diisocyanate, 1-isocyanato-3,3,5-trimethyl-5-isocyanatomethylcyclohexane (IPDI), methylene-bis(cyclohexyl isocyanate) (H₁₂MDI), 2,4- or 2,6-diisocyanato-1-methylcyclohexane (H₆TDI), 1-isocyanato-1-methyl-4 (3)isocyanatomethylcyclohexane (AMCI), 1,3-bis(isocyanatomethyl)cyclohexane, 1,4-bis(isocyanatomethyl)cyclohexane, bis(isocyanatomethyl) norbornane (NBDI), triphenylmethane-4,4′,4″-triisocyanate, toluene-2,4,6-triyl triisocyanate, ethyl ester 1-lysine triisocyanate, triisocyanatocyclohexane, tris(isocyanatomethyl)cyclohexane, triisocyanatomethylcyclohexane, 1,8-diisocyanato-4-(isocyanatomethyl) octane, undecane 1,6,11-triisocyanate, 1,7-diisocyanato-4-(3-isocyanatopropyl) heptane, 1,6-diisocyanato-3-(isocyanatomethyl) hexane, 2,2-bis[[4-(isocyanatomethyl)phenyl]methyl]butyl n-[[4-(isocyanatomethyl)phenyl]methyl]carbamate, (2,4,6-trioxotriazine-1,3,5 (2h,4h,6h)triyl)tris(hexamethylene) isocyanate, 1,3,5-triisocyanatobenzene, tris(isocyanatohexyl) biuret, 3,3′,3″-[(1h,3h,5h)-2,4,6-trioxo-1,3,5-triazine-1,3,5-triyltris(methylene)]tris[3,5,5-trimethylcyclohexyl]triisocyanate, 1,3,5-triazine-2,4,6-triisocyanate, 2,4,4′-triisocyanato-dicyclohexylmethane, triisocyanate triphenylthiophosphate, 2,4,4′-diphenylethertriisocyanate, 1,3-Bis(3-isocyanato-4-methylphenyl)-1,3-diazetidine-2,4-dione, and a mixture of two or more thereof.

29. The poly(urea-urethane) polymer of claim 18, wherein the at least one polyol (i) is selected from the group consisting of polyester polyol, polyetherester polyol, polycarbonate polyol, polyacrylate polyol, polyolefine polyol, polyether polyol, and a mixture of two or more thereof.

30. A poly(urea-urethane) polymer-based composite obtained by a process comprising
reacting the following components
(i) at least one isocyanate;
(ii) at least one polyol; and
(iii) at least one secondary amine having the following formula (I) 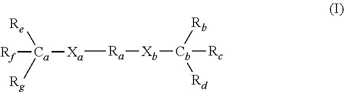
wherein —Rₐ— is selected from the group consisting of —Z₁—, —Z₂—, —Z₃—, —Z₄—, —Z₅—, —Z₆—, —Z₇—, —Z₇—, —Z₈—, —Z₉—, —Z₁₀—, —Z₁₁—, —Z₁₃—, —Z₁—Z₅—, —Z₅—Z₁—Z₅—, —Z₁—Z₆—, —Z₁—Z₇—, —Z₁—Z₈—, —Z₁—Z₉—, —Z₉—Z₁—Z₉—, —Z₁—Z₁₀—, —Z₃—Z₅—, —Z₃—Z₆—, —Z₃—Z₇—, —Z₃—Z₈—, —Z₃—Z₉—, —Z₃—Z₁₀—, —Z₁—Z₅—Z₁—, —Z₁—Z₉—Z₁—, —Z₉—Z₁(—Z₁₁—Z₁)ₙ—Z₉—, with n=1, 2, 3, 4, 5, or 6, and —Z₁—Z₁₂—Z₁—; wherein
—Z₁— is a substituted or unsubstituted, linear or branched C₁-C₃₀ alkylene;
—Z₂— is a substituted or unsubstituted, linear or branched 2- to 300,000-membered heteroalkylene;
—Z₃— is a substituted or unsubstituted, linear or branched C₂-C₃₀ alkenylene;
—Z₄— is a substituted or unsubstituted, linear or branched 3- to 30-membered heteroalkenylene;
—Z₅— is a substituted or unsubstituted C₅-C₃₀ cycloalkylene;
—Z₆— is a substituted or unsubstituted 5- to 30-membered heterocycloalkylene;
—Z₇— is a substituted or unsubstituted C₅-C₃₀ cycloalkenylene;
—Z₈— is a substituted or unsubstituted 5- to 30-membered heterocycloalkenylen;
—Z₉— is a substituted or unsubstituted C₆-C₃₀ arylene;
—Z₁₀— is a substituted or unsubstituted 5- to 30-membered heteroarylene;
—Z₁₁— is a C₆-C₃₀ arylene substituted with —NHR or —OR, wherein R is selected from the group consisting of H and substituted or unsubstituted, linear or branched C₁-C₁₀ alkyl;
—Z₁₂— is —N(R_{f})—;
—Z₁₃— is a substituted or unsubstituted 5- to 30-membered heterocycloalkylene, wherein at least one of the one or more heteroatoms of Z₁₃ is from Xₐ;
wherein Cₐ is a C atom or a H atom and C_{b} is a C atom or a H atom, wherein at least one of Cₐ and C_{b} is a C atom;
wherein Xₐ is a O atom or NH and X_{b} is a O atom or NH, wherein at least one of Xₐ and X_{b} is NH, with the condition that for Xₐ and/or X_{b} being NH, the respective Cₐ and/or C_{b} is/are C atom(s);
wherein
(A) R_{c}, R_{d}, R_{f} and R_{g} independently of each other are selected from the group consisting of hydrogen, linear or branched, substituted or unsubstituted C₁-C₃₀ alkyl, linear or branched, substituted or unsubstituted C₂-C₃₀ alkenyl, substituted or unsubstituted, linear or branched 2- to 30-membered heteroalkyl, substituted or unsubstituted, linear or branched 3- to 30-membered heteroalkenyl, substituted or unsubstituted C₅-C₃₀ cycloalkyl, substituted or unsubstituted C₅-C₃₀ cycloalkenyl, substituted or unsubstituted 5- to 30-membered heterocycloalkyl, substituted or unsubstituted 5- to 30-membered heterocycloalkenyl, substituted or unsubstituted C₆-C₃₀ aryl, substituted or unsubstituted 5- to 30-membered heteroaryl, substituted or unsubstituted C₁-C₁₀ alkylene C₅-C₃₀ cycloalkyl, substituted or unsubstituted C₁-C₁₀ alkylene C₅-C₃₀ cycloalkenyl, substituted or unsubstituted C₁-C₁₀ alkylene 5- to 30-membered heterocycloalkyl, substituted or unsubstituted C₁-C₁₀ alkylene 5- to 30-membered heterocycloalkenyl, substituted or unsubstituted C₁-C₁₀ alkylene C₆-C₃₀ aryl and substituted or unsubstituted C₁-C₁₀ alkylene 5- to 30-membered heteroaryl,
R_{b} and Rₑ independently of each other are defined as R_{c}, Rₐ, R_{f} and R_{g}; or
R_{b} and Rₑ are none, and Cₐ and C_{b} are connected to each other via a single bond forming a heterocycle consisting of Cₐ, C_{b}, Xₐ, X_{b} and Rₐ; or
(B) Cₐ and Rₑ form a substituted or unsubstituted C₆-C₃₀ arylene, and both R_{f} and R_{g} are none; and
C_{b} and R_{b} form a substituted or unsubstituted C₆-C₃₀ arylene, and both R_{c} and R_{d} are none; or
(C) —Cₐ and Rₑ form a substituted or unsubstituted C₆-C₃₀ arylene, and both R_{f} and R_{g} are none; or
—C_{b} and R_{b} form a substituted or unsubstituted C₆-C₃₀ arylene, and both R_{c} and R_{d} are none;
wherein, when Cₐ and Rₑ form a substituted or unsubstituted C₆-C₃₀ arylene, R_{b}, R_{c} and Rₐ independently of each other are defined as any one of R_{c}, R_{d}, R_{f} and R_{g} under (A);
wherein, when C_{b} and R_{b} form a substituted or unsubstituted C₆-C₃₀ arylene, Rₑ, R_{f} and R_{g} independently of each other are defined as any one of R_{c}, Rₐ, R_{f} and R_{g} under (A),
obtaining a mixture comprising a poly(urea-urethane) polymer,
bringing in contact the obtained mixture with (iv):
(iv) a filler, the filler being selected from the group consisting of glass fibers, carbon fibers, mineral fibers, textiles, metal meshs, metal fibers, metal rods, carbonates, wood, and a mixture of two or more thereof.

31. A process for preparing a poly(urea-urethane) polymer according to claim 18 comprising:
(a) reacting at least one isocyanate (i) with at least one polyol (ii), obtaining a pre-polymer; and
(b) bringing in contact the pre-polymer obtained in (a) with at least one secondary amine, the at least one secondary amine having the formula (I) as defined in claim 18, obtaining the poly(urea-urethane) polymer; or
(a′) reacting at least one isocyanate (i) with at least one secondary amine, the at least one secondary amine having the formula (I) as defined in claim 18, obtaining a pre-polymer; and
(b′) bringing in contact the pre-polymer obtained in (a′) with at least one polyol (ii), obtaining the poly(urea-urethane) polymer.

32. A recyclable material comprising a poly(urea-urethane) polymer obtained by a process comprising:
reacting the following components
(iv) at least one isocyanate;
(v) at least one polyol; and
(vi) at least one secondary amine having the following formula (I) 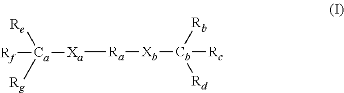
wherein —Rₐ— is selected from the group consisting of —Z₁—, —Z₂—, —Z₃—, —Z₄—, —Z₅—, —Z₆—, —Z₇—, —Z₇—, —Z₈—, —Z₉—, —Z₁₀—, —Z₁₁—, —Z₁₃—, —Z₁—Z₅—, —Z₅—Z₁—Z₅—, —Z₁—Z₆—, —Z₁—Z₇—, —Z₁—Z₈—, —Z₁—Z₉—, —Z₉—Z₁—Z₉—, —Z₁—Z₁₀—, —Z₃—Z₅—, —Z₃—Z₆—, —Z₃—Z₇—, —Z₃—Z₈—, —Z₃—Z₉—, —Z₃—Z₁₀—, —Z₁—Z₅—Z₁—, —Z₁—Z₉—Z₁—, —Z₉—Z₁(—Z₁₁—Z₁)ₙ—Z₉—, with n=1, 2, 3, 4, 5, or 6, and —Z₁—Z₁₂—Z₁—;
wherein
—Z₁— is a substituted or unsubstituted, linear or branched C₁-C₃₀ alkylene;
—Z₂— is a substituted or unsubstituted, linear or branched 2- to 300,000-membered heteroalkylene;
—Z₃— is a substituted or unsubstituted, linear or branched C₂-C₃₀ alkenylene;
—Z₄— is a substituted or unsubstituted, linear or branched 3- to 30-membered heteroalkenylene;
—Z₅— is a substituted or unsubstituted C₅-C₃₀ cycloalkylene;
—Z₆— is a substituted 1 or unsubstituted 5- to 30-membered heterocycloalkylene;
—Z₇— is a substituted or unsubstituted C₅-C₃₀ cycloalkenylene;
—Z₈— is a substituted or unsubstituted 5- to 30-membered heterocycloalkenylen;
—Z₉— is a substituted or unsubstituted C₆-C₃₀ arylene;
—Z₁₀— is a substituted or unsubstituted 5- to 30-membered heteroarylene;
—Z₁₁— is a C₆-C₃₀ arylene substituted with —NHR or —OR, wherein R is selected from the group consisting of H and substituted or unsubstituted, linear or branched C₁-C₁₀ alkyl;
—Z₁₂— is —N(R_{f})—;
—Z₁₃— is a substituted or unsubstituted 5- to 30-membered heterocycloalkylene, wherein at least one of the one or more heteroatoms of Z₁₃ is from Xₐ;
wherein Cₐ is a C atom or a H atom and C_{b} is a C atom or a H atom, wherein at least one of Cₐ and C_{b} is a C atom;
wherein Xₐ is a O atom or NH and X_{b} is a O atom or NH, wherein at least one of Xₐ and X_{b} is NH, with the condition that for Xₐ or X_{b} being NH, the respective Cₐ or C_{b} is/are C atom(s);
wherein
(D) R_{c}, R_{d}, R_{f} and R_{g} independently of each other are selected from the group consisting of hydrogen, linear or branched, substituted or unsubstituted C₁-C₃₀ alkyl, linear or branched, substituted or unsubstituted C₂-C₃₀ alkenyl, substituted or unsubstituted, linear or branched 2- to 30-membered heteroalkyl, substituted or unsubstituted, linear or branched 3- to 30-membered heteroalkenyl, substituted or unsubstituted C₅-C₃₀ cycloalkyl, substituted or unsubstituted C₅-C₃₀ cycloalkenyl, substituted or unsubstituted 5- to 30-membered heterocycloalkyl, substituted or unsubstituted 5- to 30-membered heterocycloalkenyl, substituted or unsubstituted C₆-C₃₀ aryl, substituted or unsubstituted 5- to 30-membered heteroaryl, substituted or unsubstituted C₁-C₁₀ alkylene C₅-C₃₀ cycloalkyl, substituted or unsubstituted C₁-C₁₀ alkylene C₅-C₃₀ cycloalkenyl, substituted or unsubstituted C₁-C₁₀ alkylene 5- to 30-membered heterocycloalkyl, substituted or unsubstituted C₁-C₁₀ alkylene 5- to 30-membered heterocycloalkenyl, substituted or unsubstituted C₁-C₁₀ alkylene C₆-C₃₀ aryl and substituted or unsubstituted C₁-C₁₀ alkylene 5- to 30-membered heteroaryl,
R_{b} and Rₑ independently of each other are defined as R_{c}, Rₐ, R_{f} and R_{g}; or
R_{b} and Rₑ are none, and Cₐ and C_{b} are connected to each other via a single bond forming a heterocycle consisting of Cₐ, C_{b}, Xₐ, X_{b} and Rₐ; or
(E) Cₐ and Rₑ form a substituted or unsubstituted C₆-C₃₀ arylene, and both R_{f} and R_{g} are none; and
C_{b} and R_{b} form a substituted or unsubstituted C₆-C₃₀ arylene, and both R_{c} and R_{d} are none; or
(F) —Cₐ and Rₑ form a substituted or unsubstituted C₆-C₃₀ arylene, and both R_{f} and R_{g} are none; or
—C_{b} and R_{b} form a substituted or unsubstituted C₆-C₃₀ arylene, and both R_{c} and R_{d} are none;
wherein, when Cₐ and Rₑ form a substituted or unsubstituted C₆-C₃₀ arylene, R_{b}, R_{c} and Rₐ independently of each other are defined as any one of R_{c}, R_{d}, R_{f} and R_{g} under (A);
wherein, when C_{b} and R_{b} form a substituted or unsubstituted C₆-C₃₀ arylene, Rₑ, R_{f} and R_{g} independently of each other are defined as any one of R_{c}, R_{d}, R_{f} and R_{g} under (A),
or the poly(urea-urethane) polymer composite according to claim 30.

33. A recyclable article comprising a poly(urea-urethane) polymer according to claim 18 or a poly(urea-urethane) polymer-based composite obtained by a process comprising
reacting the following components
(v) at least one isocyanate;
(vi) at least one polyol; and
(vii) at least one secondary amine having the following formula (I) 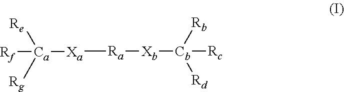
wherein —Rₐ— is selected from the group consisting of —Z₁—, —Z₂—, —Z₃—, —Z₄—, —Z₅—, —Z₆—, —Z₇—, —Z₇—, —Z₈—, —Z₉—, —Z₁₀—, —Z₁₁—, —Z₁₃—, —Z₁—Z₅—, —Z₅—Z₁—Z₅—, —Z₁—Z₆—, —Z₁—Z₇—, —Z₁—Z₈—, —Z₁—Z₉—, —Z₉—Z₁—Z₉—, —Z₁—Z₁₀—, —Z₃—Z₅—, —Z₃—Z₆—, —Z₃—Z₇—, —Z₃—Z₈—, —Z₃—Z₉—, —Z₃—Z₁₀—, —Z₁—Z₅—Z₁—, —Z₁—Z₉—Z₁—, —Z₉—Z₁(—Z₁₁—Z₁)ₙ—Z₉—, with n=1, 2, 3, 4, 5, or 6, and —Z₁—Z₁₂—Z₁—; wherein
—Z₁— is a substituted or unsubstituted, linear or branched C₁-C₃₀ alkylene;
—Z₂— is a substituted or unsubstituted, linear or branched 2- to 300,000-membered heteroalkylene;
—Z₃— is a substituted or unsubstituted, linear or branched C₂-C₃₀ alkenylene;
—Z₄— is a substituted or unsubstituted, linear or branched 3- to 30-membered heteroalkenylene;
—Z₅— is a substituted or unsubstituted C₅-C₃₀ cycloalkylene;
—Z₆— is a substituted or unsubstituted 5- to 30-membered heterocycloalkylene;
—Z₇— is a substituted or unsubstituted C₅-C₃₀ cycloalkenylene;
—Z₈— is a substituted or unsubstituted 5- to 30-membered heterocycloalkenylen;
—Z₉— is a substituted or unsubstituted C₆-C₃₀ arylene;
—Z₁₀— is a substituted or unsubstituted 5- to 30-membered heteroarylene;
—Z₁₁— is a C₆-C₃₀ arylene substituted with —NHR or —OR, wherein R is selected from the group consisting of H and substituted or unsubstituted, linear or branched C₁-C₁₀ alkyl;
—Z₁₂— is —N(R_{f})—;
—Z₁₃— is a substituted or unsubstituted 5- to 30-membered heterocycloalkylene, wherein at least one of the one or more heteroatoms of Z₁₃ is from Xₐ;
wherein Cₐ is a C atom or a H atom and C_{b} is a C atom or a H atom, wherein at least one of Cₐ and C_{b} is a C atom;
wherein Xₐ is a O atom or NH and X_{b} is a O atom or NH, wherein at least one of Xₐ and X_{b} is NH, with the condition that for Xₐ and/or X_{b} being NH, the respective Cₐ and/or C_{b} is/are C atom(s);
wherein
(D) R_{c}, Rₐ, R_{f} and R_{g} independently of each other are selected from the group consisting of hydrogen, linear or branched, substituted or unsubstituted C₁-C₃₀ alkyl, linear or branched, substituted or unsubstituted C₂-C₃₀ alkenyl, substituted or unsubstituted, linear or branched 2- to 30-membered heteroalkyl, substituted or unsubstituted, linear or branched 3- to 30-membered heteroalkenyl, substituted or unsubstituted C₅-C₃₀ cycloalkyl, substituted or unsubstituted C₅-C₃₀ cycloalkenyl, substituted or unsubstituted 5- to 30-membered heterocycloalkyl, substituted or unsubstituted 5- to 30-membered heterocycloalkenyl, substituted or unsubstituted C₆-C₃₀ aryl, substituted or unsubstituted 5- to 30-membered heteroaryl, substituted or unsubstituted C₁-C₁₀ alkylene C₅-C₃₀ cycloalkyl, substituted or unsubstituted C₁-C₁₀ alkylene C₅-C₃₀ cycloalkenyl, substituted or unsubstituted C₁-C₁₀ alkylene 5- to 30-membered heterocycloalkyl, substituted or unsubstituted C₁-C₁₀ alkylene 5- to 30-membered heterocycloalkenyl, substituted or unsubstituted C₁-C₁₀ alkylene C₆-C₃₀ aryl and substituted or unsubstituted C₁-C₁₀ alkylene 5- to 30-membered heteroaryl,
R_{b} and Rₑ independently of each other are defined as R_{c}, R_{d}, R_{f} and R_{g}; or
R_{b} and Rₑ are none, and Cₐ and C_{b} are connected to each other via a single bond forming a heterocycle consisting of Cₐ, C_{b}, Xₐ, X_{b} and Rₐ, or
(E) Cₐ and Rₑ form a substituted or unsubstituted C₆-C₃₀ arylene, and both R_{f} and R_{g} are none; and
C_{b} and R_{b} form a substituted or unsubstituted C₆-C₃₀ arylene, and both R_{c} and Rₐ are none; or
(F) —Cₐ and Rₑ form a substituted or unsubstituted C₆-C₃₀ arylene, and both R_{f} and R_{g} are none; or
—C_{b} and R_{b} form a substituted or unsubstituted C₆-C₃₀ arylene, and both R_{c} and Rₐ are none;
wherein, when Cₐ and Rₑ form a substituted or unsubstituted C₆-C₃₀ arylene, R_{b}, R_{c} and Rₐ independently of each other are defined as any one of R_{c}, R_{d}, R_{f} and R_{g} under (A);
wherein, when C_{b} and R_{b} form a substituted or unsubstituted C₆-C₃₀ arylene, Rₑ, R_{f} and R_{g} independently of each other are defined as any one of R_{c}, Rₐ, R_{f} and R_{g} under (A),
obtaining a mixture comprising a poly(urea-urethane) polymer,
bringing in contact the obtained mixture with (iv):
(viii) a filler, the filler being selected from the group consisting of glass fibers, carbon fibers, mineral fibers, textiles, metal meshs, metal fibers, metal rods, carbonates, wood, and a mixture of two or more thereof.

34. A process for shaping a poly(urea-urethane) polymer obtained by a process comprising:
reacting the following components
(vii) at least one isocyanate;
(viii) at least one polyol; and
(ix) at least one secondary amine having the following formula (I) 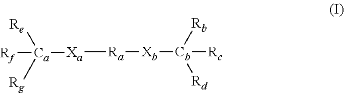
wherein —Rₐ— is selected from the group consisting of —Z₁—, —Z₂—, —Z₃—, —Z₄—, —Z₅—, —Z₆—, —Z₇—, —Z₇—, —Z₈—, —Z₉—, —Z₁₀—, —Z₁₁—, —Z₁₃—, —Z₁—Z₅—, —Z₅—Z₁—Z₅—, —Z₁—Z₆—, —Z₁—Z₇—, —Z₁—Z₈—, —Z₁—Z₉—, —Z₉—Z₁—Z₉—, —Z₁—Z₁₀—, —Z₃—Z₅—, —Z₃—Z₆—, —Z₃—Z₇—, —Z₃—Z₈—, —Z₃—Z₉—, —Z₃—Z₁₀—, —Z₁—Z₅—Z₁—, —Z₁—Z₉—Z₁—, —Z₉—Z₁(—Z₁₁—Z₁)ₙ—Z₉—, with n=1, 2, 3, 4, 5, or 6, and —Z₁—Z₁₂—Z₁—;
wherein
—Z₁— is a substituted or unsubstituted, linear or branched C₁-C₃₀ alkylene;
—Z₂— is a substituted or unsubstituted, linear or branched 2- to 300,000-membered heteroalkylene;
—Z₃— is a substituted or unsubstituted, linear or branched C₂-C₃₀ alkenylene;
—Z₄— is a substituted or unsubstituted, linear or branched 3- to 30-membered heteroalkenylene;
—Z₅— is a substituted or unsubstituted C₅-C₃₀ cycloalkylene;
—Z₆— is a substituted or unsubstituted 5- to 30-membered heterocycloalkylene;
—Z₇— is a substituted or unsubstituted C₅-C₃₀ cycloalkenylene;
—Z₈— is a substituted or unsubstituted 5- to 30-membered heterocycloalkenylen;
—Z₉— is a substituted or unsubstituted C₆-C₃₀ arylene;
—Z₁₀— is a substituted or unsubstituted 5- to 30-membered heteroarylene;
—Z₁₁— is a C₆-C₃₀ arylene substituted with —NHR or —OR, wherein R is selected from the group consisting of H and substituted or unsubstituted, linear or branched C₁-C₁₀ alkyl;
—Z₁₂— is —N(R_{f})—;
—Z₁₃— is a substituted or unsubstituted 5- to 30-membered heterocycloalkylene, wherein at least one of the one or more heteroatoms of Z₁₃ is from Xₐ;
wherein Cₐ is a C atom or a H atom and C_{b} is a C atom or a H atom, wherein at least one of Cₐ and C_{b} is a C atom;
wherein Xₐ is a O atom or NH and X_{b} is a O atom or NH, wherein at least one of Xₐ and X_{b} is NH, with the condition that for Xₐ or X_{b} being NH, the respective Cₐ or C_{b} is/are C atom(s);
wherein
(G) R_{c}, Rₐ, R_{f} and R_{g} independently of each other are selected from the group consisting of hydrogen, linear or branched, substituted or unsubstituted C₁-C₃₀ alkyl, linear or branched, substituted or unsubstituted C₂-C₃₀ alkenyl, substituted or unsubstituted, linear or branched 2- to 30-membered heteroalkyl, substituted or unsubstituted, linear or branched 3- to 30-membered heteroalkenyl, substituted or unsubstituted C₅-C₃₀ cycloalkyl, substituted or unsubstituted C₅-C₃₀ cycloalkenyl, substituted or unsubstituted 5- to 30-membered heterocycloalkyl, substituted or unsubstituted 5- to 30-membered heterocycloalkenyl, substituted or unsubstituted C₆-C₃₀ aryl, substituted or unsubstituted 5- to 30-membered heteroaryl, substituted or unsubstituted C₁-C₁₀ alkylene C₅-C₃₀ cycloalkyl, substituted or unsubstituted C₁-C₁₀ alkylene C₅-C₃₀ cycloalkenyl, substituted or unsubstituted C₁-C₁₀ alkylene 5- to 30-membered heterocycloalkyl, substituted or unsubstituted C₁-C₁₀ alkylene 5- to 30-membered heterocycloalkenyl, substituted or unsubstituted C₁-C₁₀ alkylene C₆-C₃₀ aryl and substituted or unsubstituted C₁-C₁₀ alkylene 5- to 30-membered heteroaryl,
R_{b} and Rₑ independently of each other are defined as R_{c}, Rₐ, R_{f} and R_{g}; or
R_{b} and Rₑ are none, and Cₐ and C_{b} are connected to each other via a single bond forming a heterocycle consisting of Cₐ, C_{b}, Xₐ, X_{b} and Rₐ; or
(H) Cₐ and Rₑ form a substituted or unsubstituted C₆-C₃₀ arylene, and both R_{f} and R_{g} are none; and
C_{b} and R_{b} form a substituted or unsubstituted C₆-C₃₀ arylene, and both R_{c} and Rₐ are none; or
(I) —Cₐ and Rₑ form a substituted or unsubstituted C₆-C₃₀ arylene, and both R_{f} and R_{g} are none; or
—C_{b} and R_{b} form a substituted or unsubstituted C₆-C₃₀ arylene, and both R_{c} and Rₐ are none;
wherein, when Cₐ and Rₑ form a substituted or unsubstituted C₆-C₃₀ arylene, R_{b}, R_{c} and Rₐ independently of each other are defined as any one of R_{c}, Rₐ, R_{f} and R_{g} under (A);
wherein, when C_{b} and R_{b} form a substituted or unsubstituted C₆-C₃₀ arylene, Rₑ, R_{f} and R_{g} independently of each other are defined as any one of R_{c}, R_{d}, R_{f} and R_{g} under (A),
or a poly(urea-urethane) polymer obtained by a process according to claim 30 comprising:
shaping the poly(urea-urethane) polymer, wherein shaping the polymer comprises
(x) applying pressure and heat to the poly(urea-urethane) polymer, obtaining a shaped body, or
(x′) extruding the poly(urea-urethane) polymer, obtaining a shaped body.
